(19) United States
(12) Patent Application Publication
(10) Pub. No.: US 2021/0213384 A1
(43) Pub. Date: Jul. 15, 2021

(54) DEHYDRATION USING BIOSORBENTS IN MODIFIED PRESSURE SWING ADSORPTION

(71) Applicant: University of Saskatchewan, Saskatoon (CA)

(72) Inventors: Saeed Ghanbari, Saskatoon (CA); Catherine Hui Niu, Saskatoon (CA); Rlee George Prokopishyn, Saskatoon (CA)

(73) Assignee: University of Saskatchewan, Saskatoon, SK (CA)

(21) Appl. No.: 16/757,193

(22) PCT Filed: Oct. 19, 2018
(86) PCT No.: PCT/CA2018/051327

§ 371 Date: Apr. 17, 2020

Related U.S. Application Data
(60) Provisional application No. 62/575,137, filed on Oct. 20, 2017.

(51) Int. Cl. B01D 53/26; B01D 53/047; B01D 53/04; B01D 53/28; C10L 3/10

(52) U.S. Cl. CPC B01D 53/261; B01D 53/0476; B01D 53/0423; B01D 53/28; C10L 3/106; C10L 2290/542; B01D 2256/245; B01D 2257/80; B01D 2259/402; B01D 2256/10; B01D 2259/40007; B01D 2253/20

(57) ABSTRACT

Systems and methods of separating components of a multi-component gas mixture are described herein. The systems include one or more packed bed columns packed with a biosorbent material. Upon passing the multi-component gas mixture through the packed bed column, substantially all of a polar component of the multi-component gas mixture is adsorbed by the biosorbent material and a non-polar component of the multi-component gas mixture is not substantially adsorbed by the biosorbent material.

### RELATED APPLICATIONS

This application claims the benefit of U.S. Provisional Patent Application Ser. No. 62/575,121 filed Oct. 20, 2017, and entitled DEHYDRATION USING BIOSORBENTS IN MODIFIED PRESSURE SWING ADSORPTION, the entire contents of which are hereby incorporated by reference herein for all purposes.

### TECHNICAL FIELD

The embodiments disclosed herein relate to dehydrating multi-component gas mixtures, and, in particular to systems, apparatus, and methods for dehydrating multi-component gas mixture using biosorbents in modified pressure swing adsorption.

### BACKGROUND

Natural gas can be an important energy source for industry, transportation and residential use. It is also used as a chemical feedstock in the manufacturing of plastics and other commercially important organic chemicals. Natural gas contains primarily methane; however, it also commonly contains various amounts of water, carbon dioxide, and hydrocarbons, among other components. The presence of water in natural gas substantially decreases the heat value of natural gas. In addition, natural gas is dried before entering distribution pipelines to control corrosion and prevent the formation of solid hydrocarbon/water hydrates. To this end, technologies such as absorption, adsorption, condensation, and supersonic separation have been developed for dehydrating natural gas. FIG. 1 shows an example of where dehydration-type processes can be implemented within natural gas processing plants.

While some relatively acceptable dehydration results can be achieved by utilizing some of these technologies, problems with pollution and high processing costs can still exist. There is a need for new strategies, innovative materials, and novel approaches in systems and methods that can be used to dehydrate natural gas.

Biosorbents are one example of a material that the inventors discovered has at least some potential to be used as the adsorbent media in a new natural gas dehydration system and/or method.

Temperature swing adsorption processes using commercial adsorbents such as molecular sieves and alumina are currently being used in the natural gas processing industry as part of a dehydration system, and in particular to regenerate the adsorbent material. The relatively high operating temperatures (e.g. 250° C. or higher) for desorption of these processes may make temperature swing adsorption an unsuitable process to use in combination with biosorbent materials, as the biosorbents may tend to decompose (e.g. by pyrolysis) or otherwise become inefficient at such relatively high temperatures.

Pressure swing adsorption (PSA) processes have been used for drying of air and other industrial gases/vapors for several decades. Some challenges faced in the commercial adoption of PSA processes have been the relative selectivity of the adsorbent materials, and operating costs and energy consumption related to regeneration of the adsorbents, and gas compression. Commercial adsorbents used for air/gases drying have typically tended to also adsorb at least some amounts of process air/gases that are to be dehydrated, in addition to water vapor, which is not favorable. This trait has sometimes led to additional capital and operating costs, such as adding recycle loops and the like, in order to help recover at least some of the adsorbed air/gases, and to help improve the overall efficiency of the process. This can result in resources being expended to desorb the adsorbed air/gases by, for example, using a fraction of dry air/gases products or heat the adsorbent during the regeneration process using heating systems such as hot oil or electrical heaters due to the low selectivity of the commercial adsorbents towards water vapor.

Another challenge with PSA can be gas compression, which is typically done in expensive multi-staged compressors. Gas compression is a relatively expensive unit operation in chemical plants. In addition, gas compression may be associated with temperature increase (e.g. isentropic process), which is may be generally disadvantageous for PSA processes, because water vapor adsorption may tend to decrease as the operating temperature increases. Therefore, the compressed gases are typically cooled prior to entering the adsorption columns; otherwise, the adsorption performance would be very low. However, in the case of natural gas, gas compression is not required as the natural gas emerges from reservoirs at high pressures and can be directly sent to the PSA dehydration unit.

Another relatively significant operating cost in a temperature swing adsorption processes, in addition to the gas compression cost, is associated with heating and cooling unit operations, such as the use of a fired heater and/or a suitable cooler. In some temperature swing adsorption processes, it is that natural gas is typically burned in the fired heater to regenerate the adsorbents, and the adsorbent are then cooled in order to dehydrate natural gas. Further, a compressor is typically used during regeneration to compress the holdup gas and the regeneration carrier gas (a portion of the product gas) in the column. This gas may be recycled back to improve the overall recovery of the process. All of these separate, and sometimes contradictory unit operations can have a generally negative impact on the economics of the temperature swing process. In sum, this process is very energy intensive and produces a considerable amount of gas emissions.

Accordingly, there is a need for improved systems, apparatus and/or methods for dehydrating multi-component gas mixtures.

### SUMMARY

This summary is intended to introduce the reader to the more detailed description that follows and not to limit or define any claimed or as yet unclaimed invention. One or more inventions may reside in any combination or sub-combination of the elements or process steps disclosed in any part of this document including its claims and figures.

In accordance with a broad aspect, a system for separating components of a multi-component gas mixture is described herein. The system includes a packed bed column packed with a biosorbent material, wherein, upon passing the multi-component gas mixture through the packed bed column, substantially all of a polar component of the multi-component gas mixture is adsorbed by the biosorbent material and a non-polar component of the multi-component gas mixture is not substantially adsorbed by the biosorbent material.

In some embodiments, the biosorbent material is a lignocellulose-based material.

In some embodiments, the biosorbent material is a flax-based material.

In some embodiments, the biosorbent material is flax shives or modified flax shives.

In some embodiments, the multi-component gas mixture is natural gas.

In some embodiments, the polar component is water.

In some embodiments, the non-polar component is methane.

In some embodiments, the multi-component gas mixture is natural gas and the polar component is water.

In some embodiments, the multi-component gas mixture is natural gas and the non-polar component is methane.

In some embodiments, the polar component is water and the non-polar component is methane.

In some embodiments, the multi-component gas mixture is natural gas, the polar component is water and the non-polar component is methane.

In accordance with a broad aspect, a method of separating components of a multi-component gas mixture is described herein. The method includes passing a feed stream comprising the multi-component gas mixture through a packed bed column comprising a biosorbent material for the biosorbent material to adsorb substantially all of a polar component of the multi-component gas mixture and to not substantially adsorb a non-polar component of the multi-component gas mixture.

In some embodiments, the passing the feed stream comprising the multi-component gas mixture through the packed bed column comprising a biosorbent material includes passing the feed stream comprising the multi-component gas mixture through the packed bed column comprising a lignocellulose-based material.

In some embodiments, the passing the feed stream comprising the multi-component gas mixture through the packed bed column comprising a biosorbent material includes passing the feed stream comprising the multi-component gas mixture through the packed bed column comprising a flax-based material.

In some embodiments, the passing the feed stream comprising the multi-component gas mixture through the packed bed column comprising a biosorbent material includes passing the feed stream comprising the multi-component gas mixture through the packed bed column comprising flax shives, modified flax shives or the like.

In accordance with a broad aspect, a system for separating components of a multi-component gas mixture is described herein. The system includes a feed stream comprising the multi-component gas mixture; a first packed bed column packed with a biosorbent material and configured to receive the multi-component gas mixture from the feed stream; a second packed bed column packed with the biosorbent material and configured to receive the multi-component gas mixture from the feed stream; and a product stream configured to receive a dried gas from each of the first and the second packed bed columns, the dried gas comprising substantially all of a non-polar component of the multi-component gas mixture; wherein upon passing the multi-component gas mixture through the first packed bed column substantially all of a polar component of the multi-component gas mixture is adsorbed by the biosorbent material and the non-polar component of the multi-component gas mixture is not substantially adsorbed by the biosorbent material.

In some embodiments, the system includes a vacuum pump configured to reduce a pressure within the first bed column to desorb the polar component from a surface of the biosorbent material.

In some embodiments, when passing the multi-component gas mixture through the first packed bed column, the second packed bed column is configured to undergo a regeneration process where the vacuum pump is configured to reduce a pressure within the second packed bed column to desorb the polar component from a surface of the biosorbent material.

In some embodiments, the feed stream enters the first packed bed reactor at a pressure in a range of about 15 to 1000 psia.

In some embodiments, the feed stream enters the first packed bed reactor at a pressure in a range of about 500 to 1000 psia.

In some embodiments, the feed stream enters the first packed bed reactor at a pressure sufficient for the polar component in the feed stream to adsorb to a surface of the biosorbent material.

In some embodiments, the system further includes a recycle stream configured to receive the non-polar component from the first packed bed reactor.

In some embodiments, the recycle stream is directed into the second packed bed reactor during the regeneration process to carry the desorbed polar component out of the second packed bed reactor.

In some embodiments, the system operates at about an ambient temperature (e.g. about 20 degrees Celsius).

In some embodiments, the multi-component gas mixture is an air-biogas gas mixture.

In some embodiments, the non-polar component is nitrogen gas.

In accordance with a broad aspect, a method of separating components of a multi-component gas mixture is described herein. The method includes operating a first packed bed column in an adsorption process by passing a feed stream comprising the multi-component gas mixture through the first packed bed column comprising a biosorbent material for the biosorbent material to adsorb substantially all of a polar component of the multi-component gas mixture and to not substantially adsorb a non-polar component of the multi-component gas mixture; and operating the first packed bed column in a regeneration process by drawing substantially all of the polar component adsorbed by the biosorbent material off of the biosorbent material.

In some embodiments, the method further includes, while operating the first packed bed column in the regeneration process, operating a second packed bed column in an adsorption process by passing a feed stream comprising the multi-component gas mixture through the second packed bed column comprising a biosorbent material for the biosorbent material to adsorb substantially all of a polar component of the multi-component gas mixture and to not substantially adsorb a non-polar component of the multi-component gas mixture.

In accordance with a broad aspect, a system for controlling the separation of components of a multi-component gas mixture in a pressure swing or a temperature swing adsorption process is described herein. The system includes a computing unit configured to: operate a first packed bed column in an adsorption process by passing a feed stream comprising the multi-component gas mixture through the first packed bed column comprising a biosorbent material for the biosorbent material to adsorb substantially all of a polar component of the multi-component gas mixture and to not substantially adsorb a non-polar component of the multi-component gas mixture; and operate the first packed bed column in a regeneration process by drawing substantially all of the polar component adsorbed by the biosorbent material off of the biosorbent material.

In some embodiments, the computing unit is further configured to when the first packed bed column is operated the regeneration process, operate a second packed bed column in an adsorption process by passing a feed stream comprising the multi-component gas mixture through the first packed bed column comprising a biosorbent material for the biosorbent material to adsorb substantially all of a polar component of the multi-component gas mixture and to not substantially adsorb a non-polar component of the multi-component gas mixture.

In accordance with a broad aspect, a system for controlling the separation of components of a multi-component gas mixture in a pressure swing or a temperature swing adsorption process is described herein. The system includes a computing unit configured to: pressurize a first packed bed column by directing a feed stream comprising the multi-component gas mixture into the first packed bed column, the first packed bed column comprising a biosorbent material for the biosorbent material to adsorb substantially all of a polar component of the multi-component gas mixture and to not substantially adsorb a non-polar component of the multi-component gas mixture; direct the non-polar component from the first packed bed column to a product stream; and collect the polar component from of the biosorbent material and into a recycle stream.

In some embodiments, the computing unit is configured to collect the polar component from of the biosorbent material into a recycle stream by passing CO₂ through the first packed bed column.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a schematic diagram showing a typical process for processing natural gas, according to one embodiment;

FIG. 2 is a schematic diagram showing one example of a system for dehydrating multi-component gas mixtures;

FIG. 3 is a graph showing pore size distribution of flax shives obtained using the BJH model;

FIG. 4 is a graph showing pore volume distribution of flax shives measured using the BJH model;

FIG. 5 is a graph showing incremental surface area versus pore width of flax shives;

FIG. 6 is a graph showing differential pore volume vs. pore width of flax shives;

FIG. 7 is a graph showing weight loss of a sample of flax shives due to pyrolysis where decomposition was measured with time as the temperature was gradually increased;

FIG. 8 is a graph showing a breakthrough curve for water vapour;

FIGS. 9A and 9B are images showing the molecular structure and partial charges of water and methane, respectively;

FIG. 10 is a full factorial design table showing the levels of each factors and the measured adsorption capacities for each experiment;

FIGS. 11A to 11D are interaction plots generated from the statistical analysis of the factorial experiment design results;

FIG. 12 is a contour plot of adsorption capacity over the range of temperature and pressure in the experiment design;

FIG. 13 is a graph showing the effects of temperature and water vapor mole fraction on the adsorption capacity of the biosorbent;

FIG. 14 is a graph showing a breakthrough curve for two consecutive runs of experiment number 5 in the design table of FIG. 10;

FIG. 15 is a process flowsheet of PSA process for air drying, according to one embodiment;

FIG. 16 is a process flowsheet of a glycol dehydration process, according to one embodiment;

FIG. 17 is a process flowsheet of a temperature swing adsorption process, according to one embodiment;

FIG. 18 is a schematic of a calcium chloride dehydration column, according to one embodiment;

FIG. 19 is a

FIG. 19 is a pipe and instrumentation diagram (PID) of a dual-column pressure-swing adsorption (PSA) process for natural gas dehydration, according to another embodiment;

FIG. 20 is an image showing an overview of a Labview program developed for control of a PSA process according to one of the embodiments described herein;

FIG. 21 is a PID showing integration of a PSA dehydration process with a PSA carbon dioxide capture, according to one embodiment;

FIG. 22 is a graph showing breakthrough and regeneration curves of flax shives at 300 kPa, 24° C., 100% humid feed gas, and a gas flow rate of 3 L/min;

FIG. 23 is a graph showing a breakthrough curve at 101.3 kPa, 24° C., 100% humid feed gas, and feed flow rate of 3 L/min;

FIG. 24 is a graph showing the rate of adsorption at 300 kPa and desorption at 47 kPa; temperature: 24° C.; gas flow rate during adsorption and desorption was 3 and 4.5 L/min, respectively.

FIG. 25 is a graph showing a kinetics model fitted on the breakthrough curve at 300 kPa, 24° C., 100% humid feed gas, and feed flow rate of 3 L/min;

FIG. 26A is a desorption plot predicted by the LDF model having 0.47 atm absolute pressure and a temperature of 24° C.;

FIG. 26B is a is a desorption plot predicted by the LDF model having 0.47 atm absolute pressure and a temperature of 35° C.

FIG. 27 is a graph showing a water vapor profile throughout the experiment (85 cycles)—

$$\frac{{V}_{R}}{{V}_{F}} = 1.5 ;$$

FIG. 28 is a graph showing cyclic pressure profiles (two cycles)—

$$\frac{{V}_{R}}{{V}_{F}} = 1.5 ;$$

FIG. 29 is a graph showing cyclic temperature profiles (two cycles)—

$$\frac{{V}_{R}}{{V}_{F}} = 1.5 ;$$

FIG. 30 is a graph showing a detailed analysis of column temperature profile at the top of the column during a cycle—

$$\frac{{V}_{R}}{{V}_{F}} = 1.5 ;$$

FIG. 31 is a graph showing a detailed analysis of column temperature profile at the bottom of the column during a cycle—

$$\frac{{V}_{R}}{{V}_{F}} = 1.5 ;$$

FIG. 32 is a graph showing a cyclic temperature profile during the PSA process—

$$\frac{{V}_{R}}{{V}_{F}} = 1.5 ;$$

FIG. 33 is a graph showing a comparison of temperature profile in different cycles throughout the experiment—

$$\frac{{V}_{R}}{{V}_{F}} = 1.5 ;$$

FIG. 34 is a graph showing a temperature profile during the determination of water holdup in bed after 85 cycles—

$$\frac{{V}_{R}}{{V}_{F}} = 1.5 ;$$

FIG. 35 is a graph showing a water vapor profile throughout the experiment (85 cycles)—

$$\frac{{V}_{R}}{{V}_{F}} = 1 ;$$

FIG. 36 is a graph showing a cyclic pressure profile (two cycles)—

$$\frac{{V}_{R}}{{V}_{F}} = 1 ;$$

FIG. 37 is a graph showing a temperature profile (two cycles)—

$$\frac{{V}_{R}}{{V}_{F}} = 1 ;$$

FIG. 38 is a graph showing a comparison of temperature profile in different cycles throughout the experiment—

$$\frac{{V}_{R}}{{V}_{F}} = 1 ;$$

FIG. 39 is a graph showing a cyclic temperature profile during the PSA process—

$$\frac{{V}_{R}}{{V}_{F}} = 1 ;$$

FIG. 40 is a graph showing a water vapor profile throughout the experiment—1 atm;

$$\frac{{V}_{R}}{{V}_{F}} = 1.5 ;$$

FIG. 41 is a graph showing a cyclic temperature profile during the experiment—1 atm;

$$\frac{{V}_{R}}{{V}_{F}} = 1.5 ;$$

FIG. 42 is a graph showing a temperature profile of the adsorption column at 1 atm and

$$\frac{{V}_{R}}{{V}_{F}} = 1 ;$$

FIG. 43 is a graph showing a water vapor profile throughout the experiment—adsorption at 1 atm; regeneration at 3 μHg using a vacuum pump;

$$\frac{{V}_{R}}{{V}_{F}} = 1.5 ;$$

FIG. 44 is a graph showing a cyclic temperature profile of the experiment—adsorption at 1 atm; regeneration at 3 μHg using a vacuum pump;

$$\frac{{V}_{R}}{{V}_{F}} = 1.5 ;$$

FIG. 45 is a graph showing a temperature profile of the adsorption column—adsorption at 1 atm; regeneration at 3 μHg using a vacuum pump;

$$\frac{{V}_{R}}{{V}_{F}} = 1.5 ;$$

FIG. 46 is a process flowsheet of a natural gas dehydration process using TEG simulated in ASPEN HYSYS, according to one embodiment;

FIG. 47 is a composite curve obtained from pinch analysis on the TEG dehydration process;

FIGS. 48A-D show energy analysis results from ASPEN Energy Analyzer; comparison of heating/cooling utilities and carbon emissions with target values recommended by ASPEN for gas processing plants;

FIG. 49 is a process flow diagram of the TSA process for natural gas dehydration, according to one embodiment;

FIG. 50 is a graph showing a pinch analysis of the TSA process for natural gas dehydration of FIG. 49;

FIGS. 51A-D show comparisons of heating/cooling, utilities, and gas emissions for the TSA process of FIG. 49;

FIG. 52 is a process flowsheet of a six-step PSA process without recycling for natural gas dehydration, according to one embodiment;

FIG. 53 is a process flowsheet of a six-step PSA process with recycling for natural gas dehydration, according to one embodiment;

FIG. 54 is a process flowsheet of a ten-step PSA process without recycling for natural gas dehydration, according to one embodiment;

FIG. 55 is a process flowsheet of a ten-step PSA process with recycling for natural gas dehydration, according to one embodiment;

FIG. 56 is a process flow diagram of a dynamic simulation in ASPEN ADSIM of a 6-step PSA process;

FIG. 57 is a graph showing product gas and feed gas composition during 85 cycles obtained from the dynamic simulation shown in FIG. 56;

FIG. 58 is a graph showing a water vapor profile in the mass transfer zone—fluctuations are due to the change in the pressure during a cycle from high to vacuum; the water holdup in the bed reached to a steady-state condition;

FIG. 59 is a graph showing an axial water vapor profile in the mass transfer zone—the overlapped lines show that the axial profile reached a steady-state condition over time;

FIG. 60 is a graph showing an axial temperature profile in the mass transfer zone—the local temperature in the mass transfer zone increased due to the heat of adsorption and the temperature front moved forward in the biosorbent bed with time;

FIG. 61 is a process flow diagram of a dynamic simulation in ASPEN ADSIM of a 10-step PSA process;

FIG. 62 is a graph showing an analysis of natural gas contamination with CO₂ in the 10-step PSA process shown in FIG. 61;

FIG. 63 is a graph showing a breakthrough curve of flax shives at 5 bar and 24° C.; flow rate 3 L/min; 100% humid feed gas;

FIG. 64 is a P&ID of a first step of a six-step PSA process, according to one embodiment;

FIG. 65 is a P&ID of a second step of a six-step PSA process, according to one embodiment;

FIG. 66 is a P&ID of a third step of a six-step PSA process, according to one embodiment;

FIG. 67 is a P&ID of a fourth step of a six-step PSA process, according to one embodiment;

FIG. 68 is a P&ID of a fifth step of a six-step PSA process, according to one embodiment;

FIG. 69 is a P&ID of a sixth step of a six-step PSA process, according to one embodiment;

FIG. 70 is a P&ID of a first step of a ten-step PSA process, according to one embodiment;

FIG. 71 is a P&ID of a second step of a ten-step PSA process, according to one embodiment;

FIG. 72 is a P&ID of a third step of a ten-step PSA process, according to one embodiment;

FIG. 73 is a P&ID of a fourth step of a ten-step PSA process, according to one embodiment;

FIG. 74 is a P&ID of a fifth step of a ten-step PSA process, according to one embodiment;

FIG. 75 is a P&ID of a sixth step of a ten-step PSA process, according to one embodiment;

FIG. 76 is a P&ID of a seventh step of a ten-step PSA process, according to one embodiment;

FIG. 77 is a P&ID of a eighth step of a ten-step PSA process, according to one embodiment;

FIG. 78 is a P&ID of a ninth step of a ten-step PSA process, according to one embodiment;

FIG. 79 is a P&ID of a tenth step of a ten-step PSA process, according to one embodiment;

FIG. 80 is a diagram of an overview of the Labview code for a control system, according to one embodiment.

FIG. 81 is a block panel diagram of the Labview code showing the “false” case of the case structure;

FIG. 82 is a block panel diagram of the Labview code showing the “true” case of the case structure—frame 0 of the event structure which configures the process for the adsorption step in column 1;

FIG. 83 is a block panel diagram of frame 1 of the event structure which configures the process for the pressure equalization step;

FIG. 84 is a block panel diagram of frame 2 of the event structure which configures the process for the pressurization step in column 2;

FIG. 85 is a block panel diagram of frame 3 of the event structure which configures the process for the adsorption step in column 2;

FIG. 86 is a block panel diagram of frame 4 of the event structure which configures the process for a pressure equalization step;

FIG. 87 is a block panel diagram of frame 5 of the event structure which configures the process for the pressurization step in column 1; and

FIG. 88 is an image of the front panel of the Labview code.

Further aspects and features of the example embodiments described herein will appear from the following description taken together with the accompanying drawings.

### DETAILED DESCRIPTION

Various apparatus, systems and methods will be described below to provide an example of each claimed embodiment. No embodiment described below limits any claimed embodiment and any claimed embodiment may cover apparatus, systems or methods that differ from those described below. The claimed embodiments are not limited to apparatus, systems or methods having all of the features of any one apparatus, systems or methods described below or to features common to multiple or all of the apparatus, systems or methods described below.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

It should be noted that terms of degree such as “substantially”, “about” and “approximately” as used herein mean a reasonable amount of deviation of the modified term such that the end result is not significantly changed. These terms of degree should be construed as including a deviation of the modified term, such as 1%, 2%, 5%, or 10%, for example, if this deviation does not negate the meaning of the term it modifies.

Furthermore, the recitation of any numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation up to a certain amount of the number to which reference is being made, such as 1%, 2%, 5%, or 10%, for example, if the end result is not significantly changed.

It should also be noted that, as used herein, the wording “and/or” is intended to represent an inclusive—or. That is, “X and/or Y” is intended to mean X or Y or both, for example. As a further example, “X, Y, and/or Z” is intended to mean X or Y or Z or any combination thereof.

The following description is not intended to limit or define any claimed or as yet unclaimed subject matter. Subject matter that may be claimed may reside in any combination or sub-combination of the elements or process steps disclosed in any part of this document including its claims and figures. Accordingly, it will be appreciated by a person skilled in the art that an apparatus, system or method disclosed in accordance with the teachings herein may embody any one or more of the features contained herein and that the features may be used in any particular combination or sub-combination that is physically feasible and realizable for its intended purpose.

Biosorbents may offer an alternative to convention materials for use in systems for separating and/or dehydrating multi-component gas mixtures, and may be used in any suitable reactor, such as being used in packed beds in PSA processes for separating components of multi-component gas mixtures. Biosorbents may help facilitate the use of new, modified PSA processes that may, in some examples, have increased efficiencies as compared to conventional PSA processes. For example, the new dehydration processes described herein may be, in some examples, less energy intensive, less costly, more environmental friendly, and easy to operate and control than conventional dehydration processes (e.g. conventional PSA processes).

As shown in the embodiments described herein, the inventors have developed a system and method for separating components of multi-component gas mixtures, such as but not limited to natural gas, biogas containing methane, or other industrial gases containing non-polar compounds like hydrogen, nitrogen, etc., utilizing biosorbent materials.

For example, a multi-component gas mixture comprising at least one polar component, such as but not limited to water, and at least one non-polar component, such as but not limited to natural gas, can be passed through a packed bed column comprising a suitable biosorbent material, which may adsorb the polar component(s) onto the biosorbent material. Preferably, the biosorbent material can be configured so that it adsorbs substantially only the polar component (and optionally only the polar component—i.e. water) and adsorbs a much smaller amount, and optionally none of, the non-polar component (i.e. the natural gas). In some embodiments, the biosorbent material may adsorb only water, and may not adsorb any natural gas (i.e. may have 100% water vapor selectivity).

Upon reaching a defined breakthrough point of the polar component(s), the feed stream may be stopped and, optionally, the biosorbent material may be regenerated at a regeneration pressure that is lower than the operating pressure for adsorption through vacuum. In this aspect, the system may be considered to be a batch process.

Optionally, the system may be configured with two or more packed bed columns running in parallel. This may help facilitate a configuration in which at least one packed bed column can be operating to adsorb the polar component(s) from the multi-component gas mixture as it passes through the column, while at least one packed bed column is simultaneously undergoing desorption (i.e. regeneration) via a vacuum. In this aspect, the system may be considered to be a cyclic batch process or a continuous swing adsorption process.

Regeneration of the packed bed column(s) may be completed using any suitable mechanism/apparatus, including using a vacuum pump. Gas holdup of the column, including the polar component(s) and potentially some other non-polar components trapped in the void space of the packed bed and/or adsorbed to the biosorbent material, may be desorbed from the biosorbent material under vacuum (for example at substantially the same temperature as was used during the adsorption phase) and collected for temporary storage in a buffer tank, or other suitable apparatus. Optionally, a flash drum can be included in the system to help separate the polar and non-polar components of the gas holdup and recycling the non-polar component(s) back to the packed bed column(s) for separation.

The systems and methods described herein generally operate at approximately room temperature (e.g. about 20° C.). Increasing or decreasing the operating temperature of specific aspects of the systems and methods may be desirable in some instances. For example, slightly decreasing the temperature of the feed stream may help increase the adsorption capacity of the packed bed column. Further, increasing the temperature of the column during regeneration may help increase the rate of regeneration of the biosorbent material in the packed bed column.

The systems and methods described herein generally utilize a lignocellulose material as the biosorbent material. Herein, lignocellulose generally refers to plant dry matter (biomass). Lignocellulose generally comprises carbohydrate polymers (e.g. cellulose, hemicellulose) and an aromatic polymer (e.g. lignin). The carbohydrate polymers may contain different sugar monomers (e.g. five or six carbon sugars) and they may be tightly bound to lignin.

In one embodiment of the systems and methods described herein, flax shives or the like may be used as the biosorbent material. Flax shives are a byproduct of fiber processing units and are categorized as a lignocellulose material, which is composed of cellulose, hemicellulose, lignin and protein. Cellulose and hemicellulose may help impart suitable surface functional groups onto the surface of flax shives to help facilitate adsorption of polar components. Water is polar whereas methane is non-polar. Accordingly, in some embodiments, a packed bed column comprising flax shives may be used for the selective adsorption and removal of water from natural gas (i.e. predominantly non-polar methane).

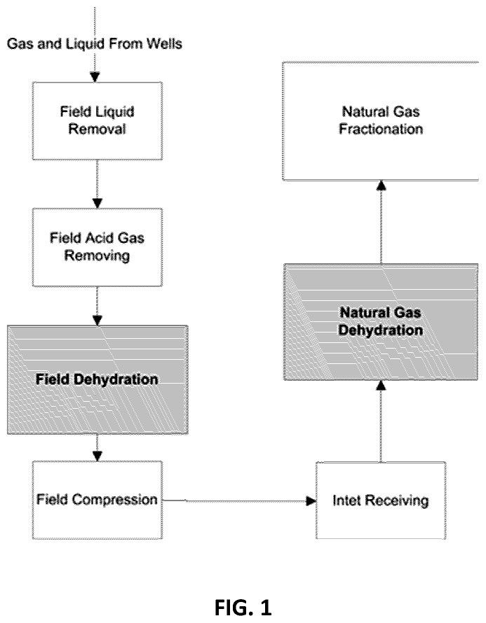

In some embodiments, natural gas from an oil well (e.g. having undergone some pre-processing, as shown in FIG. 1) can be fed as a feed stream to a packed bed column comprising flax shives for adsorption of the water in the natural gas onto the flax shives in the column. After a specific cycle time, the feed stream can be sent into another packed bed column comprising flax shives for the adsorption of water and the flax shives in the first column can regenerated under vacuum, replaced or otherwise treated.

The flax shives may have a variety of forms for use in the packed bed column. For example, in some embodiments, the flax shives may be used naturally (i.e. as a raw material). In some embodiments, the physical structure of the flax shives may be modified. For instance, the flax shives may be pelletized. Flax shive pellets could have standard shapes and sizes (e.g. cylindrical or spherical shapes) that may be helpful for process control purposes. Flax shive pellets may increase the density of the flax shives in the packed bed column, thereby increasing the adsorption capacity of the column and overall adsorption performance. Binders may or may not be used to form flax shive pellets.

In some embodiments where flax shives are used in their raw material form, the flax shives may have an average porosity such that methane molecules can pass directly through the flax shives and may tend not to be collected therein or otherwise adsorbed by the flax shives. In contrast, as noted above, water molecules are polar and may tend to be attracted to and adsorbed by the functional groups on the surface of the flax shives.

In other embodiments, other biosorbent materials may be used for the dehydration of multi-component gas mixtures according to the methods and systems described herein. These other biosorbent materials may be natural biosorbent materials (e.g. used in their raw form) or they may be natural materials that have been modified for specific applications. For example, flax shives may be modified for use in the systems and methods described herein by removing some, or optionally all of the lignin therefrom. Lignin is a generally a hydrophobic complex organic polymer and removing lignin from the flax shives may help increase water adsorption capacity of the packed bed columns described herein from multi-component gas mixtures, such as but not limited to natural gas.

### Process Description

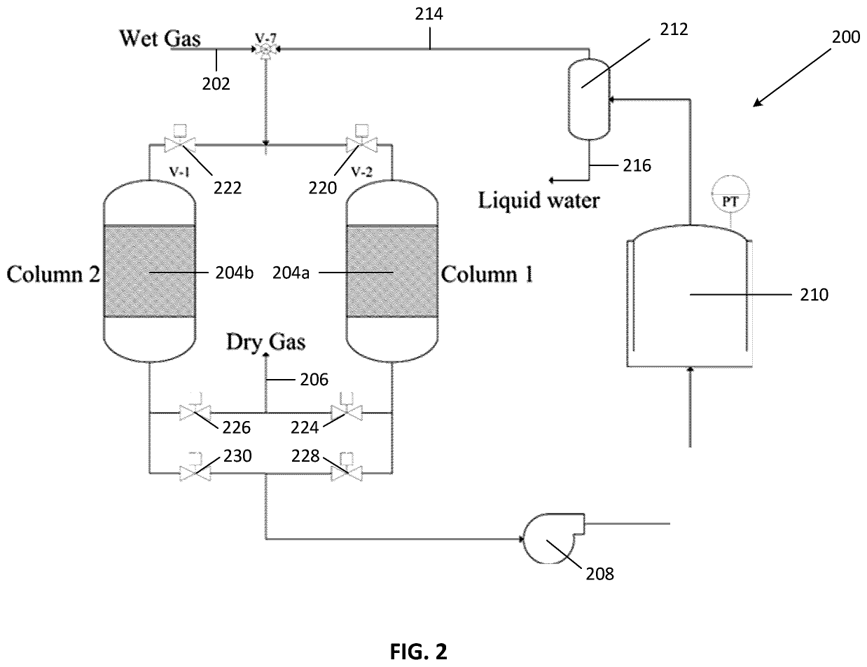

Referring to FIG. 2, illustrated therein is a system 200 for dehydrating multi-component gas mixtures, according to one embodiment. System 200 includes at least one packed bed column 204, a vacuum pump 208, a buffer tank 210, a flash drum 212, and several solenoid valves. These valves can be controlled by a control system (not shown). In the embodiment shown in FIG. 2, two packed bed columns 204a and 204b are shown. It should be noted that the system 200 could also include more than two packed bed columns 204.

In system 200, a wet gas feed stream 202 is fed to columns 204a and 204b. Columns 204a and 204b are each packed bed columns packed with the biosorbent material. In one embodiment, flax can be used as the biosorbent material to dehydrate water from a natural gas feed stream 202. In some embodiments, flax shives shives supplied by SWM Inc. (Engineered for tomorrow, Fiber Operations, Winkler, Manitoba, 2016) may be used as the biosorbent material.

System 200 is shown in FIG. 2 with two columns 204a and 204b running in parallel. In this configuration, one column (e.g. 204a) may be running an adsorption process (e.g. adsorbing water from feed stream 202) while the other column (e.g. 204b) may be running a desorption process (i.e. undergoing degeneration, as described below). After a specific cycle time, the system can change and the column previously running an adsorption process can run a desorption process and the column previously running a desorption process can run an adsorption process. In another embodiment, a methodology to determine the cycle time is described. Accordingly, the system 200 shown in FIG. 2 can be referred to as a cyclic batch system.

It should be noted that a single column 204 may also be used to perform the systems and methods described herein. In a single column configuration, the system 200 would operate a batch system and would not offer continuous adsorption.

Turning back to FIG. 2, in one example operation, adsorption may take place either column 204a or 204b at high pressure. The pressure within column 204 may depend on conditions of the multi-component gas mixture of feed stream 202, whether the multi-component gas mixture is natural gas from an oil reservoir or another feed gas such as but not limited to biogas. For instance, the operating pressure of column 204 may be in a range from 15 to 1000 psia. In other embodiments, the operating pressure of column 204 may be in a range from 500 to 1000 psia.

Wet natural gas emerging from an oil reservoir, for example, at high pressure (or biogas at moderate or high pressure) may enter either column 204a or 204b via feed stream 202 through valve 222 or 220, respectively, and dry gas can be drawn from the bottom of column 204a or 204b at high pressure through valve 226 or 224, respectively, into outlet stream 206. Outlet stream 206 can then be sent into downstream unit operations in a natural gas processing plant.

In one example, if column 204b is undergoing an adsorption process, column 204a may be regenerated under vacuum via vacuum pump 208. In this example, vacuum pump 208 draws water vapour off of the biosorbent of column 204a, as gas holdup. The gas holdup in column 204a, which may be composed of water vapor and other components of the natural gas (e.g. polar and non-polar components such as but not limited to methane, nitrogen, carbon dioxide, etc.) is sent into the buffer tank 210 by the vacuum pump 208 for temporary storage. The polar and non-polar components that are adsorbed in column 204a and removed as the gas holdup can be temporarily stored in the buffer tank 210. Generally, non-polar components are desired in outlet stream 206. Accordingly, any non-polar components adsorbed and/or trapped in the biosorbent of column(s) 204 may be separated in a flash drum 212 and recycled back to the columns 204a and 204b via recycle stream 214. Undesired components (e.g. polar components such as water) are generally removed from the system 200 via waste stream 216.

In another example operation, adsorption may be occurring in column 204a at high pressure while desorption takes place in column 204b. In this example, valves 220, 224 and 230 are open, while valves 222, 226, and 228 are closed. Under these conditions, dry gas is drawn from the bottom of column 204a at high pressure through valve 224 into outlet stream 206, while column 204b is being regenerated. The gas holdup recovery from column 204b is similar to that of the first operation mode described above.

It should be noted that columns 204a and 204b generally operate at room temperature (e.g. about 20° C.). Increasing or decreasing the temperature of specific aspects of the system and method may be desirable in some instances. For example, slightly decreasing the temperature of adsorption in columns 204a and 204b may increase water adsorption capacity of the packed bed columns. Further, slightly increasing the temperature of desorption in columns 204a and 204b may increase the rate of water evaporation from the biosorbent material. In one embodiment, columns 204a and 204b are operated at a temperature in a range from about 4° C. to about 50° C. In another embodiment, columns 204a and 204b are operated at a temperature in a range from about 10° C. to about 30° C. In another embodiment, columns 204a and 204b are operated at a temperature in a range from about 20° C. to about 25° C.

Vacuum pump 208 is generally a typical vacuum pump that operates to remove the gas holdup from column 204.

In other embodiments, other biosorbent materials beyond flax shives may also be used in system 200. These other biosorbent materials may be natural materials (e.g. used in their raw form or an alternative form such as but not limited to pellets) or may be natural materials that have been modified for specific applications. For example, flax shives may undergo a modification process in which at least a portion of the lignin therein is removed. Lignin is hydrophobic and removing lignin from flax shives may increase water adsorption capacity of column 204. Other modifications may also be performed to increase the water adsorption capacity of the biosorbent materials used herein.

In other embodiments, the systems and methods described herein may use biosorbent materials to dehydrate other generally non-polar gases, such as but not limited to hydrogen, methane, nitrogen, natural gas, air and/or helium.

### Examples

### Characterization of Flax Shives

Flax shives are a byproduct of fiber processing units (e.g. physical treatment). Fiber tumblers, fiber openers, fiber card, and long fiber separators are some of the industrial equipment used in bioprocessing plants.

Flax shives are categorized as a lignocellulose material, which is composed of cellulose, hemicellulose, lignin and protein. Based on studies reported in the literature, cellulose and hemicellulose impart suitable surface functional groups for adsorption of polar compounds. Since water is a polar compound, and methane is non-polar, material that is cellulose based and/or generally hydrophilic, such as the flax shives, may selectively adsorb water vapor from natural gas. Table 1 below shows the composition of flax shives used in the examples described herein.

TABLE 1
Composition of Flax Shives

| | Protein | Fat | Ash | Cellulose | Hemicellulose | Lignin |
|---|---|---|---|---|---|---|
| Biomass | (%) | (%) | (%) | (%) | (%) | (%) |
| Flax | 3.0 | 3.1 | 3.5 | 53.2 | 13.6 | 20.5 |
| shives | | | | | | |

The specific surface area and pore size distribution of adsorbents in PSA process generally affect their performance. Accordingly, the Brunauer Emmet and Teller (BET), and Barrett-Joyner-Halenda (BJH) theory were used to measure specific surface area, average pore size distribution and average pore volume using a commercial surface area and porosity analyzer (Micromeritics ASAP 2020). The results are summarized in Table 2:

TABLE 2
Summary of surface area and porosity analyeses

| | Specific surface area | Average pore size | Average pore volume |
|---|---|---|---|
| Model | (m²/g) | (nm) | (cm³/g) |
| BET multilayer | 1.33825 ± 0.0763 | — | — |
| Single Point | 1.4036 ± 0.0587 | — | — |
| t-plot | 3.5615 ± 0.0178 | — | — |
| BJH Adsorption | 0.582 ± 0.0555 | 11.7813 ± 0.587 | 0.001715 ± 0.0007 |
| BJH Desorption | 0.6141 ± 0.09998 | 10.6854 ± 0.874 | 0.001640 ± 0.0021 |

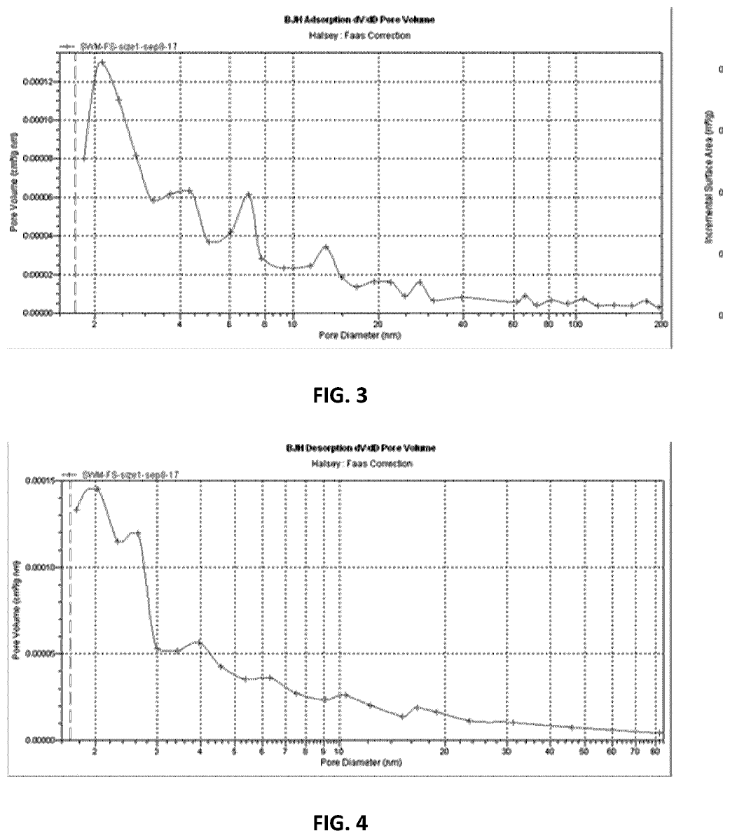

The pore size distribution obtained from the BJH model is shown in FIG. 3. As expected and reported in the literature, biosorbents (including flax shives) are heterogeneous solids having complex pore structure and pore size distribution ranging from about 2 nm to about 180 nm. The obtained results from these tests may be later compared with Scanning Electron Microscopy (SEM) photos for further characterization of surface and porosity.

FIG. 4 shows pore volume distribution of flax shives measured using the BJH model. Similar to pore size distribution, flax shives are heterogeneous. As can be noticed, the pore volume distribution is skewed towards smaller pores.

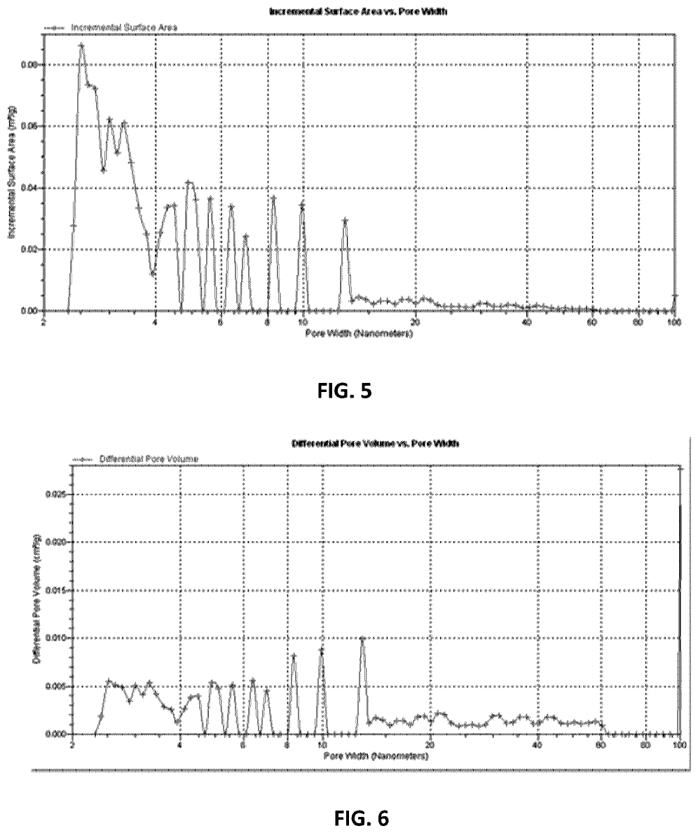

DFT model results are shown in FIGS. 5 and 6. According to these figures, flax shives have a multi-modal size distribution where smaller pores (diameter of 2 to 4 nm) account for higher percentage of the surface area available for adsorption. Pore volume distribution suggests that pore volume available for adsorption exist in pores with diameter ranging from about 3 to about 15 nm.

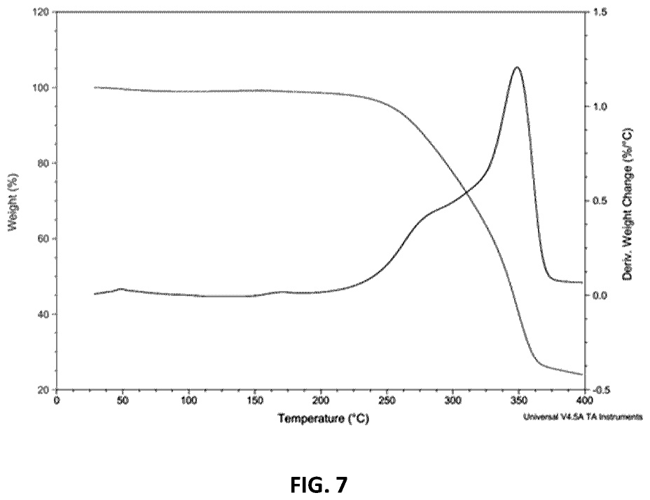

To study the thermal and pyrolytic properties of flax shives, a Thermal Gravimetric Analysis (TGA) test was carried out. In this test, the weight loss of a sample due to pyrolysis and decomposition is measured with time as the temperature is increased. According to FIG. 7, flax shives start to decompose at around 200° C. This temperature is far below the operating temperatures of the modified process described herein, which makes flax shives a suitable adsorbent.

Elemental analysis (CHNS) and proximate analyses (by ASTM 3173-78 (2003), ASTM 3174-04 (2004), and ASTM D3175-07 (2007)) of flax shives are reported in Table 3. These results demonstrate the organic nature of flax shives.

TABLE 3
Proximate and Ultimate analyses of flax shives

| | |
|---|---|
| Proximate Analysis | Ultimate Analysis |

| | | | |
|---|---|---|---|
| Volatile Matter | 84.62 ± 0.19 | C | 48.34 ± 0.09 |
| Ash Content | 11.05 ± 0.34 | H | 6.40 ± 0.16 |
| Moisture Content | 4.33 ± 0.09 | N | 0.70 ± 0.01 |

| | |
|---|---|
| S | 0.07 ± 0.00 |

### Dehydration Performance of the Process

To help demonstrate the use of the systems and methods described herein, an adsorption experiment was conducted. As part of the experiment, ultra high purity (5.0) methane, nitrogen and helium gas cylinders were purchased from a commercial gas supplier (Praxair). Deionized water was used to generate water vapor. The composition of the gas mixture was controlled using pressure regulators and mass flow controllers connected to the gas cylinders.

To start the adsorption experiment, feed gas with specific conditions was prepared and sent into a packed column of biosorbents. The composition of the outlet gas from the column was measured with time during the adsorption using a relative humidity sensor and gas chromatography method in order to measure the adsorption rate of each component in the gas. Once the breakthrough point was reached, the column was regenerated under vacuum.

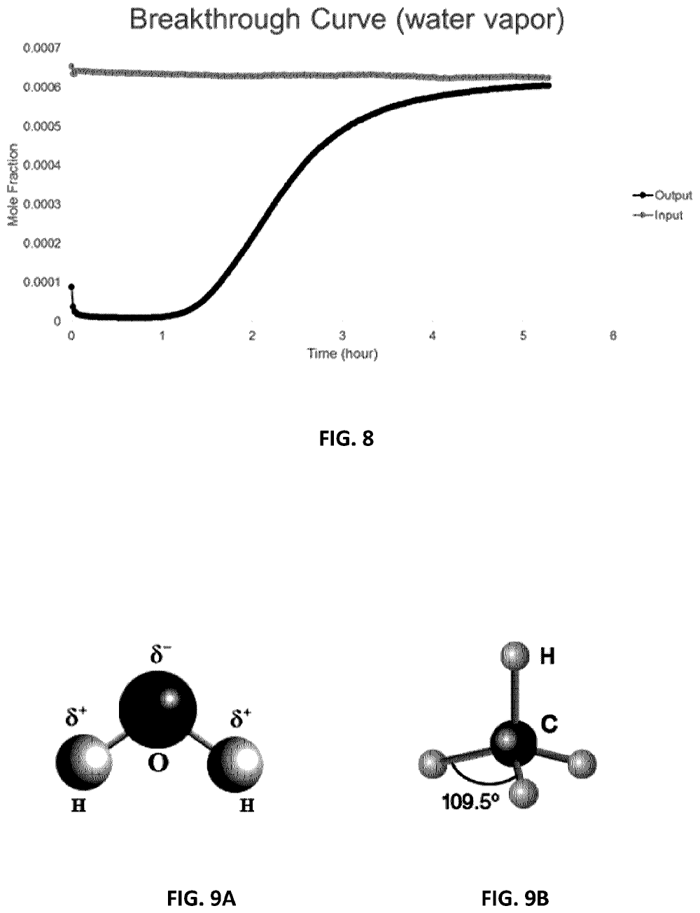

The breakthrough point for water is the point where C/Cₒ of water vapor equals to 0.01 and equilibrium or saturation point is usually considered to be the point where C/C₀ of water vapor equals to 0.95 or higher. FIG. 8 is an example of a breakthrough curve. C represents the water content in the effluent at a time t and Co denotes the water content in the feed gas.

Gas composition was analyzed by gas chromatography using a thermal conductivity detector (TCD) (SRI-58424HQ000, SRI International). Helium is used as the carrier gas. Based on differences in thermal conductivities, the concentration of each species is determined.

Water is a polar compound with an effective diameter of 2.75 Å. An image of a water molecule is provided in FIG. 9A. Methane is a non-polar compound with a small molecular diameter of 3.988 Å (see FIG. 9B), which is considerably smaller than the pore size distribution of raw biosorbents (Perry's handbook). Biosorbents may have an affinity to polar compounds, as compared to non-polar compounds, due to the generally hydrophilic surface of the biosorbent materials. For example, hydroxyl and carboxyl functional groups on the surface of biosorbents may help facilitate water vapor adsorption, while generally not facilitating the adsorption of non-polar gases such as methane.

To help understand the present systems and processes, the methane adsorption experiments were carried out at different operating conditions. A carrier gas system of nitrogen and methane with methane concentrations of 10%, 20%, 50% volume was prepared and sent to the adsorption column. Gas chromatography was used to measure the methane concentration of feed gas and effluent gas. Since adsorption is favorable at high pressure and low temperature, experiments were firstly run at 3 bar and 24° C. The total flow rate of feed gas was 4 L/min. Methane retention time in GC is 5 minutes; therefore, the feed gas was sent to the column, and the concentration of methane was measured every five minutes. No methane adsorption was observed, and the concentration of effluent gas after the start of the adsorption experiment was substantially the same as that of feed gas.

Feed concentration had no material effect on the methane adsorption. Same set of experiments was repeated at 1 bar and no methane adsorption was observed. In order to investigate the effect of methane residence time in the column, the total flow rate of feed gas was reduced to 2 L/min. Methane adsorption was tested at various pressures and feed concentrations, and it was concluded that residence time had no material effect on the adsorption process. Similarly, methane adsorption was negligible and non-detectable.

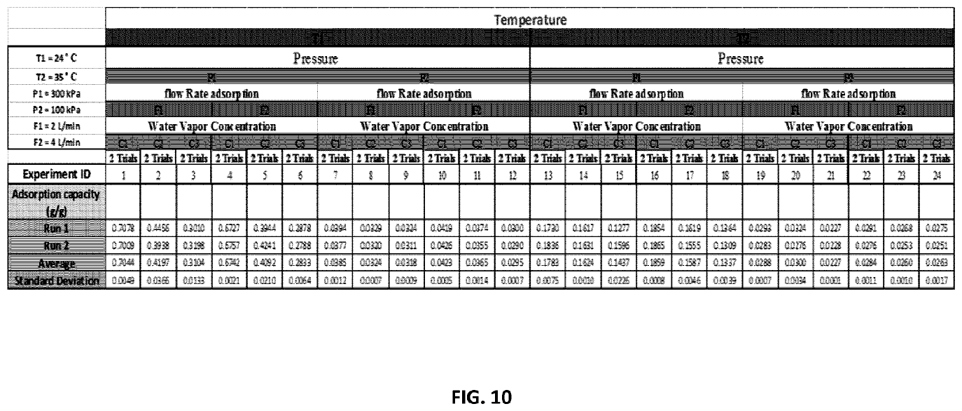

To further study the methane dehydration performance of flax shives, four independent variables were considered: pressure of the column, temperature of the column, concentration of water vapor in the feed gas, and total volumetric flow rate of feed gas. A full factorial experiment design was considered to study the effect of these operating parameters on the water vapor adsorption capacity of flax shives. FIG. 10 shows the full factorial design table, the levels of each factors, and the measured adsorption capacities for each experiment.

As shown in FIG. 10, 48 experiments were done to complete this full factorial design. Each experiment was repeated twice to help account for the reproducibility of data and to calculate the standard deviations. The values of adsorption capacity (grams of water adsorbed/grams of biosorbents) for both runs, their average, and standard deviations are reported in FIG. 10.

In order to help eliminate the random errors, disturbances in the system, human error, equipment wearing, and uncontrollable parameters in the overall experiment design, the 24 experiments were completed in random order (experiment IDs in Table 5). The experiments were done in this order based on experiment IDs: 1, 15, 5, 2, 11, 13, 16, 23, 3, 9, 7, 12, 6, 14, 18, 24, 17, 20, 19, 21, 4, 22, 8, and 10. Experiment ID is later considered as a random factor in statistical analysis of the full factorial design.

### Statistical Analysis of Factorial Experiment Design

SPSS statistical package was used to analyze this experiment design. The results are summarized in Table 4. As the results suggest, pressure, temperature, and mole fraction of water has significant effect on the adsorption capacity, while the effect of volumetric flow rate is not considerable. Second level interactions between temperature-pressure, temperature-mole fraction, and pressure-mole fraction are only significant. Among third level interactions, only temperature-pressure-mole fraction is statistically significant.

TABLE 4
Results of statistical analysis of factorial experiment design
Tests of Between-Subjects Effects
Dependent Variable: Adsorption Capacity

| | Type III Sum of | Degree of | Mean | | Significance |
|---|---|---|---|---|---|
| Source | Squares | Freedom | Square | F | level |
| Corrected Model | .926^{a} | 19 | .049 | 1299.484 | .000 |
| Intercept | .713 | 1 | .713 | 19013.651 | .000 |
| Temp | .148 | 1 | .148 | 3957.078 | .000 |
| Press | .479 | 1 | .479 | 12772.850 | .000 |
| Vol. Flow | .000 | 1 | .000 | 5.292 | .083 |
| MoleFrac | .053 | 2 | .026 | 701.107 | .000 |
| Temp * Press | .133 | 1 | .133 | 3558.950 | .000 |
| Temp * Vol. Flow | .000 | 1 | .000 | 3.395 | .139 |
| Temp * MoleFrac | .034 | 2 | .017 | 448.521 | .000 |
| Press * Vol. Flow | .000 | 1 | .000 | 6.826 | .059 |
| Press * MoleFrac | .047 | 2 | .023 | 621.368 | .000 |
| Vol. Flow * MoleFrac | 3.183E−5 | 2 | 1.591E−5 | .424 | .681 |
| Temp * Press * Vol. Flow | .000 | 1 | .000 | 5.127 | .086 |
| Temp * Press * MoleFrac | .031 | 2 | .016 | 418.432 | .000 |
| Press * Vol. Flow * | 3.654E−5 | 2 | 1.827E−5 | .487 | .647 |
| MoleFrac | | | | | |
| Error | .000 | 4 | 3.751E−5 | | |
| Total | 1.639 | 24 | | | |
| Corrected Total | .926 | 23 | | | |

Partial estimated squared values can be used to find out which factor among the significant factors has the highest effect on the adsorption capacity. According to Table 5, pressure had a significant effect on the adsorption capacity. Temperature and mole fraction are also relatively important factors, respectively. The interaction of temperature-pressure is another significant one among the other interactions. The pressure-mole fraction interaction is critical because saturated gas can hold less amount of moisture as the pressure increases. In other words, when the adsorption process is run at higher pressures, the mole fraction of feed (100% humid gas at max) decreases. The adsorption capacity increases with this increase in pressure, whereas it decreases with the decrease in the mole fraction of the feed (interaction of parameters); however, overall the adsorption capacity may increase or remain constant with an increase in pressure because the effect of pressure was more significant than the effect of feed mole fraction.

TABLE 5
Comparison of main effects and interaction effects
Tests of Between-Subjects Effects
Dependent Variable: Adsorption Capacity

| Source | Partial Eta Squared |
|---|---|
| Corrected Model | 1.000 |
| Intercept | 1.000 |
| Temp | .999 |
| Press | 1.000 |
| Vol. Flow | .570 |
| MoleFrac | .997 |
| Temp * Press | .999 |
| Temp * Vol. Flow | .459 |
| Temp * MoleFrac | .996 |
| Press * Vol. Flow | .631 |
| Press * MoleFrac | .997 |
| Vol. Flow * MoleFrac | .175 |
| Temp * Press * Vol. Flow | .562 |
| Temp * Press * MoleFrac | .995 |
| Press * Vol. Flow * MoleFrac | .196 |

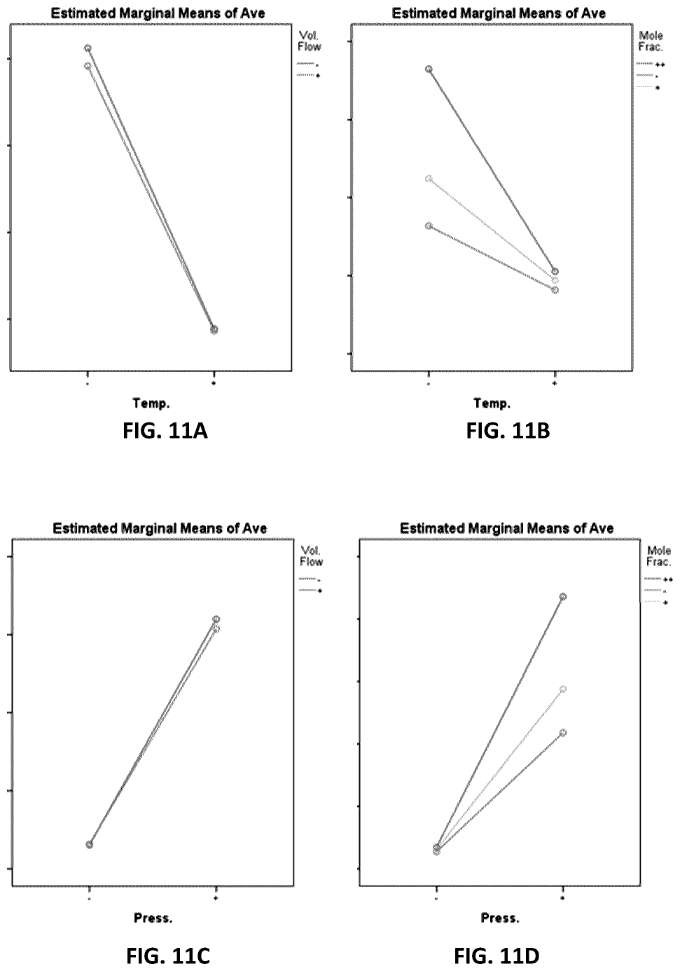

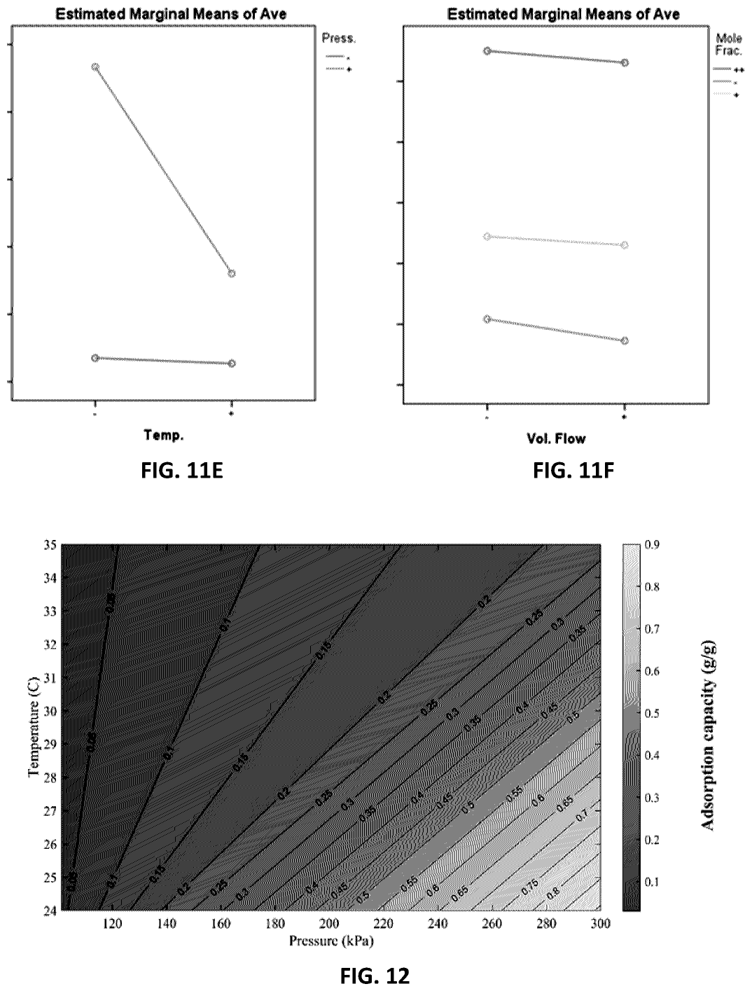

The interaction plots are shown in FIGS. 11A to 11F. Due to interactions between the independent variables, some of the lines are not parallel. The sharp changes in the estimated marginal means for pressure and temperature indicate their significance level, which are in harmony with the results in the above tables.

### Effect of Operating Parameters

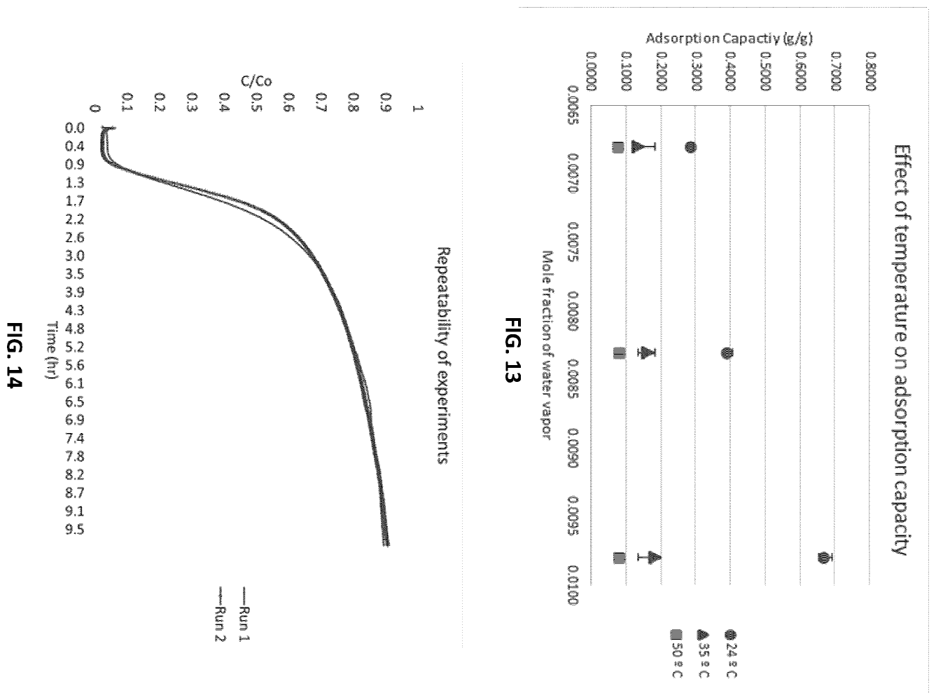

As mentioned before, pressure and temperature have a relatively significant effect on the adsorption capacity of flax shives. FIG. 12 shows the contour plot of adsorption capacity over the range of temperature and pressure in the experiment design. The highest adsorption capacity is achieved at relatively high pressure and at a relatively low temperature (i.e. about 3 bar and about 24° C.).

FIG. 13 shows the effects of temperature and water vapor mole fraction. As shown, the higher the temperature, the lower the adsorption capacity. In addition, adsorption capacity is obviously higher at higher mole fractions of water vapor (isotherm). The magnitude of this increase varies with temperature.

Each experiment in the factorial experiment design is repeated to check the reproducibility of the data. FIG. 14 shows the breakthrough curve for two consecutive runs of experiment number 5 in the design table. As can be noticed, the curves overlap and the results are repeatable.

Discussion and Comparison with Applied Dehydration Processes in Industry

The dehydration performance of flax shives was investigated and the effect of main operating parameters were studied. In this section, the authors discuss some of the apparent advantages of the modified dehydration process using biosorbents, as compared to some examples of conventional dehydration processes.

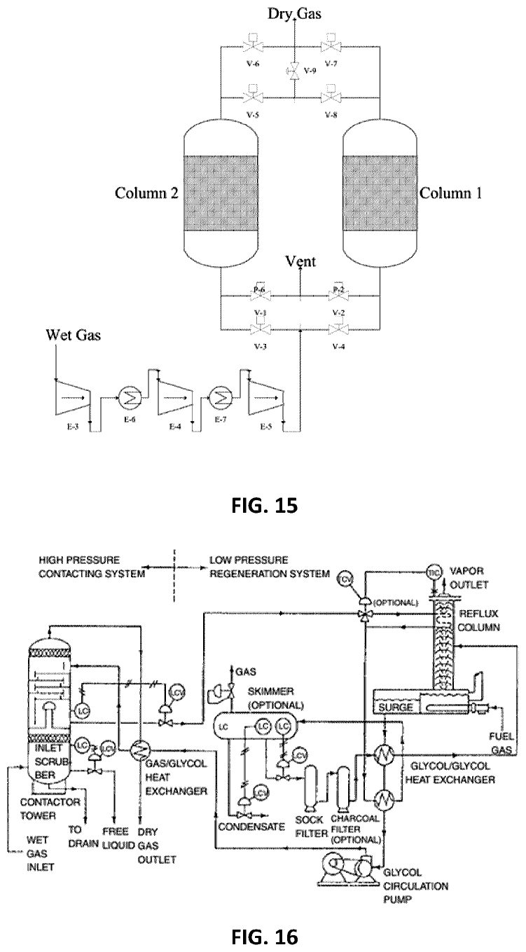

A flowsheet of the PSA process used for air drying is shown in FIG. 15. In FIG. 15, air is supplied from atmosphere and sent into a multi-staged compressor with intercoolers to compress air up to 5-6 bars. This process operates based on the Skarstrom cycle that is comprised of four steps: 1) pressurization, 2) adsorption at high pressure, 3) purge, and 4) depressurization. For instance, column 1 is pressurized, while column 2 is depressurized. Then, adsorption takes place at high pressure in column 1 and desorption takes place at atmospheric pressure in column 2. At this step, a fraction of dried air from column 1 is sent into column 2 as a carrier gas to regenerate column 2; this stream is vented out to atmosphere (see FIG. 16). This is why the recovery of this process is low. Afterwards, the columns are switched and these four steps are repeated in a cycle.

As mentioned before, the compressing is a significant operating and capital cost in this process. In addition, the capacity of these plants can be limited by the capacity of the related compressors. Multi-bed PSA process may be used to increase the capacity of the plant; however, more compressors should be used in a parallel configuration (due to limited capacity of compressors), which can make this process costly. Moreover, commercial adsorbents adsorb nitrogen and oxygen from air in addition to water vapor (low selectivity).

Glycol dehydration process another process used in the natural gas industry despite its drawbacks and major operating issues. FIG. 16 shows the flowsheet of this process. In general, natural gas is sent into an absorber column and brought in contact with liquid glycol. Glycol absorbs water and some other components from the natural gas, and dries the gas. This wet or rich glycol is then regenerated and recycled back in the process. A distillation column is used for this purpose. The absorber column operates at around 50° C., while the distillation column operates at 200° C. Therefore, several unit operations are used to change the temperature of this glycol stream, and circulate it between the two columns. The shortcomings of this process can include:
1. Relatively insufficient dehydration because of limited equilibrium between glycol and water vapor
2. Glycol loss in the absorber column due to foaming and liquid carry over
3. Thermal degradation of glycol due temperature fluctuations
4. Potentially non environmentally friendly due to release of BTEX in the Skimmer (FIG. 16)
5. Contaminations in the pumps, filters, and reboiler, that cause corrosion and other operating issues
6. Pump wear, heat exchanger fouling, and complex control systems

This process is strictly prohibited in recent decades due to pollution issues (BTEX). Therefore, most companies switched to either temperature swing adsorption process or condensation (cryogenic) process.

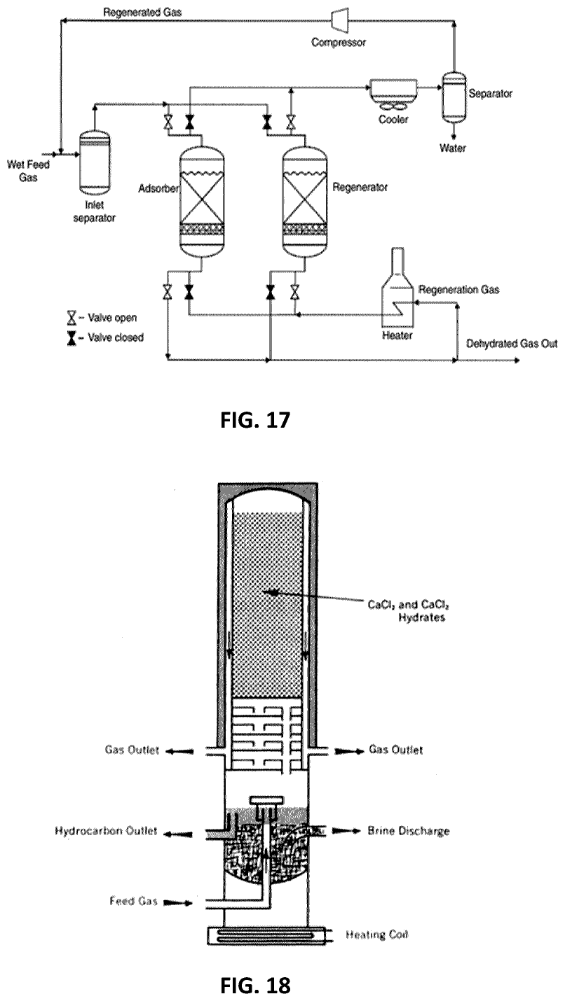

One example of a flowsheet of temperature swing adsorption is shown in FIG. 17. As can be noticed, a fired heater is used to increase the temperature of gas for regeneration of columns. Similar to the PSA process, a fraction of final product (dry gas) can be heated up to 250° C., and may be used to regenerate the columns. This high regeneration temperature contributes to the relatively high operating cost of this process. Furthermore, commercial adsorbents may tend to adsorb Methane in addition to water vapor (i.e. a relatively low selectivity), which can necessitate a recycle system to help recover the adsorbed methane. The temperature and pressure of the recycled gas are adjusted prior to mixing with the feed gas, which can require a cooler, a compressor, a flash drum and several valves and control systems. These unit operations contribute to both capital and operating costs. Thermal degradation of adsorbents is another serious drawback of this process. Due to constant temperature fluctuations, adsorbents lose their water vapor adsorption properties; therefore, premature breakthrough leads to insufficient dehydration and many operating problems in this process. Finally, commercial adsorbents such as molecular sieves are very sensitive to liquid carryover; therefore, an expensive and complex inlet separator is needed, which must be carefully controlled to protect the adsorbents (FIG. 17).

Dehydration using calcium chloride pellets is another alternative process. As can be seen in FIG. 18, wet gas is sent into packed bed column with CaCl₂) pellets, and dry gas is drawn from the outlet. The efficiency of this process is very low, and it is expensive because the adsorbents cannot be regenerated, and must be replaced by fresh adsorbents frequently. Moreover, due to limited equilibrium between calcium chloride and water vapor, insufficient dehydration is another operating issue in this process.

Commercial adsorbents for dehydration purposes are silica gel (0.35-0.5 g/g), molecular sieves (0.21-0.26 g/g), and alumina (0.25-0.33 g/g). The adsorption capacity of flax shives is more than twice that of alumina and molecular sieves, and is higher than that of silica gel, which is a hydrophilic, complex synthetic adsorbent. These commercial adsorbents tend to adsorb Methane and air in the dehydration processes (i.e. have relatively low selectivity). The relatively high adsorption capacity and the up to 100% water vapor selectivity of the flax shives tested surprised the inventors, and initiated the thought of creating a new dehydration process.

Dehydration performance of flax shives, their properties, and the modified swing adsorption process are described herein, and experimental data are presented and discussed. Flax shives appear to be a relatively cost-effective and relatively high performance adsorbent that may be suitable for use in the dehydration of natural gas and other multi-component gas mixtures, including when used with the modified processes described herein.

### Biosorbents

In another example, biosorbents were developed from flax shives. Raw flax shives were supplied from Schweitzer-Mauduit Canada, Inc., Winkler, Manitoba. The flax shives were oven dried and sieved. In the experiments, two columns were used. Both columns were filled with different batches of flax shives. The particle size distribution of flax shives was 0.425-1.18 mm and they were oven-dried at 105° C. for 24 hours before packing. In another example, flax shives with a particle size of 1.18-3 mm can be used. Ultra-High Purity (5.0) N₂ gas was purchased from Praxair Canada and used for the experiments. It had previously been confirmed that flax shives adsorbed negligible amounts of methane and carbon dioxide and had almost 100% selectivity towards water vapor; therefore, due to safety issues, nitrogen gas was used in the experiments as a representative nonpolar gases.

### Continuous Dual-Column Adsorption Experiments

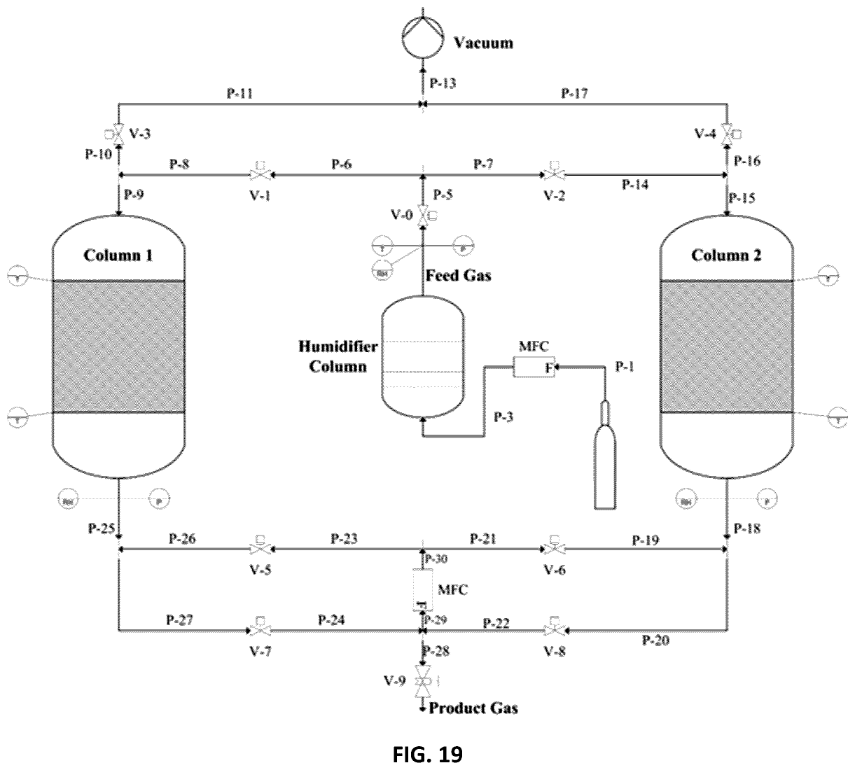

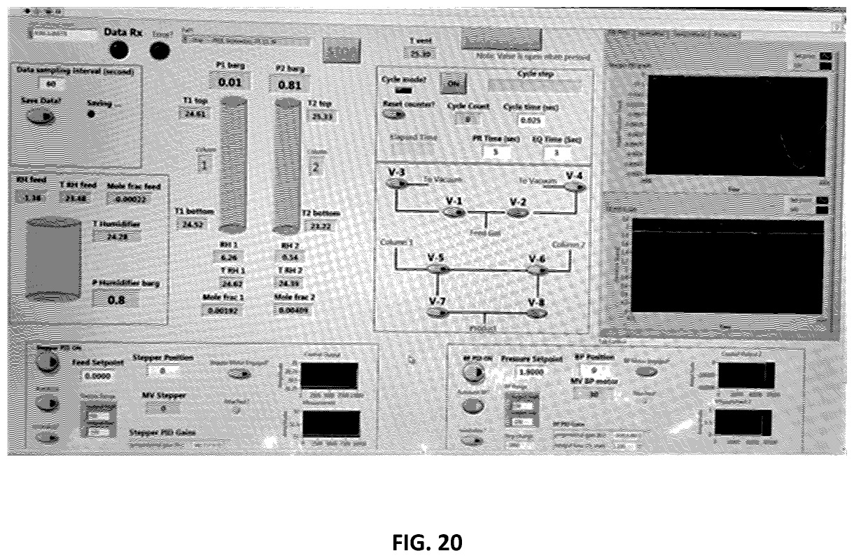

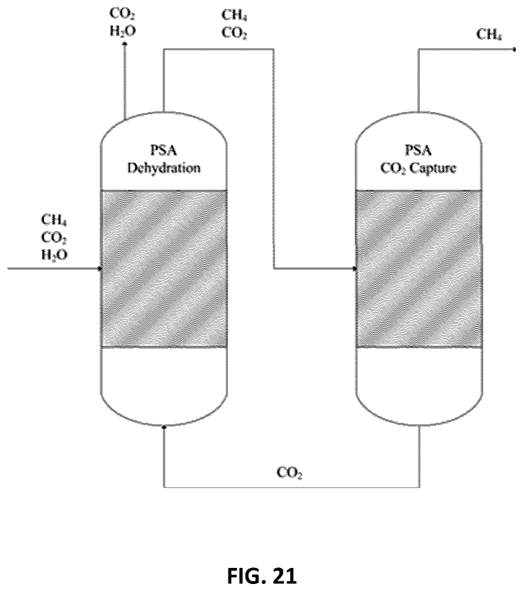

One exemplary dual-column PSA process setup is described herein. FIG. 19 shows a P&ID the exemplary dual-column PSA process. The process setup is fully automated and controlled by a control system (e.g. a Labview program) described below. The control system may run the 6-step and 10-step PSA processes described below. FIG. 20 is an overview of the control system.

### Six-Step PSA Process

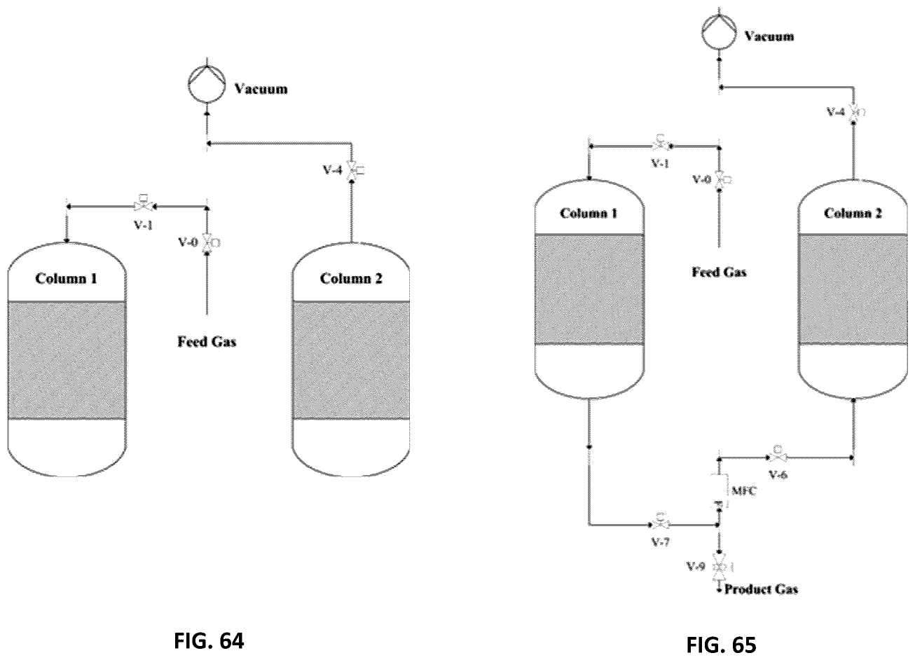

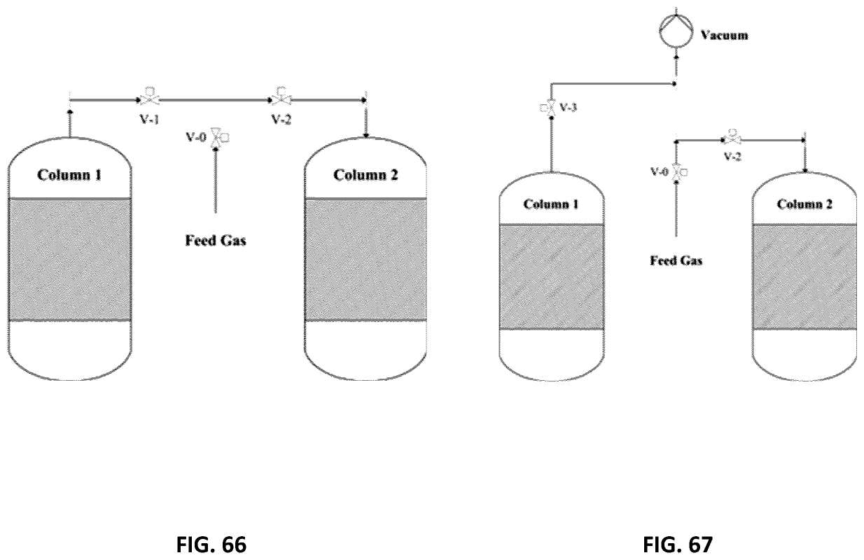

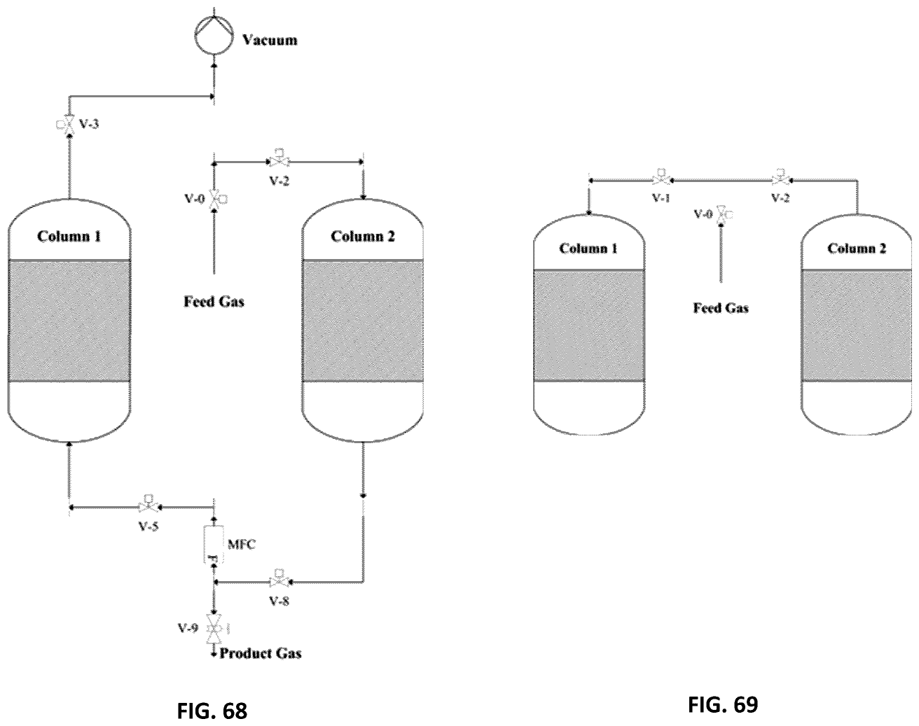

In an exemplary six-step dual-column PSA process, each bed undergoes the following steps: 1) pressurization (PR), adsorption (ADS), pressure equalization (PE), depressurization (DPR), regeneration (REG), and pressure equalization. These steps are repeated in a cyclic operation in order to achieve a steady-state dehydration process. Table 6 summarizes this cyclic operation. Piping and instrumentation diagrams (P&ID) of these steps are shown in FIGS. 64 to 69. Each column experiences these 6 steps repeatedly. For example in column 1, the cycle starts with pressurization of the column. In this step the wet feed gas is sent into the column while the outlet valves are closed (FIG. 64). Once the pressure of the column reaches the set point, the adsorption step starts. Dry product gas is draws from the bottom of the column during this step (FIG. 65). After a specific cycle time (a few minutes), the two columns are connected from the top for a few seconds until they reach a same pressure (FIG. 66). The purpose of this step is to use the gas part of the gas holdup in column 1 to pressurize column 2; and as a result, improve the total recovery of the process. Afterward, column 1 is depressurized to atmospheric pressure and the gas holdup can be recycled back to the system (FIG. 67). Next, a portion of the dry product gas (carrier gas) is sent to column 1 to carry the desorbed moisture from the column while the column is connected to the vacuum line to decrease the pressure of column (FIG. 68). The volumetric flow rate of this carrier gas at low pressure (vacuum) can be at least equal to or higher than the volumetric flow rate of the feed gas at high pressure. This stream can be recycled back to the system as well. A lower vacuum level result in a higher recovery rate and a lower recycling cost. The final step of the cycle is similar to step 3 where a portion of the gas holdup in column 2 is used to pressurized column 1 (FIG. 69). The recycling of the gas holdup and the carrier gas is optional. In other embodiments, the total recovery and economics of the six-step process with and without recycling are discussed. This process may have a total recovery of about 100% and a higher recovery and gas recompression and recycling cost than the 10-step PSA process for natural gas dehydration (described below).

TABLE 6
Configuration and steps in a six-step dual column
PSA process for natural gas dehydration.

Cycle Step

| | 1 | 2 | 3 | 4 | 5 | 6 |
|---|---|---|---|---|---|---|
| Column 1 | PR | ADS | PE | DPR | REG | PE |
| Column 2 | DPR | REG | | PR | ADS | |

### Ten-Step PSA Process

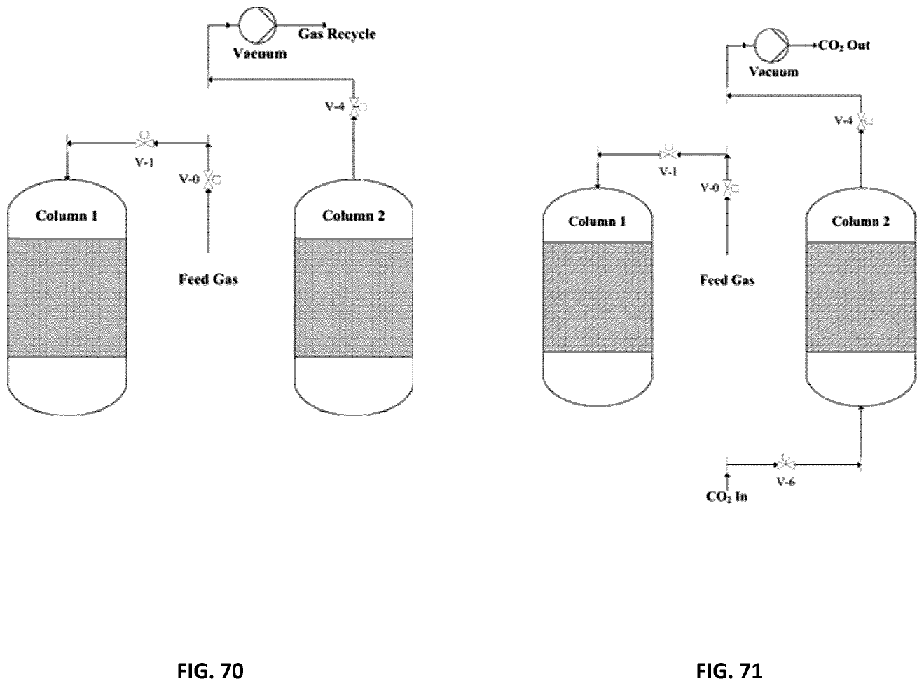

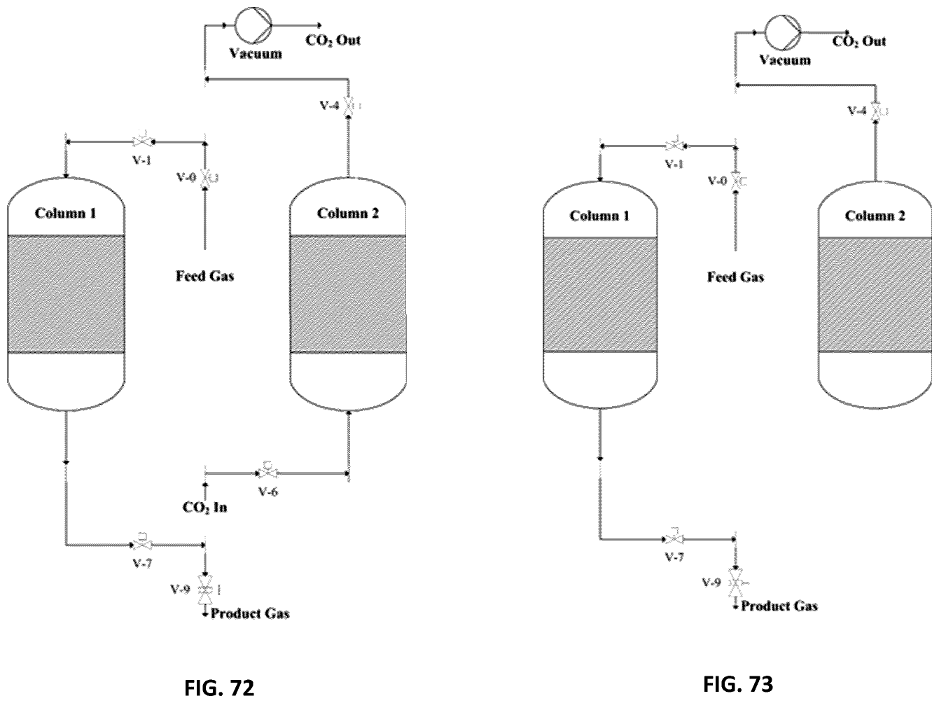

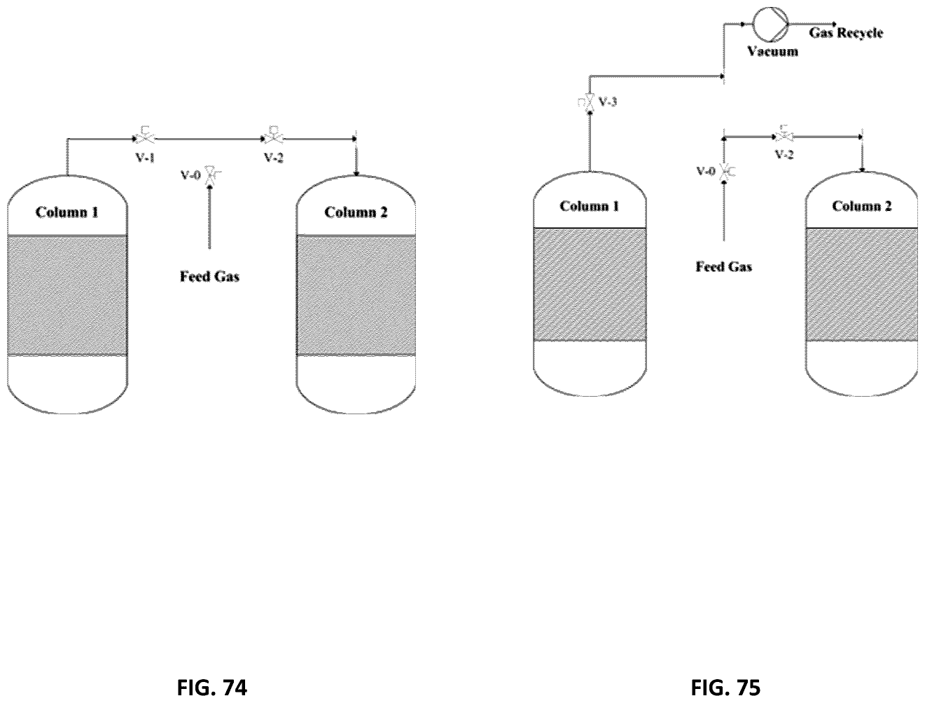

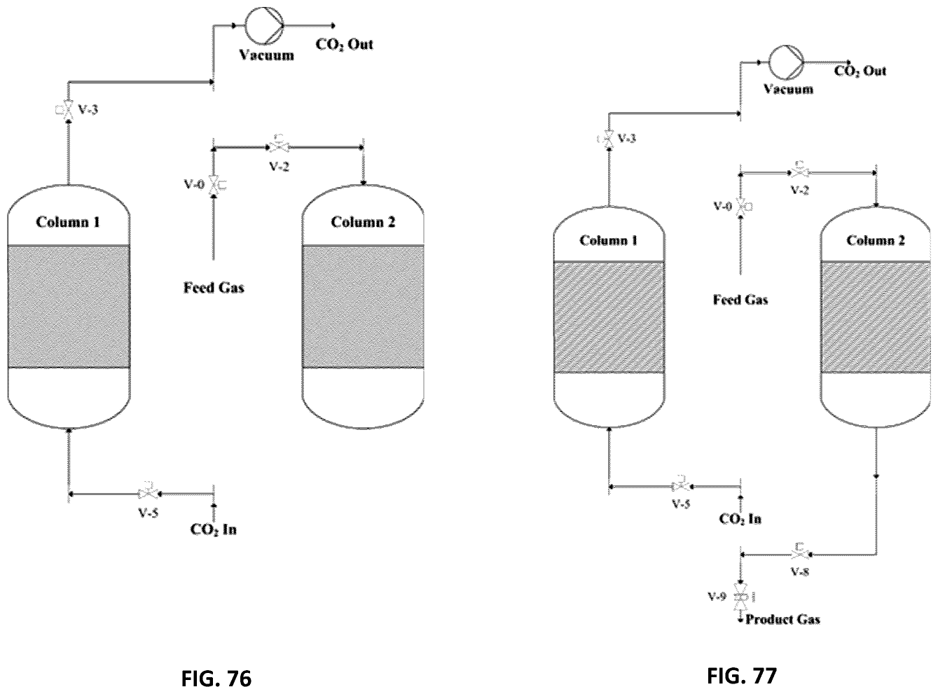

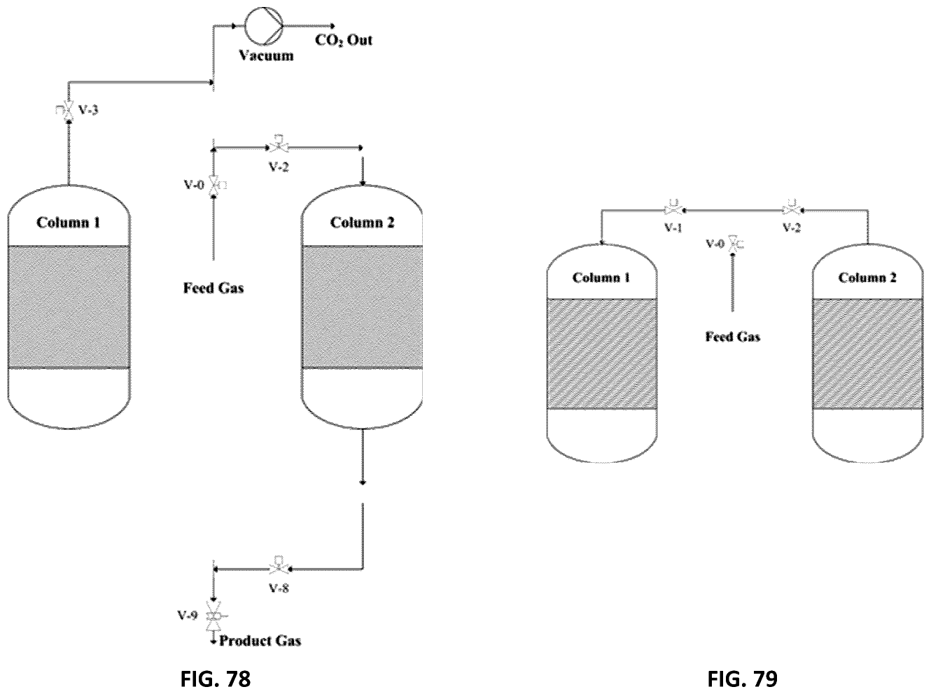

In an exemplary 10-step PSA process for natural gas dehydration may be used when a CO₂ stream is available (e.g. in the plant site) to regenerate the columns. This process may result in a lower gas recompression and recycling cost and a total recovery of 99.99%. The steps of this process are summarized in 7 and P&IDs are shown in FIGS. 70 to 79. The steps in this process are similar to those of the six-step PSA process and the only difference is two additional evacuation steps (EVC). The evacuation steps are added to minimize the CO₂ holdup in the column and natural gas contamination with CO₂. The CO2 feed to the column (carrier gas) is stopped during this step and the column is connected to the vacuum pump for a few seconds or minutes (depending on the size and volumetric flow rate of the feed gas) in order to evacuate the column from CO₂ as much as possible (FIGS. 73 and 78). By the end of this step, the CO₂ holdup in the column is negligible as it was measured and discussed in another embodiment. A lower vacuum level would result even a lower CO₂ holdup in the column, which may not be necessary as a more expensive vacuum pump might be required.

TABLE 7
Configuration and steps in a 10-step dual column
PSA process for natural gas dehydration.

| | Cycle Step | | | | | | | | | |
|---|---|---|---|---|---|---|---|---|---|---|
| | 1 | 2 | 3 | 4 | 5 | 6 | 7 | 8 | 9 | 10 |
| Col- | PR | PR | ADS | ADS | PE | DPR | REG | REG | EVC | PE |
| umn | | | | | | | | | | |
| 1 | | | | | | | | | | |
| Col- | DPR | REG | REG | EVC | | PR | PR | ADS | ADS | |
| umn | | | | | | | | | | |
| 2 | | | | | | | | | | |

One possible advantage of the 10-step PSA process is that the product gas may be 100% drawn from the columns' outlet, whereas a portion of the product gas was used for the regeneration of the other column in the 6-step PSA process. Therefore, only the gas holdup in the columns after the pressure equalization step need to be recompressed and recycled back to the system, which is very low. The gas recompression (capital and operating cost of gas compressors) is less costly in the 10-step PSA process, while in the 6-step PSA process, a continuous flow of gas is passed through the column during a cycle time, which need to be recompressed and recycled.

Step 4 and 9 in this process are considered to minimize natural gas contamination with CO₂. As can be noticed in the P&IDs in FIGS. 70 to 79, the columns are evacuated using a vacuum pump to minimize the CO₂ holdup in the columns after steps 4 and 9. Afterward, the columns contain negligible amounts of CO₂; hence, in step 5 and 10 when the columns are connected for the pressure equalization, the natural gas contamination is very negligible (the void volume of the columns is much lower than the feed gas total flow rate).

In some embodiments, the flow rate required to regenerate the PSA columns is very low as the regeneration process is run under vacuum. Additionally, this PSA process for natural gas dehydration may be effectively integrated with another PSA process for CH₄/CO₂ separation (e.g. using Zeolite adsorbents). The CO₂ product from this PSA separation process can be used as the regeneration gas in the PSA dehydration process using biosorbents (see Error! Reference source not found.).

### Breakthrough Curve Study

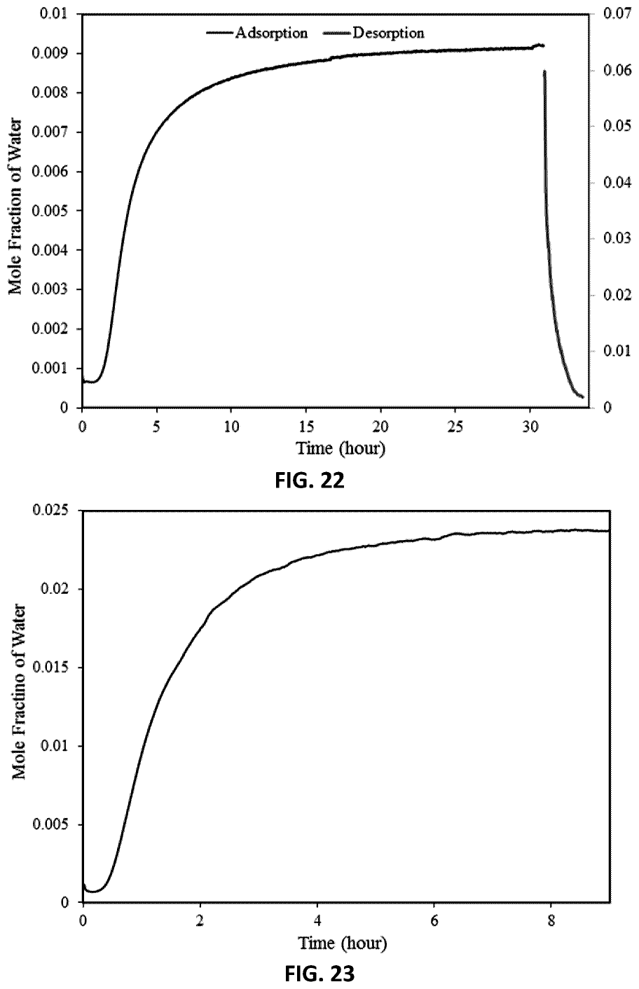

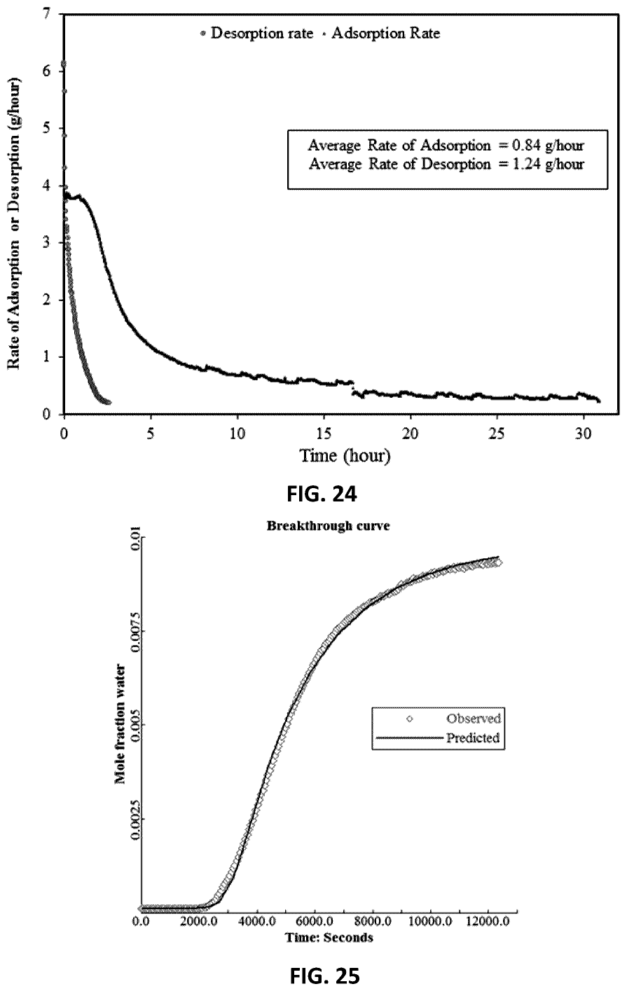

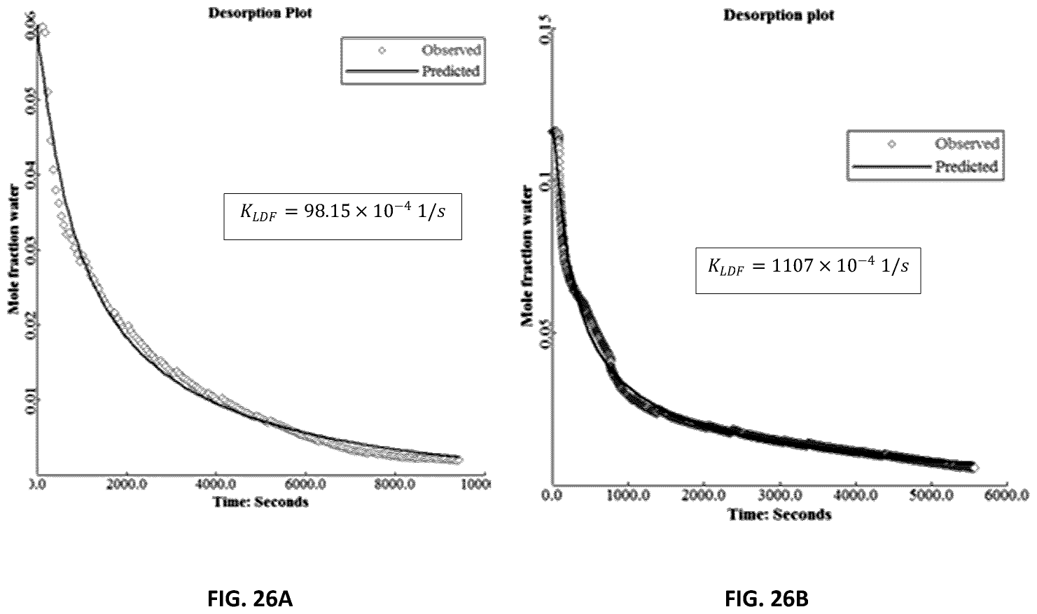

Breakthrough studies provide information about the adsorption capacity, adsorption rates, and kinetics of an adsorption process. The study in this section was done in a single column. FIG. 22 shows the breakthrough and regeneration curves of flax shives at 300 kPa, 24° C., 100% humid feed gas, and a gas flow rate of 3 L/min. Desorption was done under a vacuum of 74 kPa and a gas flow of 4.5 L/min. Firstly, the adsorption capacity of flax shives at these conditions is 0.91 g/g. Secondly, the adsorption time (30 hours to approximately saturate the whole bed) is much longer than the regeneration time (2.5 hours to free the column from moisture); hence, the desorption rate seems to be much higher than the adsorption rate.

The breakthrough study was also done at atmospheric pressure and 24° C. (see Error! Reference source not found.). The feed gas was 100% humid with a flow rate of 3 L/min. The adsorption capacity of flax shives at these conditions was 0.57 g/g.

### Adsorption-Desorption Rate Study

The purpose of this study is to investigate whether the rate of adsorption and desorption in the biosorbent are comparable. The rate of desorption must be equal or higher than the rate of adsorption in every PSA cycle (few seconds to minutes depending on the process and adsorbents) for a continuous cyclic process. In this work, the average rate of adsorption/desorption in the entire column was determined using the breakthrough and regeneration curves. In this method, numerical integration techniques were used in the rate calculations. The data from sensors including the RH sensor was recorded every minute; therefore, the mass flows of water vapor in the inlet and outlet of the column are known in every time interval. The mass of water adsorbed/desorbed in each time interval is equal to (mass input−mass output); hence, the rate of adsorption/desorption can be calculated as follows:

$$Rate = \frac{[ {( {\dot{m}}_{in} - {\dot{m}}_{o u t} )}_{a t ( t + Δ t )} {-}^{\cdot } {( {\dot{m}}_{in} - {\dot{m}}_{o u t} )}_{a t ( t )} ] \times Δ t}{Δ t} = Δ {\dot{m}}_{i n} - Δ {\dot{m}}_{o u t} \qquad ( 1 )$$

where \dot{m} is the mass flow rate (g/hour), and Δt is the time interval of sensor measurements. The rates are shown in Error! Reference source not found. 24 for both the adsorption and desorption. As predicted the rates are not constant during the process, and are decreased with time mostly due to the decrease in the driving force (concentration gradient) as the bed become saturated or regenerated. Firstly, the average rate of desorption was higher than the average rate of desorption. Secondly, the rate of desorption in the beginning of the process (6.09 g/hour) was much higher than that of adsorption (3.78 g/hour). Hence, the regeneration properties of the biosorbent seem to be suitable for the PSA process.

In a continuous dual-column PSA process, the adsorption bed is usually operated for a number of minutes; and then, it is regenerated for the same amount of time in each cycle; hence, the bed is often partially saturated. As can be seen in Error! Reference source not found. 25, the rate of desorption is higher than that of adsorption in the first 10 minutes of the operation; therefore, a cycle time around 10 minutes should work for a continuous dual-column PSA process.

The pressure swing adsorption process (PSA) is usually modeled by a system of coupled PDEs, ODEs, and algebraic equations. The PDE equation of gas phase mass balance takes the following form:

$$\frac{\partial {C}_{g i}}{\partial t} = - {u}_{f} \frac{\partial {C}_{g i}}{\partial z} + {D}_{L} \frac{{\partial }^{2} {C}_{g i}}{\partial {z}^{2}} - \frac{{ρ}_{s}}{e} \frac{\partial {\overline{\overline{q}}}_{i}}{\partial t} \qquad ( 2 )$$

where C_{gi} is the concentration of component i in the gas phase (mole/bed void volume), u_{f} is the interstitial velocity (m/s), D_{L} is the axial dispersion coefficient (m²/s), q̅ᵢ is the average loading of the biosorbent (mole/kg adsorbent), e is the bed voidage z is the axial distance (m), ρₛ is the bulk density of adsorbent, and t is time (s). The boundary and initial conditions for this PDE during the high-pressure adsorption are:

$${C}_{gi} {\vert}_{t = 0} = {C}_{0} , {C}_{gi} {\vert}_{z = 0} = {C}_{in} , \frac{\partial {C}_{gi}}{\partial z} {\vert}_{z = H} = 0 \qquad ( 3 )$$

The bed is initially free of moisture; so Cₒ for water vapor is considered 10⁻⁶. The concentration of methane and water vapor in the feed gas at z=0 are known (Cᵢₙ). The term

$$\frac{\partial {\overline{\overline{q}}}_{i}}{\partial t}$$

represents me rare or absorption or sink term in the equation. The linear driving force (LDF) is one of the most common expression used for the rate of adsorption/desorption term in the equation, which takes the following form^{6,7}:

$$\frac{\partial {\overline{\overline{q}}}_{i}}{\partial t} = ( 1 - e ) {k}_{LDF} ( {q}^{*} - {\overline{\overline{q}}}_{ι} ) \qquad ( 4 )$$

where q* is the biosorbent loading at equilibrium with the gas phase, and k_{LDF} is the effective mass transfer coefficient (1/s). Table 8 is a summary of the parameters used in this kinetics modeling:

TABLE 8
Parameters used in the modeling

| Bed voidage | 0.32 | |
|---|---|---|
| Interparticle voidage | 0.71 | |
| Height of biosorbent layer | 49 | cm |
| Internal diameter of biosorbent layer | 5 | cm |
| Average particle size | 1.01 | mm |
| Bulk density | 155.16 | kg/m³ |
| True density | 1.35 | g/ml |
| Specific surface area (H₂O) | 1005 ± 81 | m²/g |

This model was fitted on the experimental data (breakthrough curve) and the mass transfer coefficient was determined. As can be seen, the model showed an excellent fit and a value of

$$0.58 \times 1 {0}^{- 4} ( \frac{1}{s} )$$

was obtained for the mass transfer coefficient.

Desorption rate is critical in a PSA process. The biosorbent bed must be sufficiently regenerated in a cycle time; otherwise, adsorbates would accumulate in the bed causing a premature breakthrough. Similarly, the kinetics model was used to determine the desorption rate at 24 and 35° C. The fitted desorption curves and mass transfer coefficients were shown in Error! Reference source not found. A and B. As can be noticed, the model could correctly predict the desorption curve. The deviations in the experimental data are due to the fluctuations in the vacuum pump used during the desorption process. The values of mass transfer coefficients (K_{LDF}) for desorption process were much higher than those of adsorption process. So these results are in harmony with those reported in Error! Reference source not found. In summary, the desorption rates were fast and the biosorbent has excellent regeneration properties, which makes it a suitable adsorbent for gas dehydration in a PSA process.

### High Pressure Tests in the Continuous Dual-Column PSA Process

In this experiment, the columns were operated at an adiabatic condition. These columns were equipped with a jacket that was kept at a vacuum of 3 μHg throughout the experiment to minimize heat loss. The column flanges were covered by a heat insulation material to avoid heat loss from the columns' inlet and outlet. The 100% humid gas was fed from the top while dry product gas was drawn from the bottom, whereas the columns were regenerated counter-currently from the bottom in order to avoid product contamination with water vapor. A cycle time of 10 minutes was considered based on adsorption-desorption rate measurements discussed in previous embodiments. The pressure equalization time was 5 seconds. A normal building vacuum was used to regenerate the columns (39 kPa absolute). The PSA process was run for 85 cycles until a full T-size nitrogen gas cylinder was dehydrated (5002 liters at 3 bar). The volumetric flow rate of feed gas (V_{F}) and regeneration gas (V_{R}) were 3 and 4.5 L/min, respectively. The standard ratio of

$$\frac{{V}_{R}}{{V}_{F}} = 1.5$$

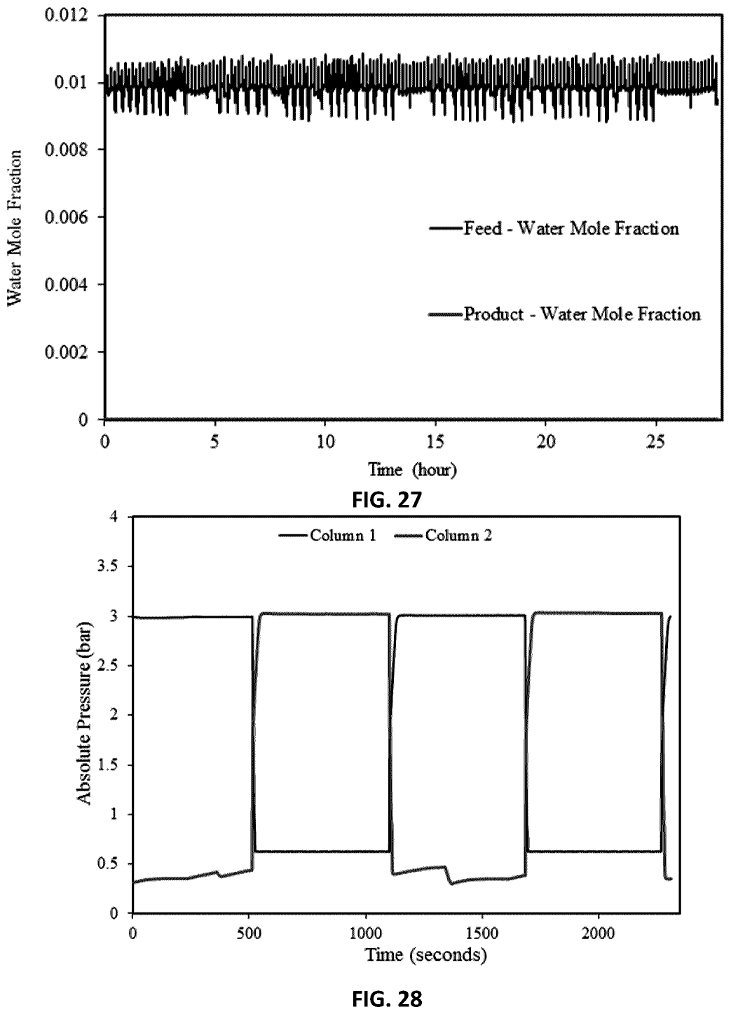

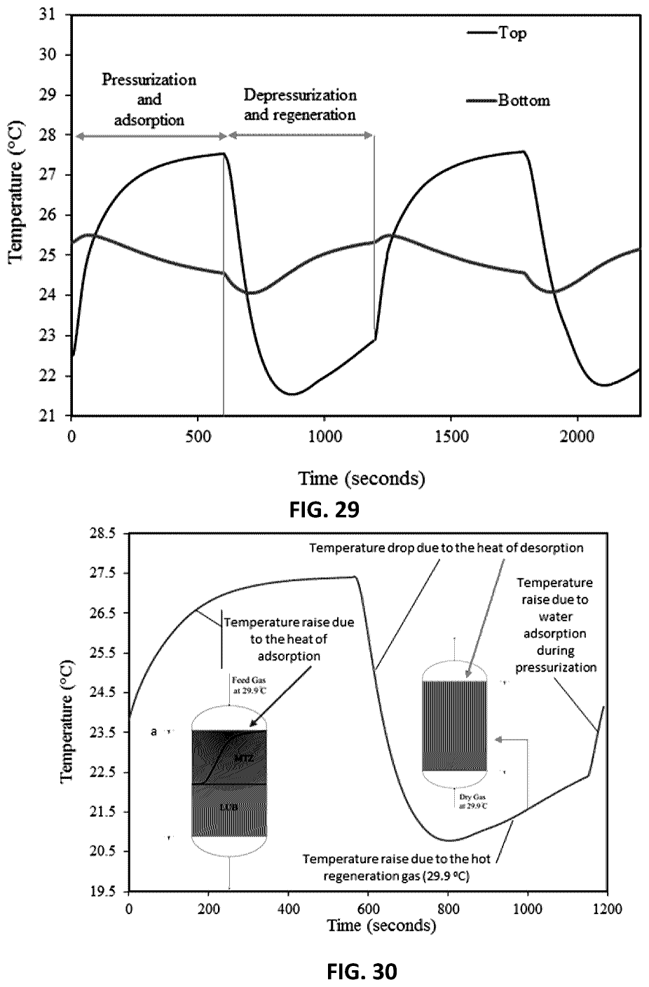

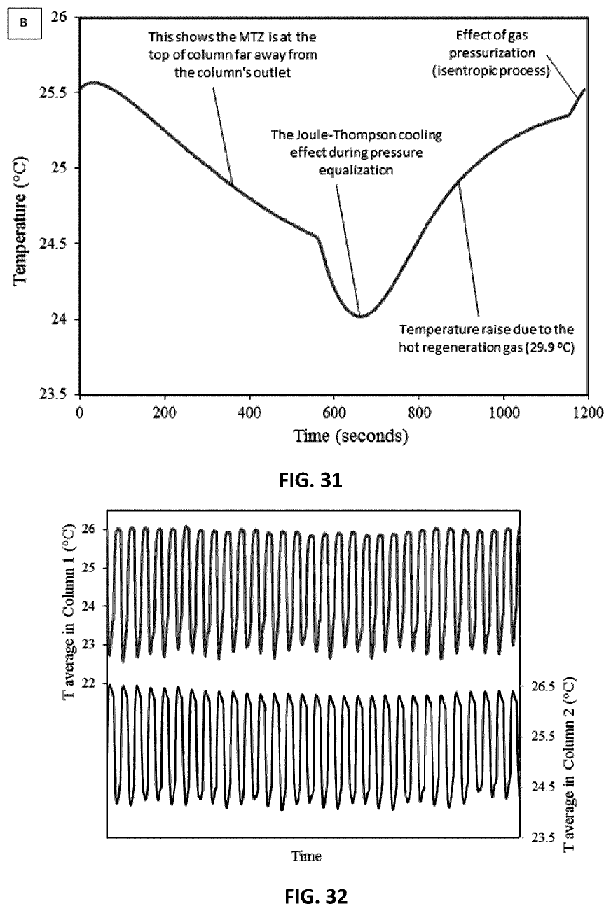

was considered in this experiment. The feed gas temperature was controlled at 29.92±0.21° C., which is the usual temperature of sweet gas in natural gas plants, and the mole fraction of water vapor in the feed gas was 0.0098±0.0002 (100% relative humidity). The mole fraction of water vapor in the feed gas and product gas was recorded every second throughout the experiment using a data acquisition system. FIG. 27 shows the water vapor profile throughout this experiment. As can be seen, the feed mole fraction was controlled at 0.0098 and dry gas was collected as the product throughout the 85 cycles. This experiment confirms that this PSA process can effectively dehydrate nitrogen, methane, carbon dioxide, and other nonpolar gases.

Cyclic pressure and temperature profiles during two cycles are shown in Error! Reference source not found. and 29. During this cyclic operation, each column runs at 300 kPa for 10 minutes followed by a 5 second pressure equalization where both columns reach an equal pressure of approximately 170 kPa; then, the column is depressurized and kept under a vacuum of 39 kPa for another 10 minutes. Two temperature sensors were installed to record the temperature at the top and bottom of the column. As can be seen, the temperature at the top of the column (where humid feed gas was sent) increased during the pressurization and adsorption steps because of the heat of adsorption, while it decreased during the pressure equalization and regeneration steps due to the heat of desorption. The temperature profile of the column provides valuable information about the performance of the system, which is discussed in detail in the following sections.

FIG. 30 shows the detailed analysis of the column temperature profile during a cycle. As can be noticed, the temperature at the top of the column sharply increased due to the heat of adsorption during the pressurization and adsorption steps. In the meantime, the temperature at the bottom of the column slowly decreased as the heat of desorption (from the previous cycle) dissipated to the bottom of the column with the gas flow (the process is adiabatic, so all thermal energy was contained within the column). This observation also confirms that the mass transfer zone (MTZ) was at the top of the column and far away from the column's outlet. The length of mass transfer zone at 24 and 35° C. was 10.8 and 7.09 cm, respectively. In an adiabatic condition, the length of mass transfer zone changes as the temperature does during a cycle; however, the total height of the biosorbent bed in the column (49 cm) was much higher than the length of mass transfer zone in this experiment, which ensured the breakthrough point was not reached in this cyclic operation.

Afterward, the temperature at the top and bottom of the column sharply decreased due to the pressure equalization step (Joule-Thompson effect).⁷ Next, the temperature at the top continued to decrease due to the heat of desorption (MTZ was at the top of the column, see Error! Reference source not found. A), while the temperature at the bottom gradually increased since the dry regeneration gas at 29.9° C. was being sent from the bottom of the column. Finally, the temperature at the top and bottom increased due to the pressurization step; then, this cycle repeats repeatedly.

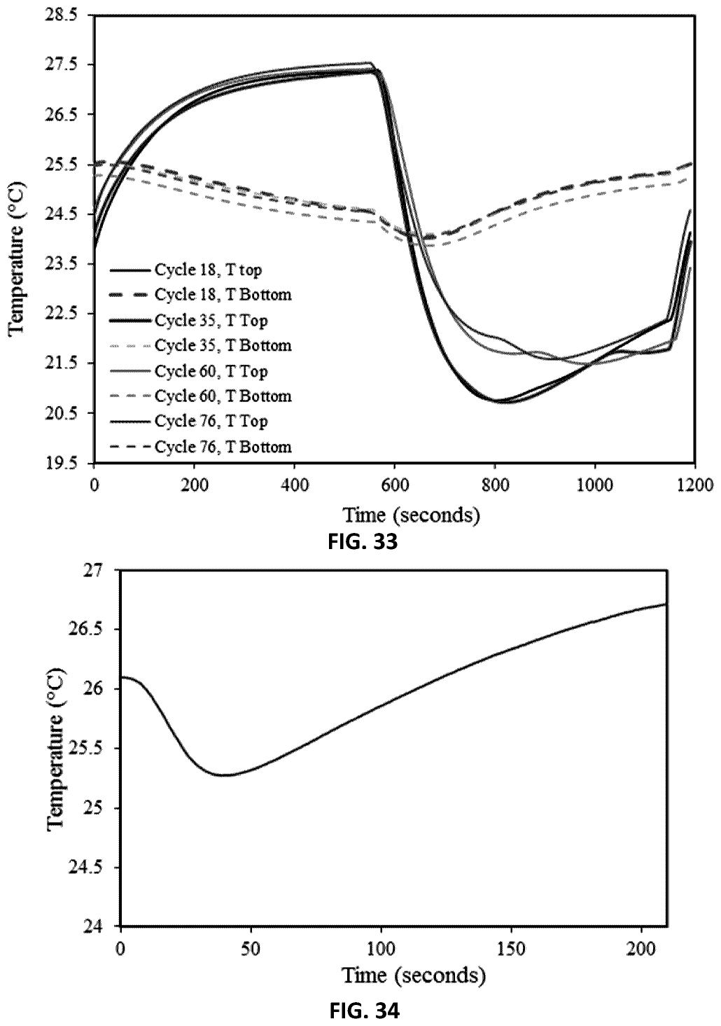

The most critical observation here was the temperature profile at the top during the regeneration step (Error! Reference source not found. A, between 800 to 1150 seconds). As can be seen in FIG. 30A, the regeneration gas was being sent from the bottom of the column at 29.9° C. and the only reason for a temperature drop in the column during the regeneration is the heat of desorption because the process is adiabatic (sink term in the energy balance). The temperature at the top decreased from 27.5 to 20.6° C. in the period of 600-800 seconds; then, it started to increase to about 22.5° C. This observation confirms that the biosorbents were completely regenerated after 6-7 minutes as the energy sink was stopped, and a cycle time of 10 minute was sufficient for this PSA process. This observation and the temperature profile had been repeatedly seen in all 85 cycles throughout the experiment as shown in FIGS. 32 and 33. The process can continue to operate in such cycles.

The average temperature of column (top and bottom) showed a steady-state behavior and no heat accumulation was seen after 85 cycles. This shows the columns were sufficiently regenerated and a cycle time of 10 minutes worked well.

FIG. 34 again shows the overlapped temperature profile of the adsorption column during different cycles. As can be seen, the temperature profiles during cycle 18, 35, 60, and 76 were almost identical, which shows the stable performance of the biosorbent and steady-state behavior of the PSA process. The slight differences were due to uncontrollable environmental noises and fluctuations in the feed gas flow rate.

The water holdup in the column was determined after 85 cycles (experiment termination) to ensure that the columns were sufficiently regenerated. For that, dry gas was sent into the column from the top and the mole fraction of water in the outlet of the column was measured using the RH sensors while the column was under vacuum. No moisture was detected and the temperature profile did not show a significant reduction. As can be seen in Error! Reference source not found., the temperature at the top of the column slightly decreased; and after a minute, it increased because of the heating effect of the warmer inlet gas (29.9° C.). In the last cycle before stopping the experiment, the column was pressurized with humid gas; hence, very low amounts of water were adsorbed. This slight temperature drop in FIG. 34 was caused by the desorption heat of the amount of water adsorbed during the pressurization before stopping the experiment, which was negligible and non-detectable by the RH sensors.

High Pressure Test in the Continuous Dual-Column PSA Process with Improved Recovery

In this section, the experiment illustrated in the previous section was repeated with a regeneration gas volumetric flow rate to feed gas volumetric flow rate of one

$$( \frac{{V}_{R}}{{V}_{F}} = 1 ) .$$

According to humidity principles and the psychometric chart, this volumetric ratio must be equal or larger than one in order to remove all the adsorbed moisture from the adsorption bed. In industry, a standard ratio of 1.5 is usually considered (same as the test discussed in the previous embodiment). However, in this section, the same test was repeated with a volumetric ratio of one in order to improve the recovery of the PSA process and investigate if a steady-state process is feasible under this condition. Similar to the previous experiment, this test was also run for 85 cycles and a steady-state performance was observed. Similar results were achieved and the performance of the system was as good as the previous test with

$$\frac{{V}_{R}}{{V}_{F}} = 1.5$$

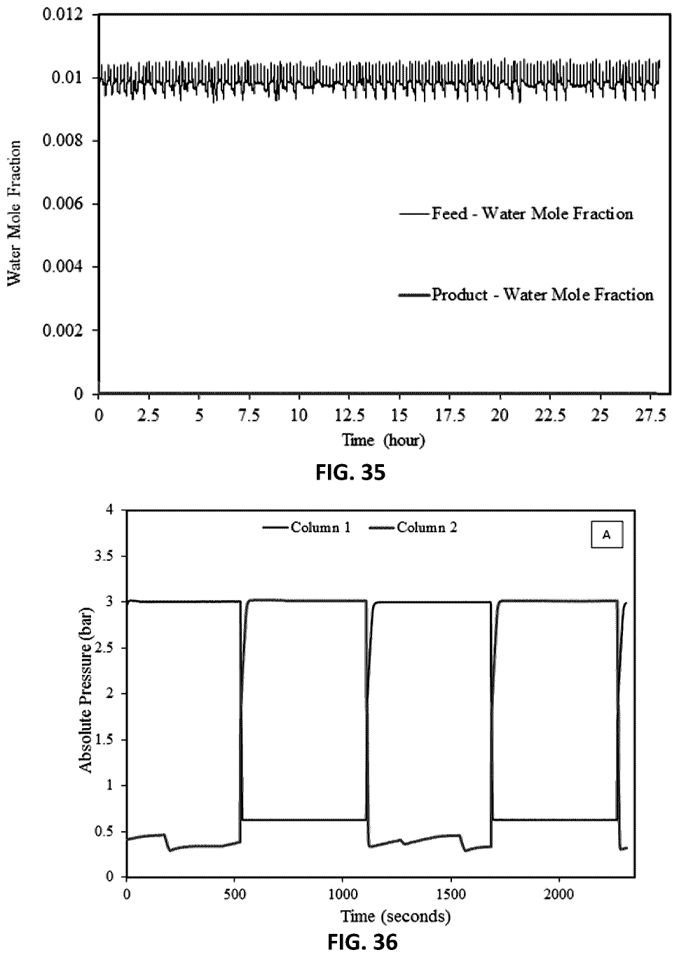

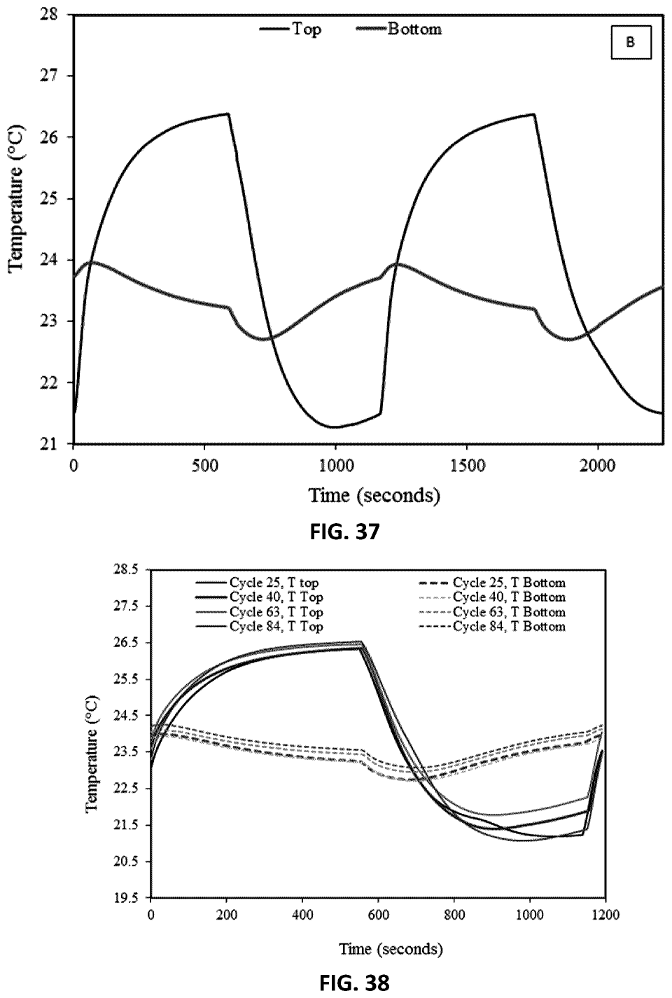

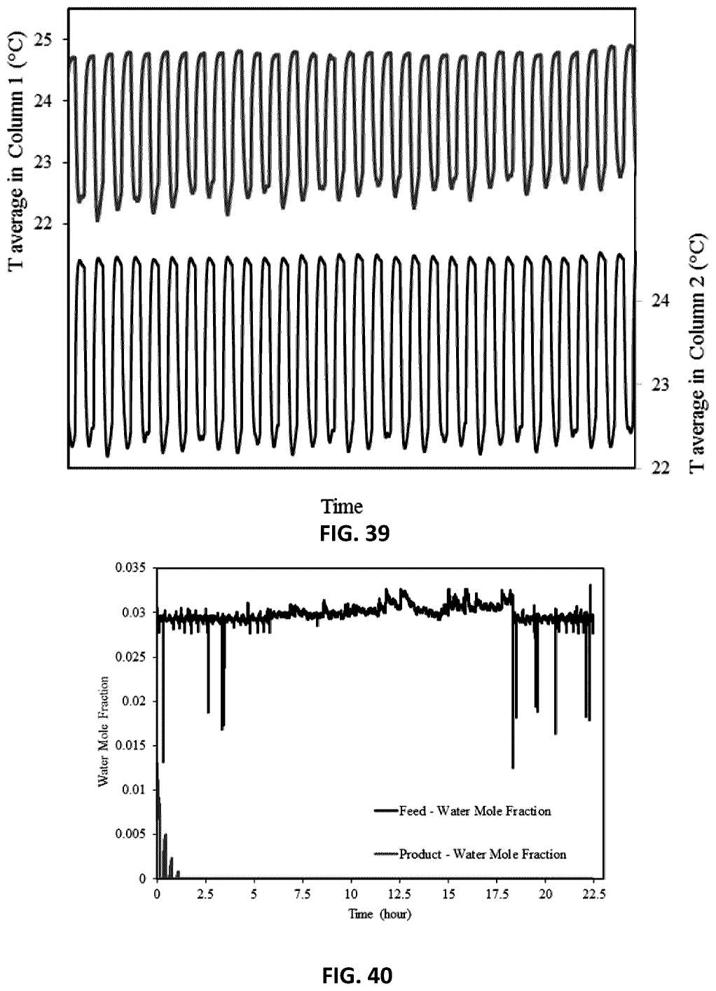

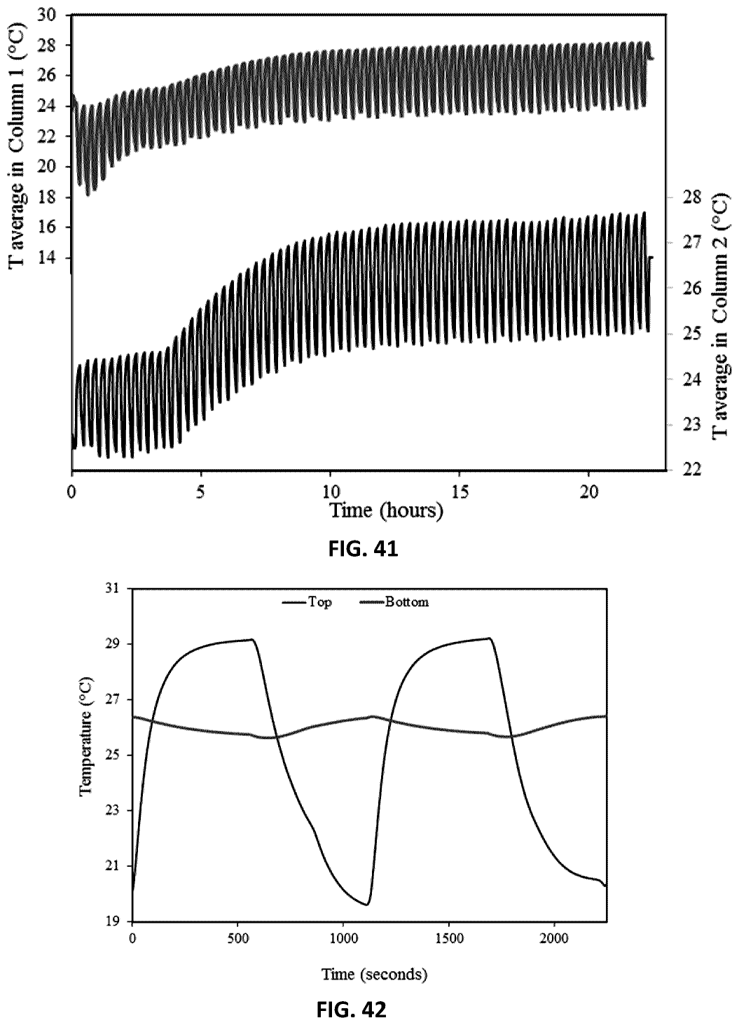

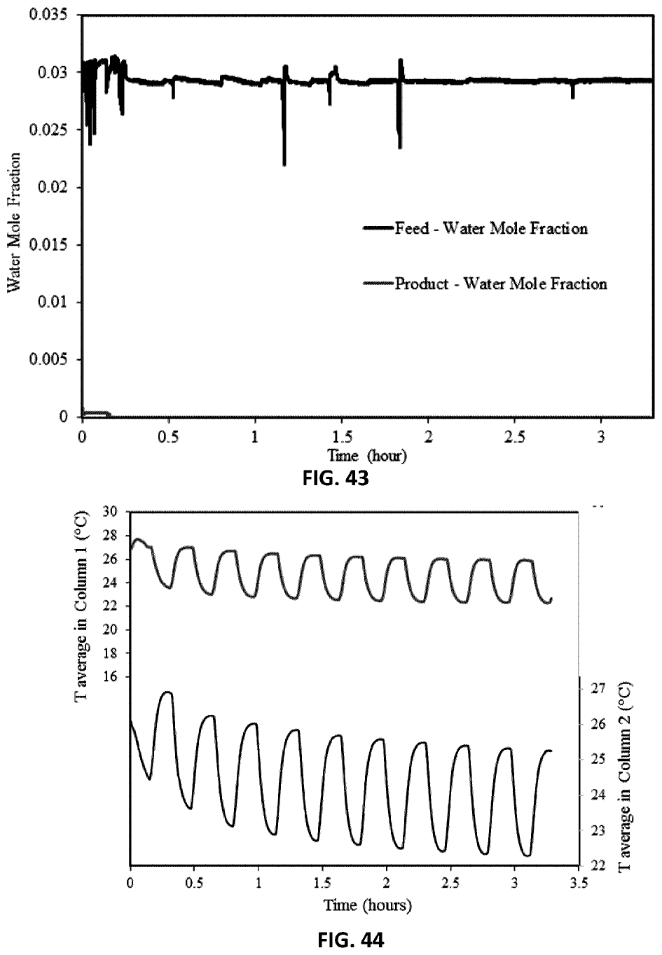

as can be seen in the product composition and other column profiles shown in FIGS. 35 to 39.

The temperature profile during the regeneration was similar to what was observed in the previous experiment. The temperature raise after 7-8 minutes during the regeneration indicates that the bed was effectively regenerated even with the volumetric flow rate of

$$\frac{{V}_{R}}{{V}_{F}} = 1.5 .$$

Moreover, this temperature profile was repeatedly seen all through various cycles, which shows the steady-state condition of the process.

Error! Reference source not found. shows that the process reached a steady-state condition as the average temperature of top and bottom of the column was almost identical during the experiment even when

$$\frac{{V}_{R}}{{V}_{F}} = 1.5 .$$

Similar to the previous experiment, the moisture holdup in the column after 85 cycles was determined and no moisture was detected in both columns.

### Effect of Cycle Time and Feed Gas Flow Rate

In some embodiments, the length of mass transfer zone (MTZ) may slightly increase with an increase in the gas flow rate. This increase in the length of MTZ may not affect the cyclic performance of the process as it was seen that the MTZ was far away from the column's outlet. In addition, this increase in the length of MTZ was not significant. A 100% increase in the gas flow rate increases the length of MTZ from 10.8 to 11.4 cm at 24° C. This increase was even smaller at higher temperatures. Furthermore, adsorption columns are usually overdesigned (height to diameter ratios of 2 to 4); therefore, the length of unused bed (LUB) is usually bigger than the length of MTZ (extra adsorbents in the column). Moreover, a higher gas flow rate improves the regeneration of adsorbents since more moisture (desorbed water) can be carried out of the bed during a cycle time.⁷

As for the cycle time, previous research showed that increasing the cycle time causes an increase in the length of MTZ^{3,8-11}; however, this increase was also insignificant in this work. Adsorption-desorption rate measurements in previous embodiments showed that both the adsorption and desorption rates decreased over time as the bed become saturated and regenerated, respectively; however, the rate of desorption in the first 10 minute of the process was much higher than the rate of adsorption. Therefore, a cycle time longer than 10 minute would not be advantageous for this PSA process. It results a slightly higher length of MTZ and more significant temperature fluctuations in the columns, which is disadvantageous for the biosorbent. It was also seen that the columns were effectively regenerated after 6-7 minutes. Therefore, a cycle time between 7 to 10 minutes appears to be effective for this PSA process.

### Atmospheric Pressure Tests in Continuous Dual-Column PSA Process

Gas pressurization is expensive, especially in the case of natural gas where multi-staged compressors and intercoolers are required. Similarly in air drying processes, atmospheric air is compressed because the adsorbents' performance is good enough at higher pressures for a steady-state process. Our goal in the following embodiments is to investigate if the PSA process using the biosorbent is feasible at atmospheric pressure, in which case both the operating and capital costs of the process would decrease.

To begin with, we run a dual-column experiment at atmospheric pressure and used the normal building vacuum (39 kPa) during the regeneration step. A volumetric ratio of

$$\frac{{V}_{R}}{{V}_{F}} = 1.5$$

and a cycle time of 10 minutes were considered. The feed gas was 100% humid with a temperature of 29.44° C. This test was not successful and breakthrough point was reached in the second cycle. We also observed that water vapor was condensed in the column during the regeneration step and liquid water in the outlet wet the RH sensors. The water condensation was due to the low volumetric flow rate of the regeneration gas, which could not carry out all the desorbed moisture from the column.

Next, the same test was repeated with a volumetric ratio of

$$\frac{{V}_{R}}{{V}_{F}} = 1.5 .$$

This test was successful; however, the performance of the system was not as good as the high-pressure process. As can be seen in Error! Reference source not found., breakthrough point was reached in the first three cycles; and then, the process reached a steady-state condition. This observation can be clearly seen in the cyclic temperature profile of the columns (Error! Reference source not found.). The temperature of columns increased over time and reached a steady-state profile. The breakthrough point reached in the first few cycles can be explain based on the adsorption-desorption rates discussed in the previous embodiments. As noted, the desorption rate was much higher at higher temperatures; therefore, as the temperature of columns increased after a few cycles, the biosorbent in the columns were effectively regenerated due to a higher desorption rate. It is worthy to highlight that the breakthrough point at the beginning of the experiment can be simply avoided by heating the column during the startup prior to starting the cyclic operation.

Detailed analysis of the temperature profile indicates that the columns were partially regenerated during the atmospheric pressure operation as no temperature raise was seen during the regeneration step similar to what was seen in the previous embodiments; however, the process still reached a steady-state condition and could run for more repeated cycles. Similar to other industrial PSA operations, the adsorbent beds are partially saturated and regenerated in every cycle.

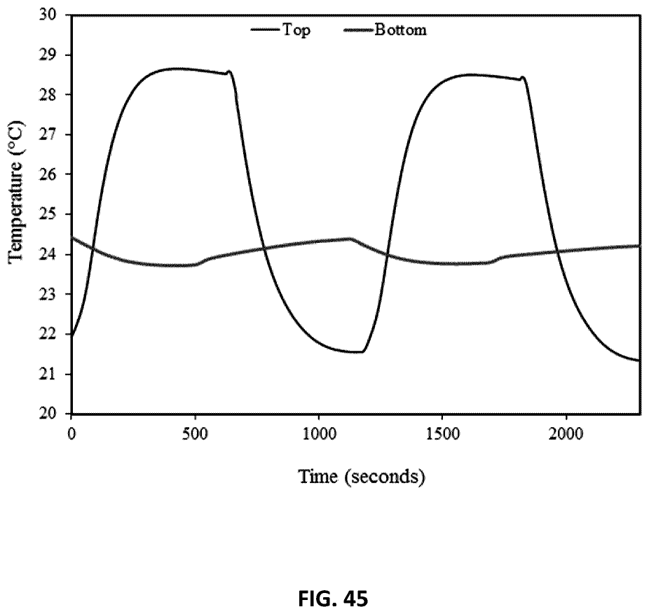

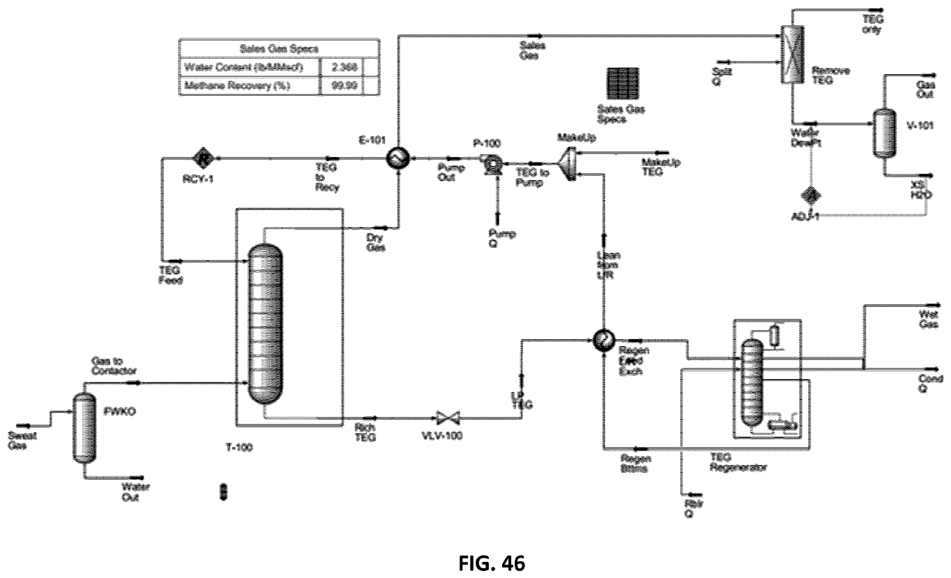

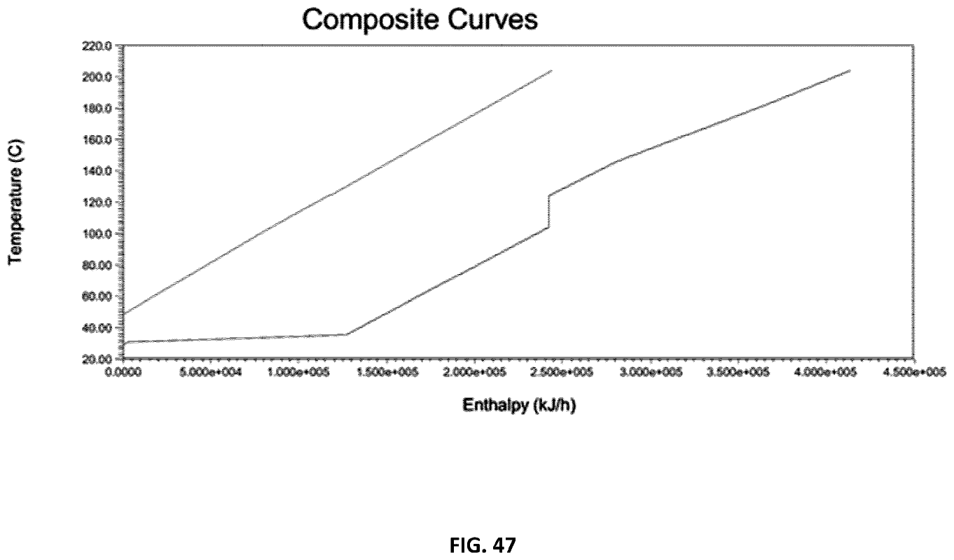

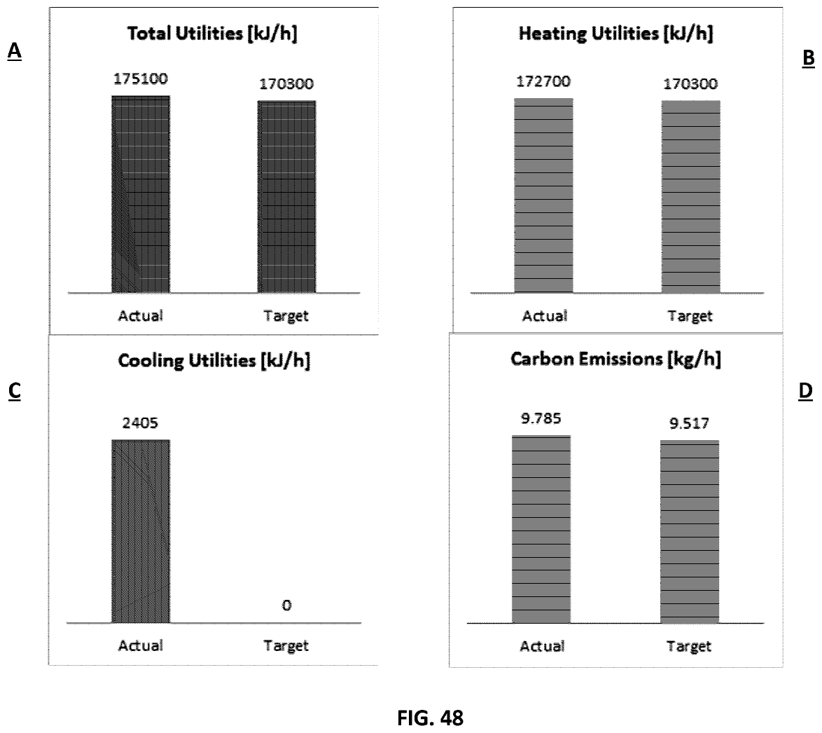

In the next experiment, a vacuum pump that can provide a vacuum level of 3 μHg was used to regenerate the columns. The effect of vacuum level on the cyclic process were studied in this experiment. The other conditions were the same as the previous experiment. As can be seen in Error! Reference source not found., breakthrough point was reached only in the first cycle; afterward, the process reached a steady-state condition, which can be better seen in Error! Reference source not found. The cyclic temperature profile of the column did not show an increasing trend as that of the previous experiment; in fact, the temperature was slightly decreased due to more effective regeneration steps and reached a steady-state condition. FIG. 45 also shows that the temperature almost reached to a constant level during the regeneration step and then sharply increased once the column was switched from the regeneration step to the adsorption step (see Error! Reference source not found.).

These results suggest that the PSA process can operate at atmospheric pressure as well and gas dehydration is possible under these conditions. This process was successful due to the excellent regeneration properties of the biosorbent (fast rates at lower temperatures). Atmospheric PSA operation was not successful using other commercial adsorbents such as molecular sieves as various processes were designed to operate at higher pressures and the adsorbents were heated to higher temperatures during the regeneration step using different heating systems (hot gas/oil or electrical rods).^{6,7,12} Using a vacuum pump is suggested for the atmospheric operations to ensure effective gas dehydration. A vacuum level between 39 kPa and 0.0004 kPa (3 μHg) should work for this process. A lower vacuum level is costly and the cost is highly dependent on the feed gas flow rate as parallel multi-staged vacuum pumps might be needed. On the other hand, gas can be compressed to 2-3 bars instead of using an expensive vacuum pump, which is not comparatively very expensive as a single stage compressor can handle this pressure increase. In a nutshell, the optimal economic design of an atmospheric pressure PSA process depends on the feed gas and the chemical plant, and there is no single best design for all scenarios.

### Simulation and Economic Analysis Results

In the following embodiments, the steady-state simulation, economic analysis, and energy analysis of Tetraethylene Glycol (TEG), temperature-swing adsorption (TSA), and PSA dehydration processes are discussed one by one. In addition, rigorous dynamic simulation of our PSA processes are presented afterward in order to comprehensively analyze the designed PSA processes.

### Dehydration in a Tetraethylene Glycol (TEG) Process

### Process Description

This process is comprised of an absorber column, a distillation column, a flash drum, and a series of heat exchangers, valves, and pumps.^{1,12} Firstly, liquid water is separated from natural gas in a knock-out drum; then, the wet natural gas is dried in an absorber column where the gas is brought in contact with a TEG liquid stream. Next, any TEG impurities in the final product due to column flooding or TEG foaming is removed from natural gas and the sales gas is sent into the pipelines. On the other hand, the rich or wet TEG is regenerated in a distillation column running on total reflux mode. The lean TEG stream is recycled back to the system once its pressure and temperature is adjusted. A makeup stream of TEG is necessary to compensate for the TEG losses in the system.

### Steady-State Simulation

The TEG dehydration process was simulated using ASPEN HYSYS process simulator. The HYSYS Glycol fluid package was selected for property calculations. Alberta natural gas conditions and composition were considered as the basis of this simulation. The feed gas composition is shown in Table 9. The feed gas to the dehydration unit is “Sweat Gas”, which is the product of the acid removal unit in the natural gas processing plant.¹² In the Alberta plant, this sweat gas has a flow rate, pressure, and temperature of 10.45 ton/h, 60.05 bar, and 29.44° C., respectively.

TABLE 9
Composition of Alberta natural gas; sweat gas on dry basis.

| Component | Mole % |
|---|---|
| N₂ | 3.16 |
| CO₂ | 1.68 |
| H₂S | 3.26 |
| CH₄ | 76.10 |
| Ethane | 6.51 |
| Propane | 3.06 |
| Butane | 1.97 |
| C₅₊ | 2.96 |
| H₂O | 1.30 |

Error! Reference source not found. shows the process flowsheet of the TEG dehydration unit simulated in ASPEN HYSYS. As can be noticed, a recovery of 99.99% was achieved, and the water content of the sales gas is 2.37 lb/MMscf, which is within the range of pipeline quality gas (4-7 lb/MMscf).

### Economic and Energy Analyses

ASPEN Economic Analyzer was used to perform an economic analysis on the simulated processes in this report, which is a robust and reliable economic analyzer. The capital cost and operating cost of the different dehydration processes were estimated and compared. As can be seen in Table, a total capital cost of 30.7 million USD was estimated for the TEG dehydration process, 87.6% of which is due to the raw material cost (mainly TEG).

TABLE 10
Summary of economic analysis; TEG dehydration process

| Total Capital Cost [MUSD] | 30.7 |
|---|---|
| Total Operating Cost [USD/Year] | 982,821 |
| Total Raw Materials Cost [MUSD] | 26.9 |
| ETG Makeup cost [USD/Year] | 315 |
| Total Utilities Cost [USD/Year] | 52,880.4 |
| Equipment Cost [USD] | 179,500 |
| Total Installed Cost [USD] | 755,600 |
| Utilities | USD/hour |
| Electricity | 5.5188 |
| HP Steam | 0.5138 |

Energy analysis was performed using ASPEN Energy Analyzer. The composite curve obtained from a pinch analysis is shown in Error! Reference source not found. This figure suggests that further heat integration is possible; however, capital cost need to be considered at the same time. The pinch temperature is approximately 20° C.

Table shows the heating and cooling utilities used in the TEG dehydration process. Carbon emissions are also estimated and compared to target values recommended by ASPEN for gas processing plants. The obtained values are close to the target values, except for cooling utilities. These results are also visually illustrated in Error! Reference source not found.

TABLE 11
Energy analysis results from ASPEN Energy Analyzer; the target values
are recommended values by ASPEN for gas processing plants.

| | | | Available | % of |
|---|---|---|---|---|
| Property | Actual | Target | Savings | Actual |
| Total Utilities [kJ/h] | 175,100 | 170,300 | 4805 | 2.75 |
| Heating Utilities [kJ/h] | 172,700 | 170,300 | 2,400 | 1.39 |
| Cooling Utilities [kJ/h] | 2,405 | 0 | 2,405 | 100 |
| Carbon Emissions [kg/h] | 9.785 | 9.517 | 0.2684 | 2.74 |

### Dehydration in a Temperature Swing Adsorption Process

### Process Description

In this process, two adsorption columns packed with molecular sieves were used in the temperature swing adsorption (TSA) process to dehydrate natural gas. While adsorption is taking place in one column at a relatively lower temperature, desorption takes place in the other column at a higher temperature. These two columns operate in a cyclic batch mode. Each column is switched from an adsorption mode to a desorption mode after a certain cycle time (a few minutes). A part of the dry product gas is sent into a furnace where it is heated to temperatures up to 300° C. Then this gas is sent into one of the column as a carrier gas during the desorption step in the cycle. The column is heated at the same time using heating jackets or electrical heaters in order to increase the temperature of solid adsorbents in the columns. Water vapor is desorbed and carried out with this hot gas stream, and the adsorbents are regenerated enough and ready for another adsorption cycle. Afterward, the columns are cooled down, the hot gas is sent into a flash drum, compressed, cooled down, and recycled back to the feed in upstream.

### Steady-State Simulation

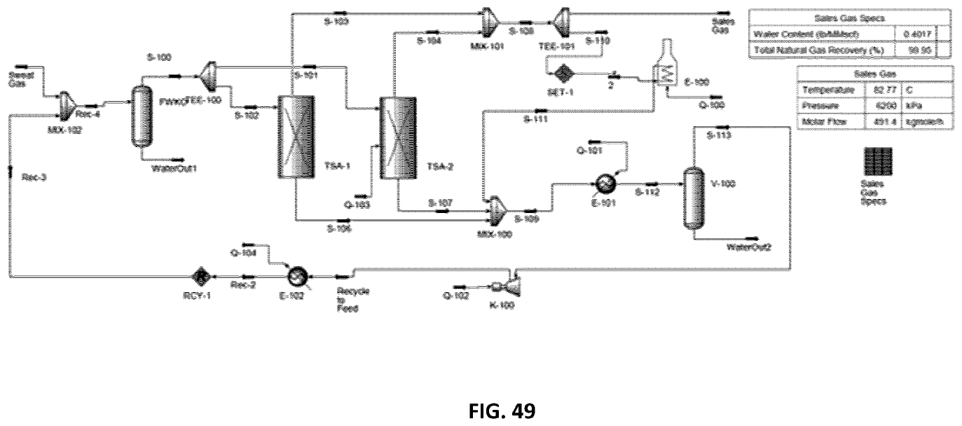

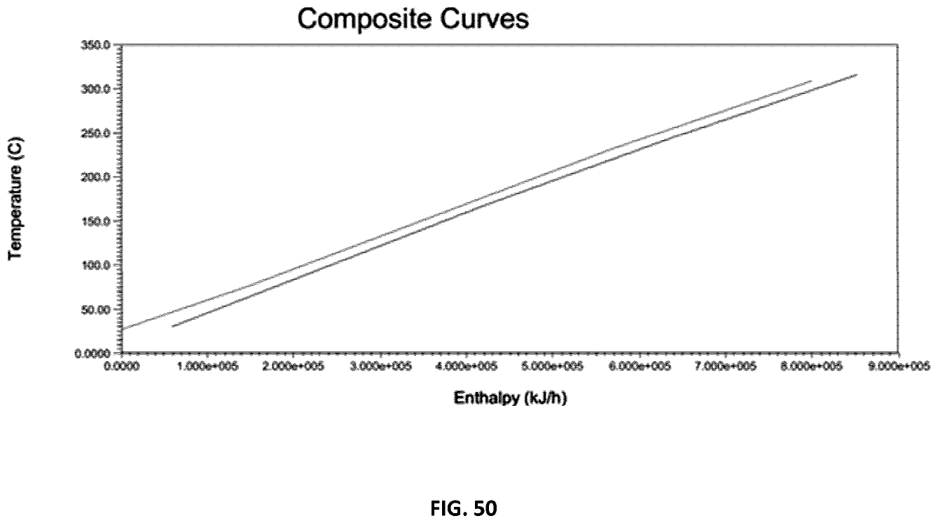

The TSA process was simulated in ASPEN HYSYS, shown in FIG. 49, based on the adsorption capacities and selectivities reported for molecular sieves. NRTL-RK fluid package was used for property estimation. In order to simulate a dynamic cyclic batch process in a steady-state mode simulation in HYSYS, the feed was divided in half, and each stream is sent into an adsorption column separating water vapor from the natural gas. A portion of the dried gas (S-110) is sent into a furnace, heated to 300° C., and mixed with the separated water streams in the adsorption columns (S-106 and S-107). The mixed gas is the humid gas exiting the adsorption columns during the desorption step. This stream is then cooled down using cooling water. Condensed water is separated in a flash drum and the overhead gas is compressed in a multi-staged compressor and recycled back to the system. The standard L/D ratio of 2 was considered for the adsorbent layer, and the required mass of adsorbent was calculated accordingly.⁷ The overall recovery of natural gas in this process was 99.95% and the water content of the sales gas is 0.4 lb/MMscf, which is below the pipeline standards.

### Economic and Energy Analyses

Similar to the TEG dehydration process, an economic analysis was performed on the TSA process. As can be seen in Table, a total capital cost of 5.38 million USD was estimated for the TSA process, which is much lower than the capital cost of the TEG dehydration process; however, the operating cost and utilities cost were slightly higher than those of the TEG dehydration process.

TABLE 12
Economic analysis results of the TSA process

| Total Capital Cost [MUSD] | 5.38 |
|---|---|
| Total Operating Cost [MUSD/Year] | 1.49 |
| Total Adsorbent Cost [USD] | 123,328.43 |
| Total Utilities Cost [USD/Year] | 154,361 |
| Equipment Cost [USD] | 1,437,200 |
| Total Installed Cost [USD] | 1,968,600 |
| Utilities | USD/hour |
| Electricity | 16.16 |
| Cooling Water | 0.2341 |
| Furnace (natural gas) | 1.21 |

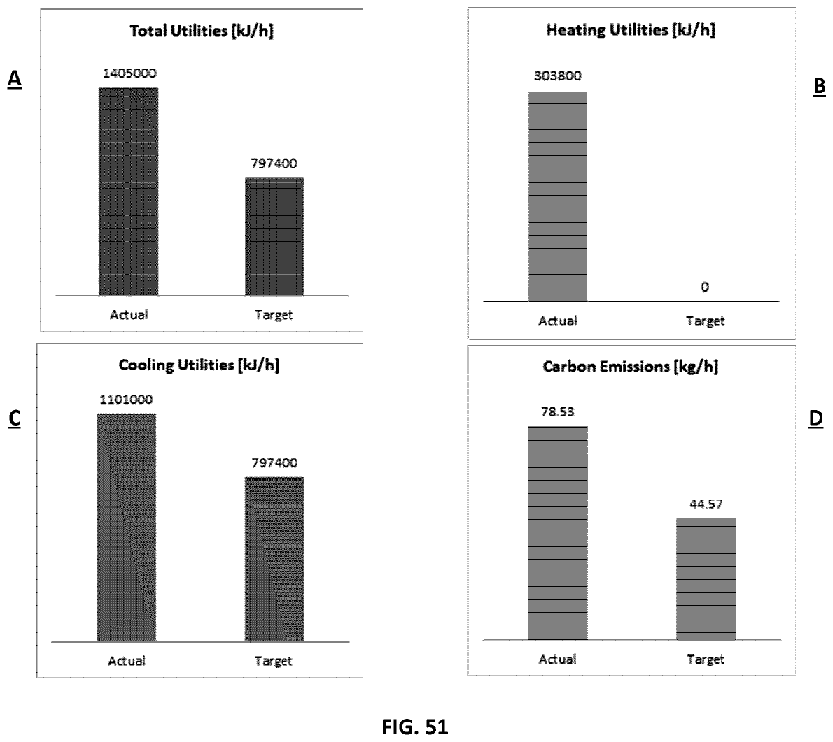

Energy analysis was similarly done and the results are shown in Error! Reference source not found. 0 and FIG. 51. A very low pinch temperature was obtained (Error! Reference source not found.), which indicates that further heat integration is not worthy. Furthermore, the heating/cooling utilities and gas emissions were much higher than the target values recommended by ASPEN (FIG. 51). This is due to the furnace and sharp temperature fluctuations in the process. Natural gas is burnt in the furnace producing carbon dioxide and other pollutants. These results are also shown in Table 13.

TABLE 13
Energy analysis results for TSA process.
Summary Table

| | | | Available | % of |
|---|---|---|---|---|
| Property | Actual | Target | Savings | Actual |
| Total Utilities [kJ/h] | 1405000 | 797400 | 607400 | 43.25 |
| Heating Utilities [kJ/h] | 303800 | 0 | 303800 | 100 |
| Cooling Utilities [kJ/h] | 1101000 | 797400 | 303600 | 27.59 |

### Dehydration in a Pressure Swing Adsorption Process

### Process Description

The pressure swing adsorption (PSA) process is very similar to the TSA process. The only difference is that the pressure is changed based on a cyclic operation where adsorption and desorption take place at high pressure and low pressure, respectively. The operating temperature is much lower than that of TSA and it is slightly different during adsorption and desorption due to the heat of adsorption and the heat of desorption. The details of this cyclic process is explained elsewhere.

In this work, two different PSA processes for natural gas dehydration were designed, tested, and simulated: 1) six-step PSA process, and 2) ten-step PSA process. The details of cycles and process control are discussed in previous embodiments. In the following embodiments, steady-state and dynamic simulation of these processes are illustrated and discussed. Each of these two processes were simulated with and without recycling of the natural gas purge stream during the depressurization steps. The total natural gas recovery, capital cost, and operating cost of each process with and without recycling are also determined and discussed.

Steady-State Simulation of the Six-Step PSA Process without Recycling

The PSA process was simulated in ASPEN HYSYS using a User-defined model generated from our experimental data. Basically, the behavior of system at various temperatures, pressures, feed composition, and flow rate was predicted using property tables generated by the user model. The conditions of adsorption columns in terms of configuration, amounts of adsorbent, L/D ratio, etc. were the same as those in the TSA process.

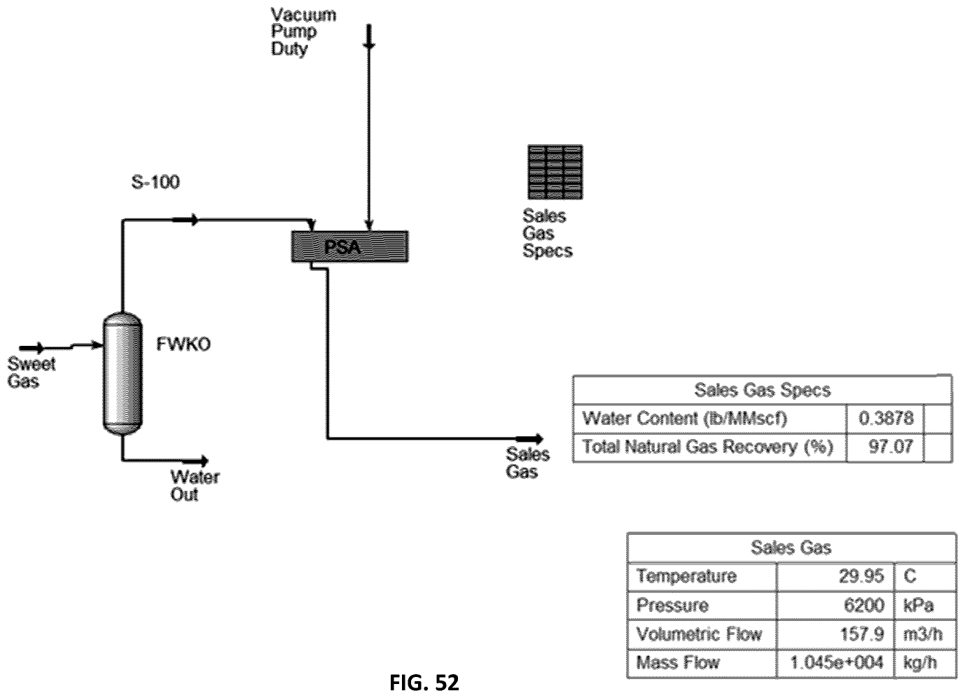

The main power consumption (utility) in this process is the vacuum pump duty (FIG. 52). A dual-stage pump with excess maximum capacity of 130% was sized and simulated and its capital cost and power consumption was estimated using the manufacturer documentations (Kinney, KLRC 950 GPM 39). The CH₄ purge stream is actually the gas holdup in the column during the pressure equalization and depressurization steps in the designed cycle, which is sent back to the upstream to be used as a utility (e.g. in a furnace or HPS generation). A total methane recovery of 97.07% was achieved as the mass flow rate of this purge stream is very small (15.53 kmole/h, 3.23% of the total feed flow rate). Moreover, the water content of the sales gas was satisfactory for pipeline quality gas (Error! Reference source not found.).

Steady-State Simulation of the Six-Step PSA Process with Recycling

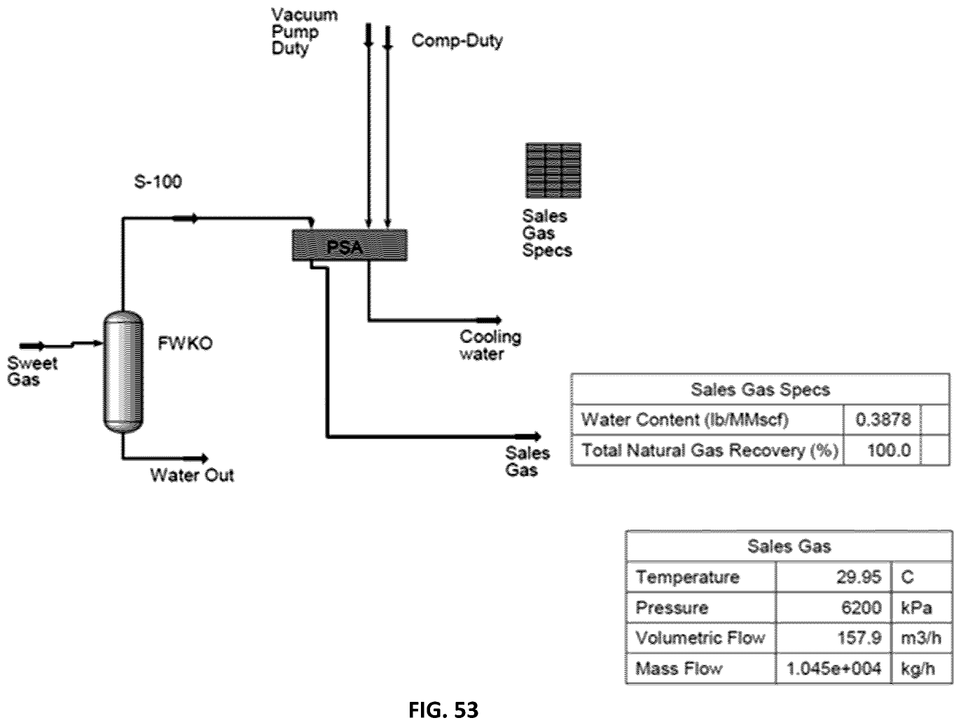

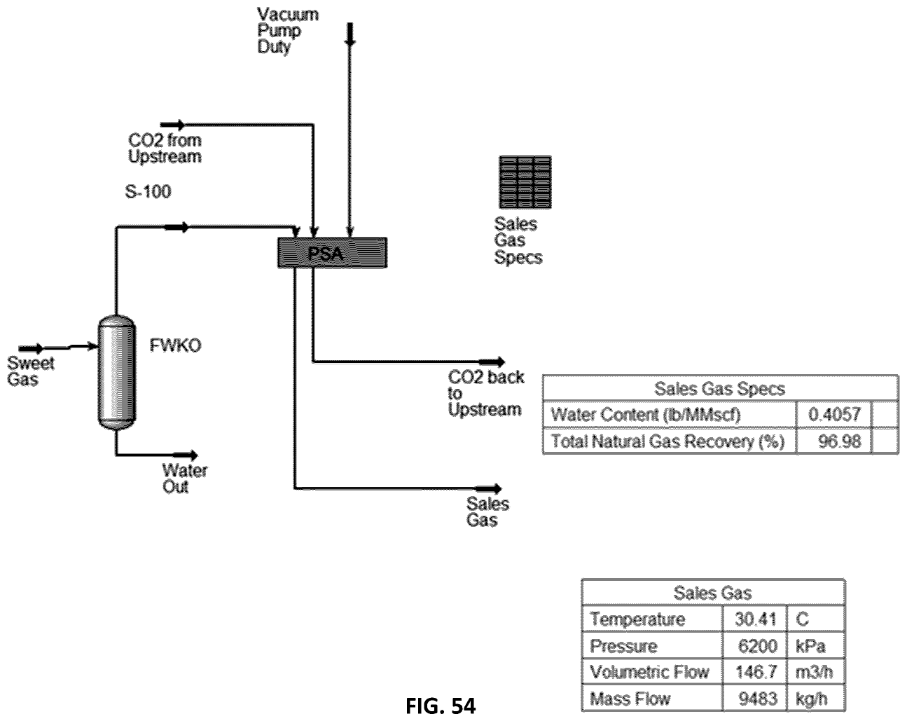

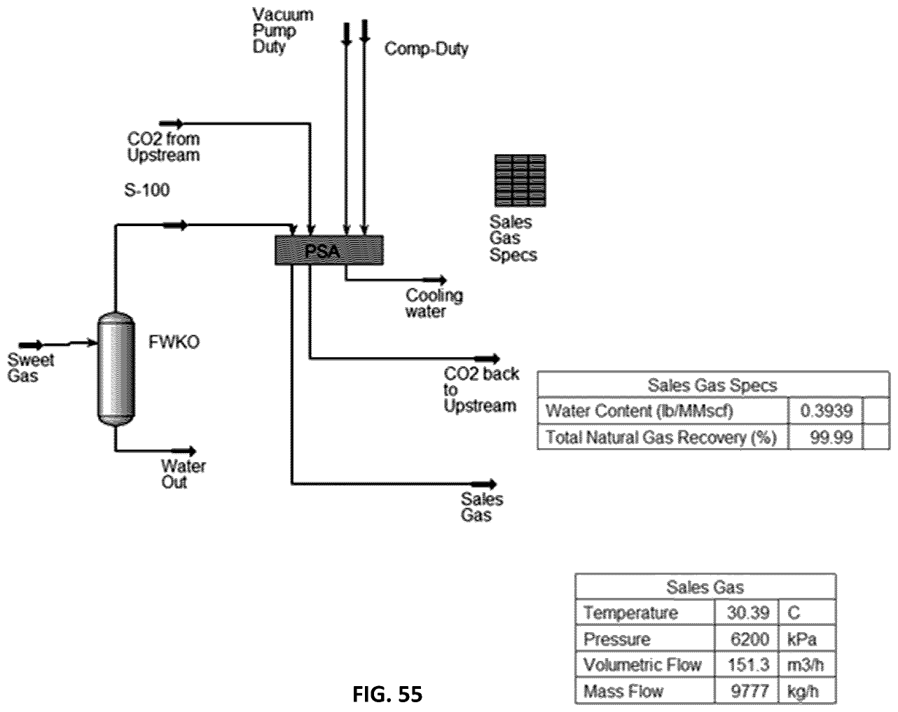

The difference of this process is the additional cost of recycling that includes the capital and operating costs of multi-staged compressors and heat exchangers (coolers); however, the natural gas recovery of this process is 100% because the gas holdup in the column and the regeneration gas is recompressed and recycled back to feed. In other words, a recycle stream with a flow rate of 15.53 kmole/h is compressed and cooled down to the feed gas pressure and temperature, respectively. FIG. 53 shows the process flow diagram of this process.

Steady-State Simulation of the Ten-Step PSA Process without Recycling

In this process, a waste CO₂ stream is used to regenerate the columns based on the 10-step cycle explained in the previous embodiments. This CO₂ stream can also be supplied from an integrated CH₄/CO₂ separation PSA unit. According to the CO₂ mole fraction reported in Table 9 and assuming

$$\frac{{V}_{R}}{{V}_{F}} = 1.5 ,$$

a flow rate of 1.22 kmole/h of CO₂ is required to regenerate the columns. The total flow rate of CO₂ that can be recovered from the Alberta's natural gas is 8.1 kmole/h, which is considerably higher than the required flow rate for the PSA dehydration process. The natural gas purge stream in this process is the gas holdup in the column, which has a flow rate of 14.31 kmole/h. This natural gas stream can be used in upstream as a process utility. Because of this purge stream, the natural gas recovery of this process is 96.98%. Error! Reference source not found. shows the process flow diagram of this process.
Steady-State Simulation of the Ten-Step PSA Process with Recycling

In this process, the natural gas purge stream (gas holdup in columns) is compressed, cooled down, and recycled. The result is a higher natural gas recovery of 99.99% and higher capital and operating costs. A very small amount of natural gas (0.031 kmole/h) is lost during the column evacuation and regeneration with CO₂ (FIGS. 73 and 78). The process flow diagram of this process is shown in Error! Reference source not found. 5.

### Economic Analysis

Similar to the TSA and TEG processes, an economic analysis of the six-step PSA process without recycling was performed and the results are summarized in Table 14. A total capital cost of 2.45 million USD was estimated for this plant, most of which was the equipment cost. The total raw material cost is very low since biosorbent were supplied without any cost and the only cost is the shipping and handling costs. About 1.67 ton of biosorbent was needed for two adsorption columns.

TABLE 14
Summary of economic analysis of the six-
step PSA process without recycling.

| Total Capital Cost [MUSD] | 2.45 |
|---|---|
| Total Operating Cost [USD/Year] | 955,753 |
| Total Raw Materials Cost [USD] | 53.2 |
| Total Utilities Cost [USD/Year] | 37,020.9 |
| Equipment Cost [USD] | 86,500 |
| Total Installed Cost [USD] | 323,800 |
| Utility | USD/hour |
| Electricity | 4.2232 |

Since electricity is the only utility used in this process, energy analysis is pointless. This process is highly environmental friendly as no heating utilities such as furnace that produces pollution was used. The operating cost may be increased for large-capacity plants where a high gas flow need to be handled by multi-staged vacuum pumps.

Similarly, economic analysis was performed for the other PSA processes discussed previously. The capital and operating costs were different as compressors and heat exchangers were used in the processes with recycling of the purge natural gas. These results are shown in Table 10. As can be noticed, the recycling significantly increased the capital cost (about 2 MUSD). Furthermore, the operating cost increased due to the power consumption in multi-staged compressors and their intercoolers and aftercoolers. The outcome of the recycling and the concomitant costs is a higher natural gas recovery (2-3% increase). Considering the low price of natural gas, this two million dollars investment in the capital cost would result a very long payback period (maybe longer than the lifetime of the plant/process). Hence, the PSA processes without recycling sound more reasonable. It is worthy to mention that the 2-3% of purged natural gas can be easily stored in a tank and later used in the upstream as a process utility (heating in furnace or steam generation). I

### Summary of the Economic Analyses

Herein, different natural gas dehydration processes were simulated in ASPEN HYSYS and techno-economic analyses were performed to compare the capital and operating costs of these processes. As can be seen in Table 105, the PSA processes without recycling have lower capital cost and operating cost. The PSA process has fewer pieces of equipment and is much easier to control since the cyclic system is just a manifold of automated solenoid valves. Due to lower operating temperatures, the operation is safer and more environmentally friendly (lower gas emissions). The methane recovery and sales gas water content appear to be within the pipeline quality gas standards. The six-step PSA process can be applied in natural gas plants where no waste CO₂ stream is available. The ten-step PSA process can be applied in plants where either a waste CO₂ stream is available or the dehydration process is integrated with another PSA process for CH₄/CO₂ separation.

TABLE 105
Comparison of natural gas dehydration processes.

| | Total | Annual | Gas | |
|---|---|---|---|---|
| | Capital Cost | Operating Cost | Emissions | Recovery |
| Process | (MUSD) | (USD/year) | (kg/h) | (%) |
| TEG | 30.7 | 982,821 | 9.78 | 99.99 |
| TSA | 5.38 | 1,495,740 | 88.99 | 99.95 |
| PSA 6-step | 2.45 | 955,753 | <0.1 | 97.07 |
| without recycle | | | | |
| PSA 6-step | 4.49 | 1,412,890 | <0.1 | 100 |
| with recycle | | | | |
| PSA 10-step | 2.44 | 956,321 | <0.1 | 96.98 |
| without recycle | | | | |
| PSA 10-step | 4.43 | 1,411,410 | <0.1 | 99.99 |
| with recycle | | | | |

### Dynamic Simulation

In following embodiments, a rigorous dynamic simulation of the PSA processes was done using ASPEN ADSORPTION software (ASPEN Adsim Inc.). In this simulation, material and energy balance equations, momentum balance (Ergun equation), thermodynamics equations (isotherms and heat of adsorption/desorption), and kinetics of adsorption equations were rigorously solved as a system of coupled partial/ordinary/algebraic equations. The results were compared with the experimental data and additional information about the system, which is not possible to measure experimentally, was obtained from the simulation (e.g. mass transfer zone). The conditions of simulation were set based on the experiment conditions explained in the previous embodiments.

### Six-Step PSA Process

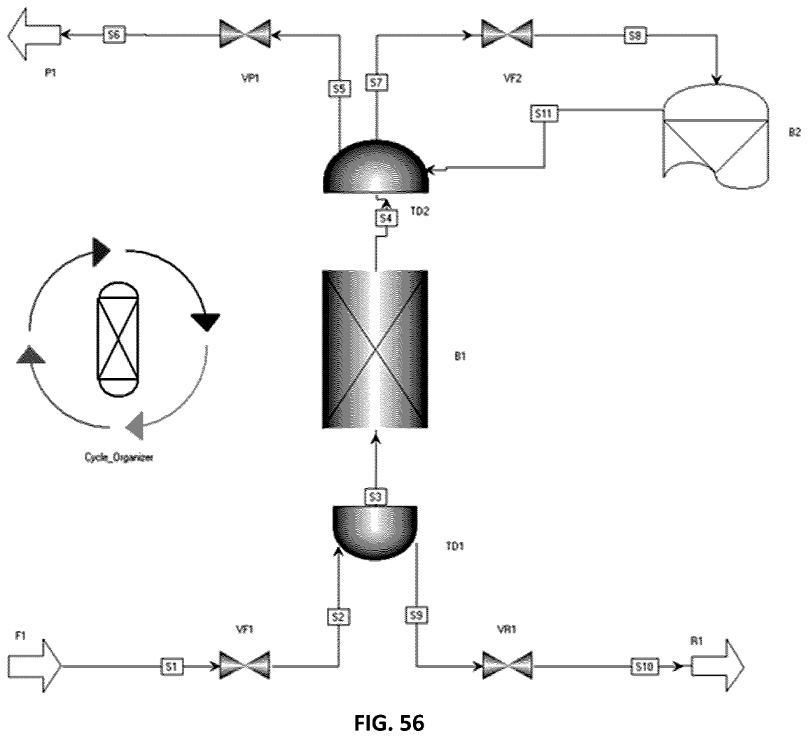

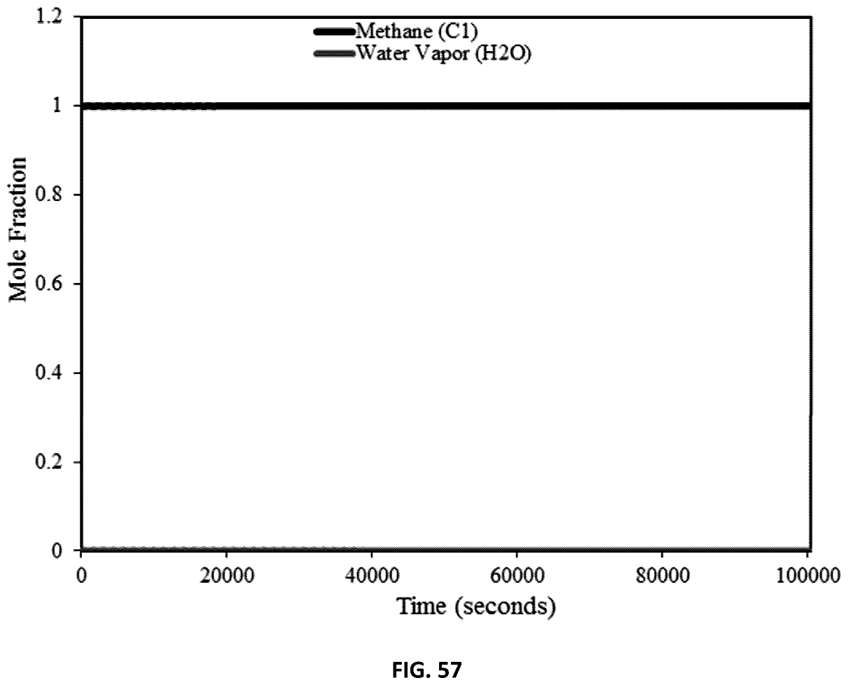

FIG. 56 shows the process flow diagram of the PSA process. This dynamic simulation is based on the 6-step cycle designed and illustrated in FIGS. 64 to 69. ASPEN cycle organizer was used to define these six steps and manipulate the parameters (valves, pressure, flow rates, time, etc.). For the purpose of simulation, the feed gas was assumed to be a mixture methane and water (100% humid). This dynamic simulation was run for 85 cycles in order to compare the simulation results with the experimental data presented for the 85 cycles.

Firstly, the composition of product gas during these 85 cycles are shown in Error! Reference source not found. As can be seen, the product gas was dry and no moisture was detected in the product gas. These dynamic simulation results are in harmony with the experimental data (above).

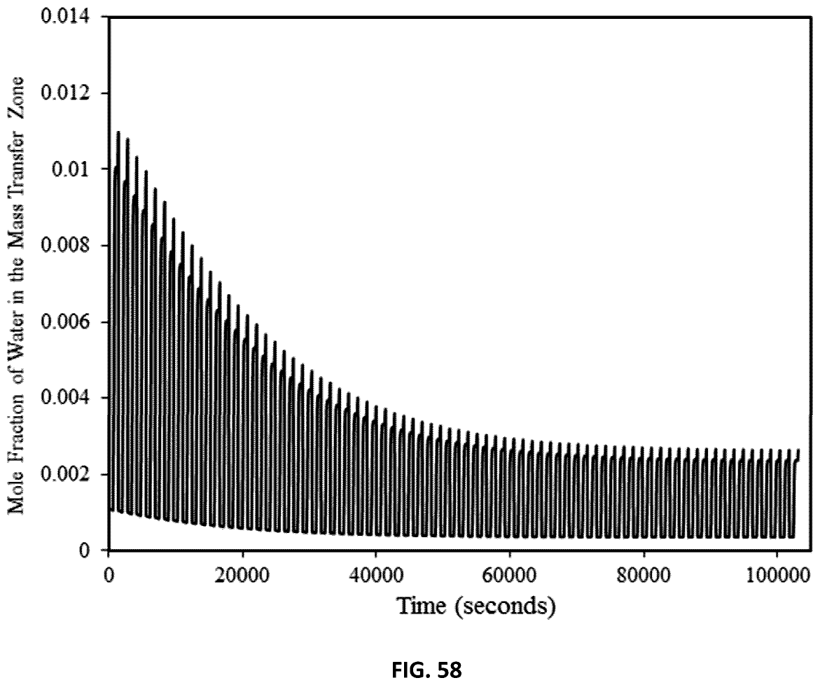

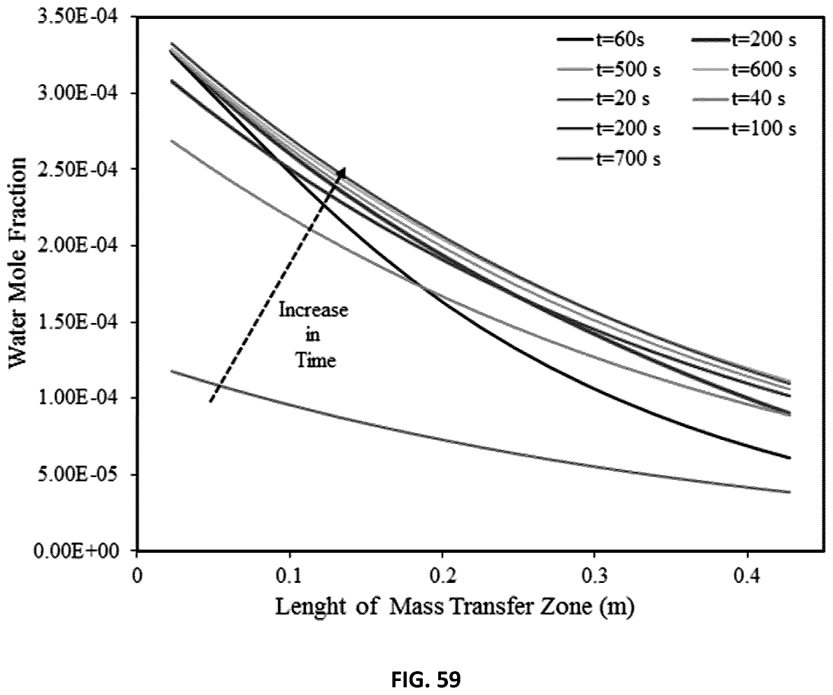

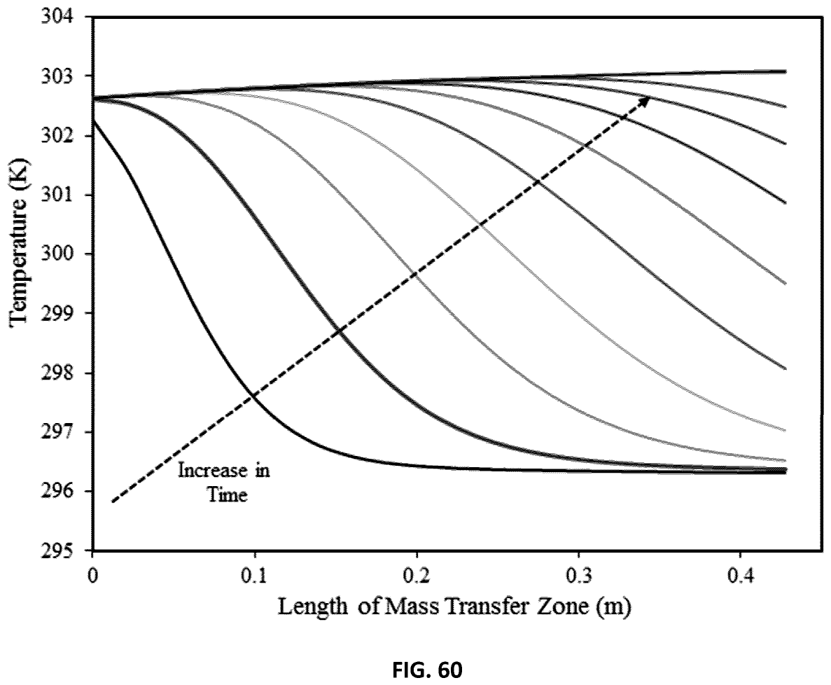

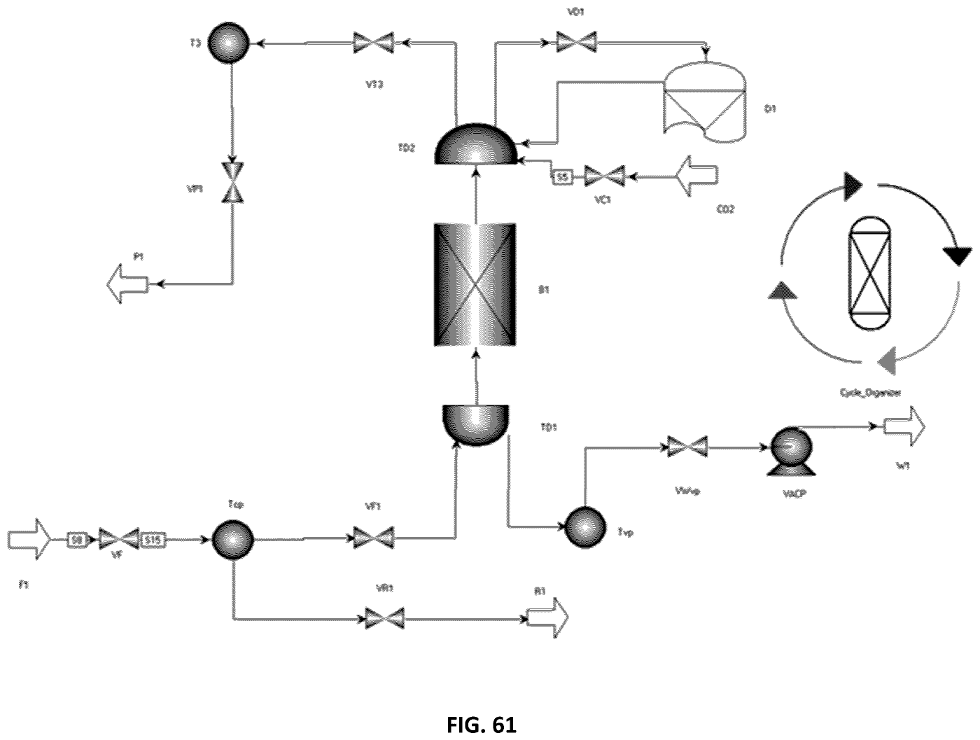

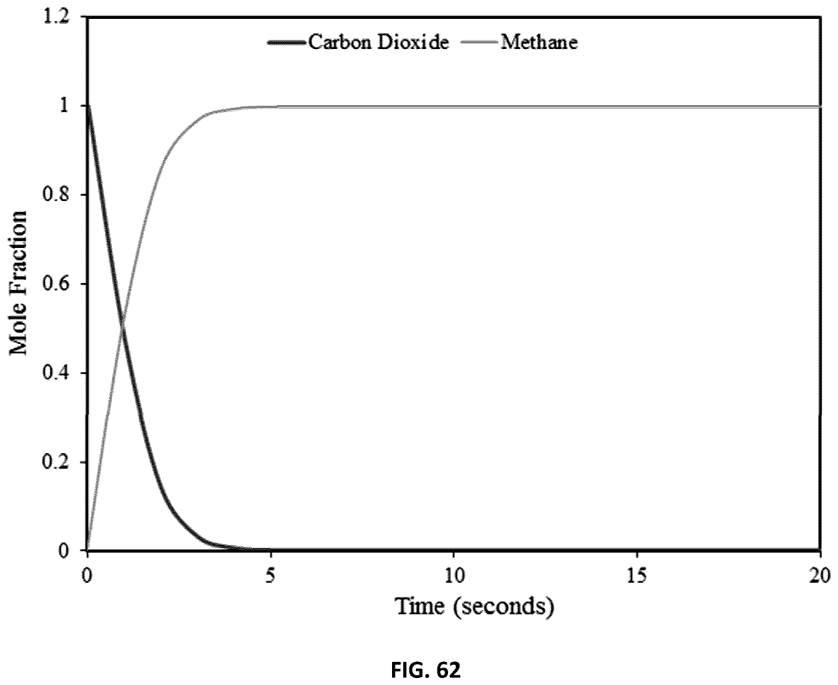

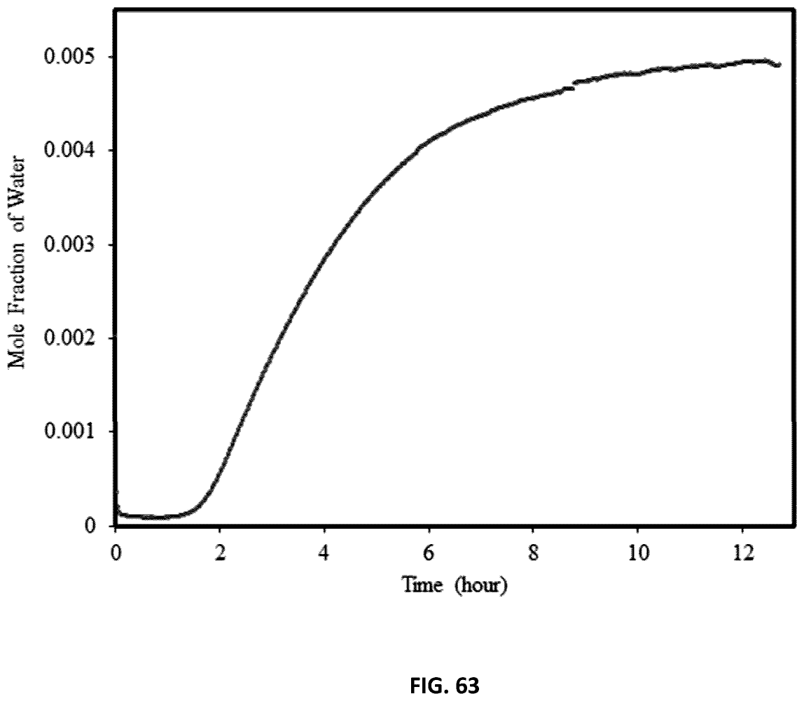

The moisture holdup in the column (mass transfer zone) can be investigated using the simulation results, which could not be experimentally measured. According to FIG. 58, the moisture holdup in the column was higher at the beginning of the experiment and it reached to a steady-state condition over time. The fluctuations are due to change in the column pressure throughout different cycle steps.

Dynamic simulation also provides valuable information on the axial profiles in the column. Error! Reference source not found. shows the axial composition in the mass transfer zone, while the axial temperature profile is shown in Error! Reference source not found. The axial composition also shows how the process reached a steady-state condition over time. In the beginning, the bed was free of moisture and after 20 seconds, water is adsorbed in the mass transfer zone and the axial composition profile was obtained from the dynamic simulation. More water was adsorbed over time and this composition profile reached to higher mole fraction values (shifted up) until it reached a steady-state profile, which was repeated over different cycles.

Similarly, the temperature profile reached a steady-state condition over time. Initially, the bed was at room temperature. As the feed gas was sent into the column, the temperature of the bed at the inlet started to increase due to the heat of adsorption; then, as more amounts of water were adsorbed over time, this temperature front dissipated throughout the mass transfer zone until the whole mass transfer zone reached a steady-state temperature of 303 K.

### Ten-Step PSA Process

This simulation is similar to the six-step PSA process and similar results were obtained in terms of product composition and axial profiles because the nature of water adsorption is the same (same set of equations in the simulation). The only difference is the gas used for regeneration, which is investigated and discussed here. The process flow diagram of this dynamic simulation is shown in Error! Reference source not found. 61. The important aspect of this process that can be rigorously investigated using the dynamic simulation is the contamination of natural gas with CO₂ as this gas is used to regenerate the column. After the evacuation steps in this PSA process, natural gas may be sent into a column that is filled with CO₂ (see Table 13). It is critical to determine the exact amount of CO₂ that is mixed with the product gas in every cycle.

The material balance equations over the adsorption column were rigorously solved using ASPEN Adsim in order to determine the amount of CO₂ contamination. Basically, the initial condition for the bed was set as CO₂ in the void volume of the column and the feed was assumed to be 100% humid methane. The composition of the product gas was determined by solving the equations. As can be seen in Error! Reference source not found. 62, the mole fraction of CO₂ in the product gas reached zero after 5 seconds. Applying this finding to the HYSYS steady-state simulation of Alberta natural gas, the total mole flow of CO₂ from this contamination is 0.031 kmole/h (the total mole flow of natural gas is 460.7 kmole/h). Therefore, the CO₂ contamination of natural gas in the 10-step PSA process is negligible. It is worthy to mention that the Alberta natural gas already contains 1.68 mole % CO₂ (see Table 14).

### Lifetime of the Biosorbent

The results presented in this work confirms that the PSA process can dehydrate nonpolar gases at atmospheric and high-pressures. A critical question that must be answered is the lifetime of the biosorbent in this process. It has been shown that the biosorbent showed no degradation after experiencing 70 full adsorption-desorption cycles (complete saturation and regeneration). Herein, the biosorbent showed a steady-state performance in 250 cycles in the continuous dual-column PSA process overall and can continue for more repeated cycles. Flax shives are a biomaterial and can go bad over time if stored in a wet environment; however, in this PSA process they are periodically dried in every ten minutes. Therefore, they are supposed to work for a long time. Furthermore, we studied the surface chemistry of the flax shives and investigated how the surface might have changed over time (repeated adsorption-desorption cycles). The surface chemistry was investigated using a previous XPS method and the same methodology was used to investigate the surface functional groups of the flax shives that experienced 70 full adsorption-desorption cycles. The results showed the composition of the raw and reused biosorbent for 70 cycles were consistent. Taking these results into consideration, we predict that the biosorbent can effectively work in the PSA process with negligible degradation.

### Process Performance at Higher Pressures

Another critical question that needs to be answered regarding the PSA process is the effect of extremely high pressures of natural gas operations (30 to 65 bars). Due to safety issues, we could not test the adsorption performance of the flax shives at such pressures. The maximum operating pressure possible in our lab-scale setup was 5 bar. The breakthrough curve of this test at 5 bar and 24° C. is shown in Error! Reference source not found. 63. The feed gas was 100% humid having a flow rate of 3 L/min. An adsorption capacity of 0.88 g/g was achieved, which is still higher than all commercial adsorbents. Again, adsorption of methane, carbon dioxide, and nitrogen was negligible. Methane, carbon dioxide, and nitrogen adsorption at pressures up to 60 bar can be investigated once a safe setup is available. In the meanwhile, this process is applicable for the drying of air and biogas containing methane, nitrogen, carbon dioxide, etc., (similar to the composition of the aforementioned natural gas) generated from biological processes such as fermentation but operated at atmospheric to moderate pressure.

### Labview Code for 6-Step PSA Cycle

The embodiments of the control systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example and without limitation, the programmable computers may be a server, network appliance, embedded device, computer expansion module, a personal computer, laptop, personal data assistant, cellular telephone, smart-phone device, tablet computer, a wireless device or any other computing device capable of being configured to carry out the methods described herein.

In some embodiments, the communication interface may be a network communication interface. In embodiments in which elements are combined, the communication interface may be a software communication interface, such as those for inter-process communication (IPC). In still other embodiments, there may be a combination of communication interfaces implemented as hardware, software, and combination thereof.

Program code may be applied to input data to perform the functions described herein and to generate output information. The output information is applied to one or more output devices, in known fashion.

Each program may be implemented in a high level procedural or object oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g. ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

The overall format of the code may be a while loop inside an event structure, which is inside a case structure. This whole structure is inside the main while loop of the Labview program.

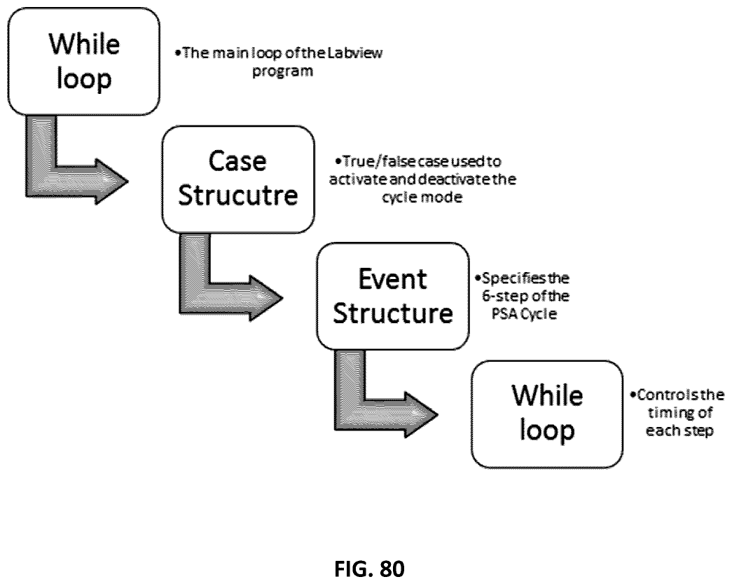

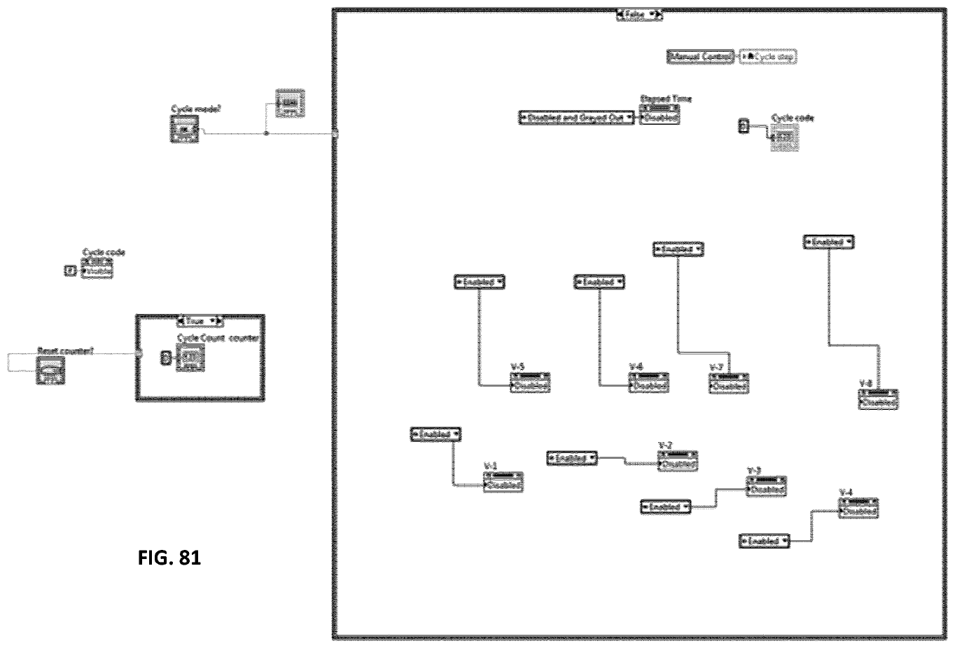

According to one embodiment, FIG. 80 shows an overview of an exemplary Labview code. FIGS. 81 to 88 illustrate parts of the code inside the main while loop (block panel). FIG. 81 shows the “False” case of the case structure, which allows users to activate/deactivate the cycle mode. The cycle mode runs the cyclic operation. In this false case, the valves (V-1 to V-8) can be manually controlled. This is used to for startup of the process.

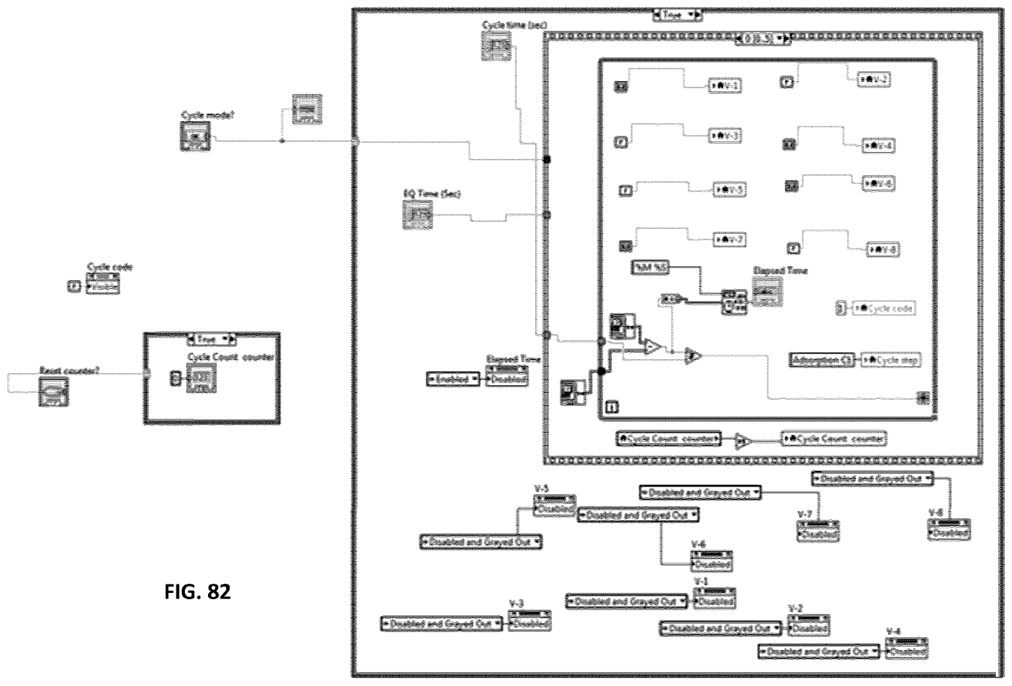

FIG. 82 shows the “True” case of the case structure. The event structure has 6 frames (numbered 0 to 5) where each frame controls each of the six steps of the PSA process. The code starts the process from the adsorption step in column 1 and regeneration in column 2. The system should be put in this mode of operation in the startup before starting the cyclic process.

Frame 0 shown in FIG. 82 is a time driven step based on a cycle time that users specify in the front panel. The while loop inside this frame reads the local time and compares it with the local time read inside the frame 0. If the time difference (which is the elapsed time of this step or frame) is larger than the specified cycle time, the while inside the frame 0 stops and the event structure proceeds to frame 1. The gas flow through the columns are controlled by opening and closing the valves. As can be seen in FIG. 82, valves V-1, V-7, V-4, and V-6 are open (constant logic of “True”), while the other valves are closed. This is based on the P&IDs illustrated and discussed elsewhere.

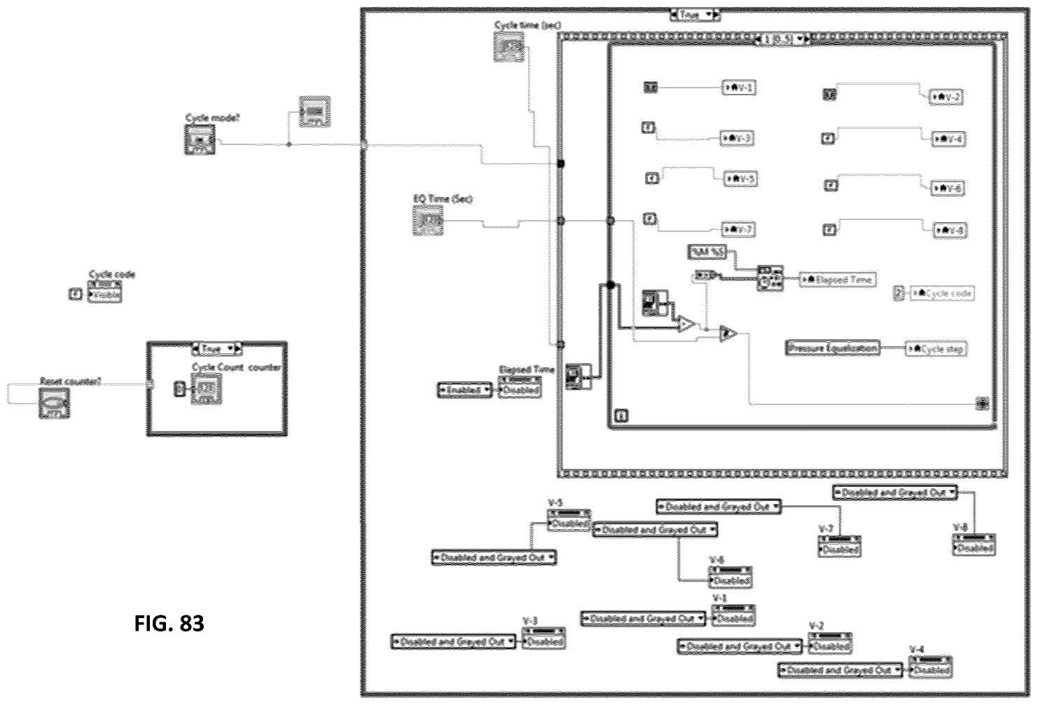

FIG. 83 shows the frame 1 of the event structure. This frame is also time driven step based on the “Pressure Equalization Time” specified by users in the front panel. The time readings and gas flow control algorithms are similar to those explained in frame 0.

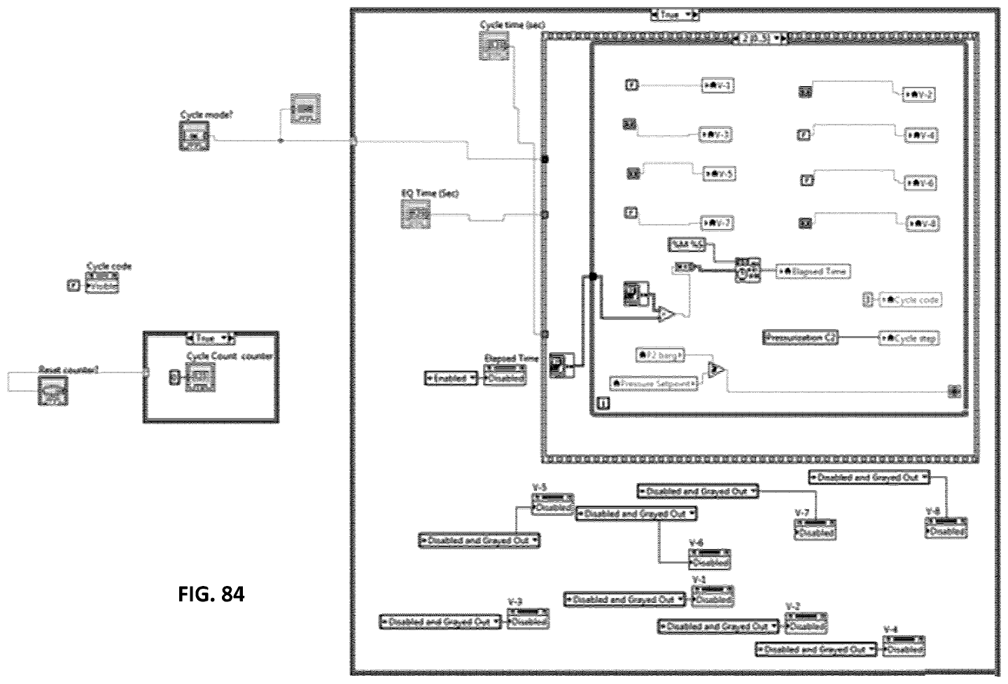

FIG. 84 shows the frame 2 of the event structure, which is an event driven step. The column 2 is pressurized in this step and code stays in this frame until the pressure in column 2 reaches the pressure set point specified by users in the front panel. In this frame, local variables of the pressure sensor installed on the column 2 and the pressure set point are compared. The while loop inside this frame stops as soon as the pressure in column 2 reaches the set point values. Then the event structure proceeds to frame 3.

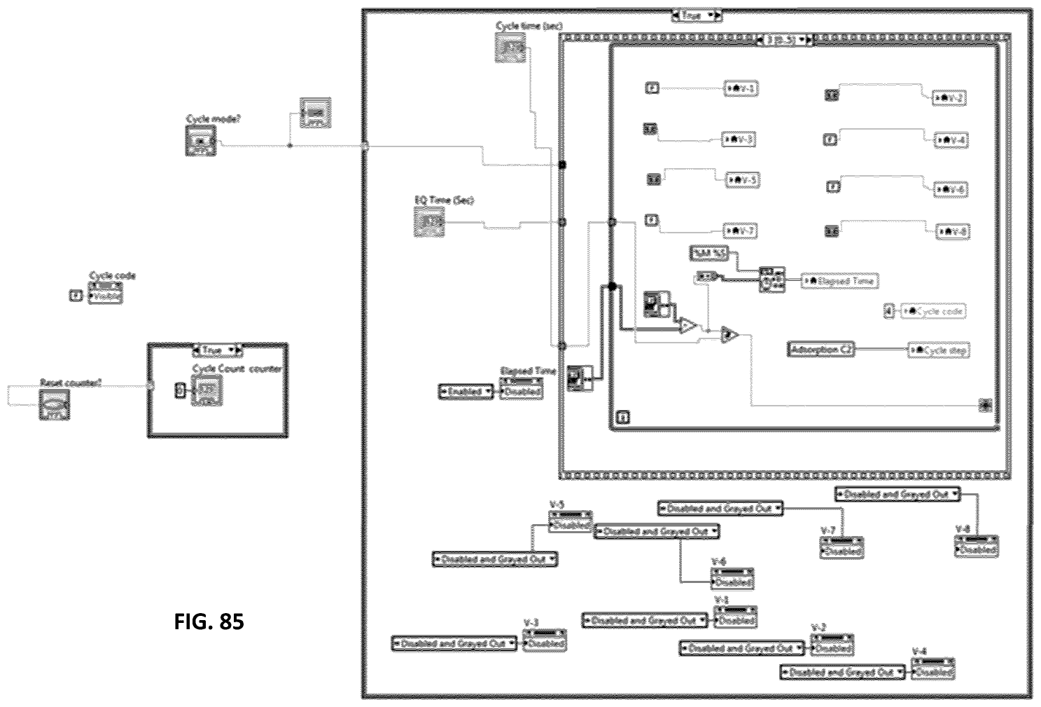

FIG. 85 shows the frame 3 of the event structure, which is again a time driven step based on the cycle time specified by the users in the front panel. This frame is similar to frame 0; however, the configuration of valves are different.

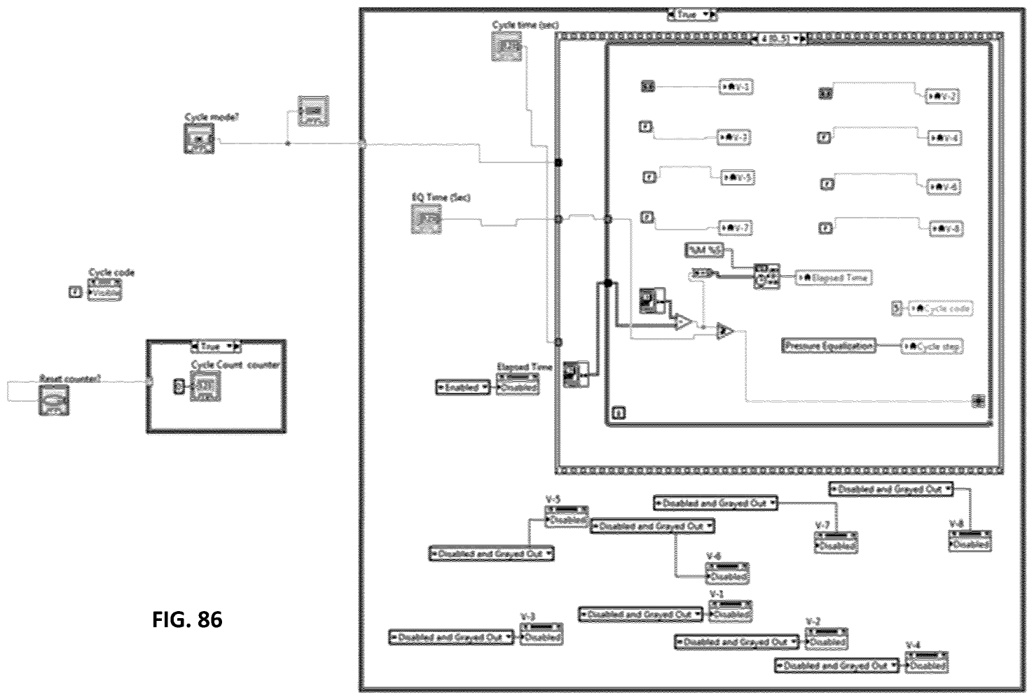

FIG. 86 shows the frame 4 of the event structure which is another time driven step. This frame is identical to frame 1.

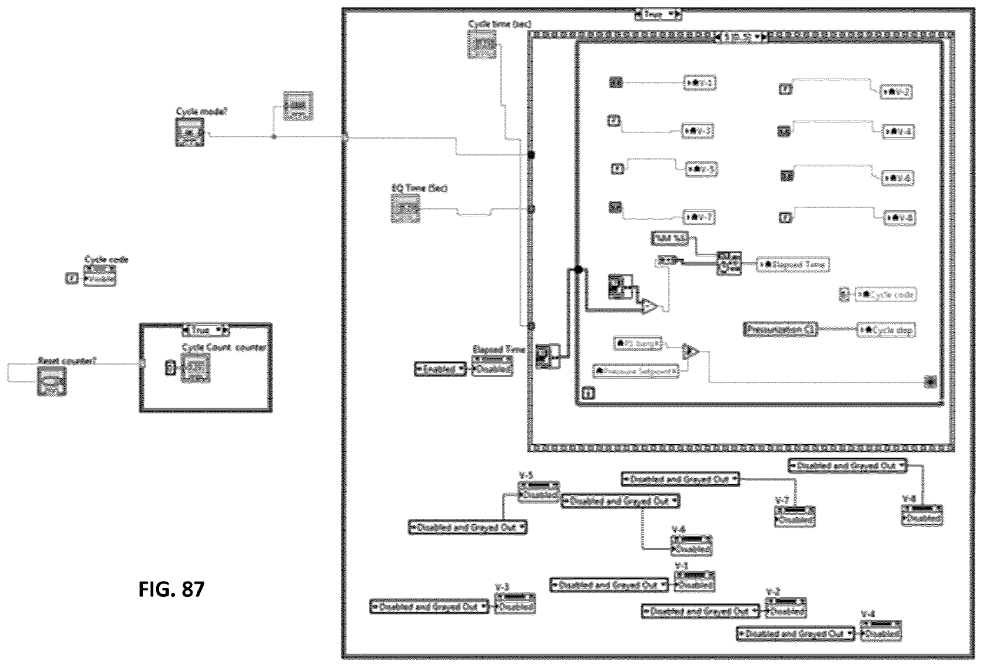

FIG. 87 shows the frame 5 of the event structure, which is an event driven step. This frame is similar to frame 2; however, the local variable of the pressure sensor installed on the column 1 is compared to the pressure set point value.

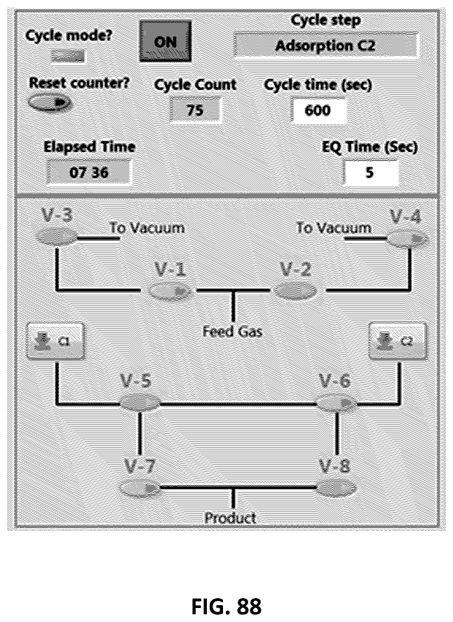

At this point, the event structure completed all the 6 frames and is reset to the first frame. This continues as long as the cycle mode is active and the code controls the continuous cyclic operation of the PSA process. A “String” is used to show the active step of the process in the front panel. Similarly, an indicator is used to show the elapsed time of each step in the PSA process. A counter is also put in the event structure to count the number of cycles passed. A case structure is used outside the cycle activation's case structure to allow users to reset the cycle count, which basically sets the cycle count to zero when the ON/OFF button is pushed in the front panel. Property nodes are used to disable and gray the buttons that open/close the valves when the cycle mode is active so that the users do not disrupt the cyclic operation by accident. FIG. 88 shows the front panel of the code.

It should be noted that the algorithm used in this code can be applied to any cyclic operation and swing adsorption processes (e.g. pressure swing and temperature swing). For different types of processes, the number of frames in the event structure and the configuration of vales and pressure/temperature sensors may vary accordingly.

While the above description provides examples of one or more apparatus, methods, or systems, it will be appreciated that other apparatus, methods, or systems may be within the scope of the claims as interpreted by one of skill in the art.

### REFERENCES

BHADRA, S. J. (2007). Methane-nitrogen separation by pressure swing adsorption.
Borhan, M. S., Rahman, S., & Hammer, C. (2014). Water absorption capacity of flax and pine horse beddings and gaseous concentrations in bedded stalls. Journal of Equine Veterinary Science, 34(5), 611-618.
Ranjbar, Z., Tajallipour, M., Niu, C. H., & Dalai, A. K. (2013). Water removal from ethanol vapor by adsorption on canola meal after protein extraction. Industrial & engineering chemistry research, 52(40), 14429-14440.
Ruthven, D. M. (1984). Principles of adsorption and adsorption processes: John Wiley & Sons.
Ruthven, D. M., Farooq, S., & Knaebel, K. S. (1994). Pressure swing adsorption (Vol. 480): VCH publishers New York.
Sun, Q., Li, H., Yan, J., Liu, L., Yu, Z., & Yu, X. (2015). Selection of appropriate biogas upgrading technology—a review of biogas cleaning, upgrading and utilisation. Renewable and Sustainable Energy Reviews, 51, 521-532.
Tajallipour, M., Niu, C., & Dalai, A. (2013). Ethanol Dehydration in a Pressure Swing Adsorption Process Using Canola Meal. Energy & Fuels, 27(11), 6655-6664.
Rentsen, B. (2010). Characterization of flax shives and factors affecting the quality of fuel pellets from flax shives.
Rudzinski, W., & Everett, D. H. (2012). Adsorption of gases on heterogeneous surfaces: Academic Press.
Ruthven, D. M. (1984). Principles of adsorption and adsorption processes: John Wiley & Sons.
Ruthven, D. M., Farooq, S., & Knaebel, K. S. (1994). Pressure swing adsorption (Vol. 480): VCH publishers New York.
Seery, M. W. (1999). Bulk separation of carbon dioxide from methane using natural clinoptilolite: Google Patents.
Shin, H. S., & Knaebel, K. (1988). Pressure swing adsorption: An experimental study of diffusion-induced separation. AIChE Journal, 34(9), 1409-1416.
Sircar, S. (1988). High efficiency separation of methane and carbon dioxide mixtures by adsorption. Paper presented at the AICHE Symposium Series[AICHE SYMP. SER.].
Skarstrom, C. W. (1960). Method and apparatus for fractionating gaseous mixtures by adsorption: Google Patents.
Slejko, F. L. (1985). Adsorption technology. A step-by-step approach to process evaluation and application: Dekker New York; Basel.
Sun, Q., Li, H., Yan, J., Liu, L., Yu, Z., & Yu, X. (2015). Selection of appropriate biogas upgrading technology—a review of biogas cleaning, upgrading and utilisation. Renewable and Sustainable Energy Reviews, 51, 521-532.
Tagliabue, M., Farrusseng, D., Valencia, S., Aguado, S., Rayon, U., Rizzo, C., Mirodatos, C. (2009). Natural gas treating by selective adsorption: Material science and chemical engineering interplay. Chemical Engineering Journal, 155(3), 553-566.

What is claimed is:

1. A system for separating components of a multi-component gas mixture, the system comprising a packed bed column packed with a biosorbent material,
wherein, upon passing the multi-component gas mixture through the packed bed column, substantially all of a polar component of the multi-component gas mixture is adsorbed by the biosorbent material and a non-polar component of the multi-component gas mixture is not substantially adsorbed by the biosorbent material.

2. The system of claim 1, wherein the biosorbent material is a lignocellulose-based material.

3. The system of claim 1, wherein the biosorbent material is a flax-based material.

4. The system of claim 1, wherein the biosorbent material is flax shives or modified flax shives.

5. The system of claim 1, wherein the multi-component gas mixture is natural gas.

6. The system of claim 1, wherein the polar component is water.

7. The system of claim 1, wherein the non-polar component is methane.

8. The system of claim 1, wherein the multi-component gas mixture is natural gas and the polar component is water.

9. The system of claim 1, wherein the multi-component gas mixture is natural gas and the non-polar component is methane.

10. The system of claim 1, wherein the polar component is water and the non-polar component is methane.

11. The system of claim 1, wherein the multi-component gas mixture is natural gas, the polar component is water and the non-polar component is methane.

12. A method of separating components of a multi-component gas mixture, the method comprising:
passing a feed stream comprising the multi-component gas mixture through a packed bed column comprising a biosorbent material for the biosorbent material to adsorb substantially all of a polar component of the multi-component gas mixture and to not substantially adsorb a non-polar component of the multi-component gas mixture.

13. The method of claim 12, wherein the passing the feed stream comprising the multi-component gas mixture through the packed bed column comprising a biosorbent material includes passing the feed stream comprising the multi-component gas mixture through the packed bed column comprising a lignocellulose-based material.

14. The method of claim 12, wherein the passing the feed stream comprising the multi-component gas mixture through the packed bed column comprising a biosorbent material includes passing the feed stream comprising the multi-component gas mixture through the packed bed column comprising a flax-based material.

15. The method of claim 12, wherein the passing the feed stream comprising the multi-component gas mixture through the packed bed column comprising a biosorbent material includes passing the feed stream comprising the multi-component gas mixture through the packed bed column comprising flax shives, modified flax shives or the like.

16. The method of claim 12, wherein the multi-component gas mixture is natural gas.

17. The method of claim 12, wherein the polar component is water.

18. The method of claim 12, wherein the non-polar component is methane.

19. The method of claim 12, wherein the multi-component gas mixture is natural gas and the polar component is water.

20. The method of claim 12, wherein the multi-component gas mixture is natural gas and the non-polar component is methane.

21. The method of claim 12, wherein the polar component is water and the non-polar component is methane.

22. The method of claim 12, wherein the multi-component gas mixture is natural gas, the polar component is water and the non-polar component is methane.

23. A system for separating components of a multi-component gas mixture, the system comprising:
a feed stream comprising the multi-component gas mixture;
a first packed bed column packed with a biosorbent material and configured to receive the multi-component gas mixture from the feed stream;
a second packed bed column packed with the biosorbent material and configured to receive the multi-component gas mixture from the feed stream; and
a product stream configured to receive a dried gas from each of the first and the second packed bed columns, the dried gas comprising substantially all of a non-polar component of the multi-component gas mixture;
wherein upon passing the multi-component gas mixture through the first packed bed column substantially all of a polar component of the multi-component gas mixture is adsorbed by the biosorbent material and the non-polar component of the multi-component gas mixture is not substantially adsorbed by the biosorbent material.

24. The system of claim 23, further comprising a vacuum pump configured to reduce a pressure within the first bed column to desorb the polar component from a surface of the biosorbent material.

25. The system of claim 24, wherein, when passing the multi-component gas mixture through the first packed bed column, the second packed bed column is configured to undergo a regeneration process where the vacuum pump is configured to reduce a pressure within the second packed bed column to desorb the polar component from a surface of the biosorbent material.

26. The system of claim 23, wherein the biosorbent material is a lignocellulose-based material.

27. The system of claim 23, wherein the biosorbent material is a flax-based material.

28. The system of claim 23, wherein the biosorbent material is flax shives or modified flax shives.

29. The system of claim 23, wherein the multi-component gas mixture is natural gas.

30. The system of claim 23, wherein the polar component is water.

31. The system of claim 23, wherein the non-polar component is methane.

32. The system of claim 23, wherein the multi-component gas mixture is natural gas and the polar component is water.

33. The system of claim 23, wherein the multi-component gas mixture is natural gas and the non-polar component is methane.

34. The system of claim 23, wherein the polar component is water and the non-polar component is methane.

35. The system of claim 23, wherein the multi-component gas mixture is natural gas, the polar component is water and the non-polar component is methane.

36. The system of claim 23, wherein the feed stream enters the first packed bed reactor at a pressure in a range of about 15 to 1000 psia.

37. The system of claim 23, wherein the feed stream enters the first packed bed reactor at a pressure in a range of about 500 to 1000 psia.

38. The system of claim 23, wherein the feed stream enters the first packed bed reactor at a pressure sufficient for the polar component in the feed stream to adsorb to a surface of the biosorbent material.

39. The system of claim 25 further comprising a recycle stream configured to receive the non-polar component from the first packed bed reactor.

40. The system of claim 39, wherein the recycle stream is directed into the second packed bed reactor during the regeneration process to carry the desorbed polar component out of the second packed bed reactor.

41. The system of claim 23, wherein the system operates at about an ambient temperature.

42. The system of claim 23, wherein the multi-component gas mixture is an air-biogas gas mixture.

43. The system of claim 42, wherein the non-polar component is nitrogen gas.

44. A method of separating components of a multi-component gas mixture, the method comprising:
operating a first packed bed column in an adsorption process by passing a feed stream comprising the multi-component gas mixture through the first packed bed column comprising a biosorbent material for the biosorbent material to adsorb substantially all of a polar component of the multi-component gas mixture and to not substantially adsorb a non-polar component of the multi-component gas mixture; and
operating the first packed bed column in a regeneration process by drawing substantially all of the polar component adsorbed by the biosorbent material off of the biosorbent material.

45. The method of claim 44, further comprising, while operating the first packed bed column in the regeneration process, operating a second packed bed column in an adsorption process by passing a feed stream comprising the multi-component gas mixture through the second packed bed column comprising a biosorbent material for the biosorbent material to adsorb substantially all of a polar component of the multi-component gas mixture and to not substantially adsorb a non-polar component of the multi-component gas mixture.

46. The method of claim 45, wherein the biosorbent material is a lignocellulose-based material.

47. The method of claim 45, wherein the biosorbent material is a flax-based material.

48. The method of claim 45, wherein the biosorbent material is flax shives, modified flax shives or the like.

49. The method of claim 45, wherein the multi-component gas mixture is natural gas.

50. The method of claim 45, wherein the polar component is water.

51. The method of claim 45, wherein the non-polar component is methane.

52. The method of claim 45, wherein the multi-component gas mixture is natural gas and the polar component is water.

53. The method of claim 45, wherein the multi-component gas mixture is natural gas and the non-polar component is methane.

54. The method of claim 45, wherein the polar component is water and the non-polar component is methane.

55. The method of claim 45, wherein the multi-component gas mixture is natural gas, the polar component is water and the non-polar component is methane.

56. A system for controlling the separation of components of a multi-component gas mixture in a pressure swing or a temperature swing adsorption process, the system comprising:
a computing unit configured to:
operate a first packed bed column in an adsorption process by passing a feed stream comprising the multi-component gas mixture through the first packed bed column comprising a biosorbent material for the biosorbent material to adsorb substantially all of a polar component of the multi-component gas mixture and to not substantially adsorb a non-polar component of the multi-component gas mixture; and
operate the first packed bed column in a regeneration process by drawing substantially all of the polar component adsorbed by the biosorbent material off of the biosorbent material.

57. The system of claim 56, wherein the computing unit is further configured to when the first packed bed column is operated the regeneration process, operate a second packed bed column in an adsorption process by passing a feed stream comprising the multi-component gas mixture through the first packed bed column comprising a biosorbent material for the biosorbent material to adsorb substantially all of a polar component of the multi-component gas mixture and to not substantially adsorb a non-polar component of the multi-component gas mixture.

58. A system for controlling the separation of components of a multi-component gas mixture in a pressure swing or a temperature swing adsorption process, the system comprising:
a computing unit configured to:
pressurize a first packed bed column by directing a feed stream comprising the multi-component gas mixture into the first packed bed column, the first packed bed column comprising a biosorbent material for the biosorbent material to adsorb substantially all of a polar component of the multi-component gas mixture and to not substantially adsorb a non-polar component of the multi-component gas mixture;
direct the non-polar component from the first packed bed column to a product stream; and
collect the polar component off of the biosorbent material and into a recycle stream.

59. The system of claim 58, wherein the computing unit is configured to collect the polar component off of the biosorbent material and into a recycle stream by depressurizing the first packed bed column to desorb the polar component from the biosorbent material.

60. The system of claim 59, wherein the computing unit is configured to collect the polar component from the biosorbent material and into a recycle stream by further passing CO₂ through the first packed bed column after the polar component is desorbed from the biosorbent material.
